(19) United States
(12) Patent Application Publication
(10) Pub. No.: US 2006/0223116 A1
(43) Pub. Date: Oct. 5, 2006

(54) Modulation of Th2 lineage commitment by T-bet

(76) Inventors: Laurie H. Glimcher, West Newton, MA (US); Susanne J. Szabo, Somerville, MA (US); Eun Sook Hwang, Seoul (KR)

Correspondence Address: LAHIVE & COCKFIELD, 28 STATE STREET, BOSTON, MA, 02109, US

(21) Appl. No.: 11/335,927

(22) Filed: Jan. 20, 2006

Related U.S. Application Data
(60) Provisional application No. 60/645,698, filed on Jan. 20, 2005.

(51) Int. Cl. C40B 30/04; C40B 40/10

(52) U.S. Cl. 435/7.1

(57) ABSTRACT

The instant invention is based, at least in part, on the identification of a mechanism by which T-bet directly modulates Th2 cytokine production. The present invention pertains to methods of identifying agents that modulate the Tec kinase-mediated interaction of T-bet with GATA-3, as well as methods of use therefore.

### RELATED APPLICATIONS

This application claims the benefit of U.S. Provisional Application, No. 60/645,698, filed Jan. 20, 2005, titled “Modulation of Th2 Lineage Commitment by T-bet”. This application is related to U.S. application Ser. No. 10/309,747, filed Dec. 3, 2002 (pending), which is a continuation-in-part application of U.S. application Ser. No. 10/008,264, filed on Dec. 3, 2001 (pending), which is a continuation-in-part application of PCT/US00/15345, filed on Jun. 1, 2000 (expired), published pursuant to PCT Article 21, in English, which claims priority to U.S. Provisional Application Ser. No. 60/137,085, filed Jun. 2, 1999, the entire contents of each of these applications is incorporated herein by this reference.

### GOVERNMENT FUNDING

Work described herein was supported, at least in part, under grants AI/AG 37833, AI 39646, AI 36535, AR 6-2227, TGAI 07290, and AI 48126 awarded by the National Institutes of Health. The U.S. government therefore may have certain rights in this invention.

### BACKGROUND OF THE INVENTION

Cells of the immune system alter patterns of gene expression in response to extracellular and intracellular signals. A group of polypeptides, designated cytokines or lymphokines, which affect a range of biological activities in several cell types, are among the most important of these signals. While many cell types in the immune system secrete cytokines, the T helper (Th) lymphocyte is the major source of these polypeptides. More than a decade ago it was discovered that Th cells differentiate into two distinct subsets, Th1 and Th2, upon T cell receptor engagement, defined both by their distinct functional abilities and by unique cytokine profiles (Paul and Seder, 1994, Cell 76, 241-251; Mosmann and Coffman, 1989, Annu. Rev. Immunol. 7, 145-173; Mosmann et al., 1986, J. Immunol. 136, 2348-2357; Snapper and Paul, 1987, Science 236, 944-947). Th1 cells mediate delayed type hypersensitivity responses and macrophage activation while Th2 cells provide help to B cells and are critical in the allergic response (Mosmann and Coffman, 1989, Annu. Rev. Immunol. 7, 145-173; Paul and Seder, 1994, Cell 76, 241-251; Arthur and Mason, 1986, J. Exp. Med. 163, 774-786; Paliard et al., 1988, J. Immunol. 141, 849-855; Finkelman et al., 1988, J. Immunol. 141, 2335-2341). The evidence that Th1 cells directed cell-mediated immunity while Th2 cells contributed to humoral responses fit nicely with the observations that an organism tends to mount either a cell-mediated or humoral response, but not both, in response to pathogens. These functional differences between the Th subsets can be explained most easily by the activities of the cytokines themselves. IFN-γ is the “signature” cytokine of Th1 cells although Th1 cells also produce IL-2, TNF and LT. The corresponding “signature” cytokine for Th2 cells is IL-4. Th2 cells also secrete IL-5, IL-6, IL-9, IL-10 and IL-13.

Upon encountering antigen, the naive CD4+ T helper precursor (Thp) cell enacts a genetic program that ultimately sends it down a Th1 or Th2 lineage. While it is clear that polarization can be achieved by manipulating the antigen and costimulatory signals i.e. the “strength of signal” received by the Thp (Constant and Bottomly, 1997. Annu. Rev. Immunol. 15, 297-322), the most potent inducers of effector Th cells are undoubtedly the cytokines themselves. IL-4 promotes Th2 differentiation and simultaneously blocks Th1 development, an effect that is mediated via the Stat6 signaling pathway. Thus, mice that lack IL-4 or Stat6, fail to develop Th2 cells (Kopf et al., 1993, Nature 362, 245-248; Kuhn et al., 1991, Science 254, 707-710; Kaplan et al., 1996, Immunity 4, 313-319; Shimoda et al., 1996, Nature 380, 630-633; Takeda et al., 1996, Nature 380, 627-630). In contrast, IL-12, IL-18 and IFN-γ are the cytokines critical for the development of Th1 cells (Hsieh et al., 1993, Science 260, 547-549; Okamura et al., 1995, nature 378, 88-91; Gu et al., 1997, Science 275, 206-209; Meraz et al., 1996, Cell 84, 431-442; Magram et al., 1996, Immunity 4, 471-481). IFN-γ acting via the Stat1 pathway (Meraz et al., 1996, Cell 84, 431-442), and IL-12, acting via the Stat-4 signaling pathway (Jacobson et al., 1995, J. Exp. Med. 181, 1755-1762) together promote the differentiation of Th1 cells and block commitment to the Th2 lineage (Szabo et al., 1995, Immunity 2, 665-675; Szabo et al., 1997, J. Exp. Med. 185: 817-824). Mice deficient in IL-12 or Stat4 do not have Th1 cells (Magram et al., 1996, Immunity 4, 471-481; Takeda et al., 1996, Nature 380, 627-630; Shimoda et al., 1996, Nature 380, 630-633). Another important Th1-inducing cytokine is IL-18, whose receptor is related to the IL-1 receptor family (Cerretti et al., 1992, Science 256, 97-100). Mice lacking IL-18 have defective in vivo Th1 responses (Takeda et al., 1998, Immunity 8, 383-390) and both IL-12 and IL-18 regulate IFN-γ expression (Barbulescu et al., 1998, Eur. J. Immunol. 27, 1098-1107; Robinson et al., 1997, Immunity 7, 571-581; Ahn et al., 1997, J. Immunol. 159, 2125-2131). The cytokines themselves, then, form a positive and negative feedback system that drives Th polarization (Powrie and Coffman, 1993, Immunol. Today 14, 270-274; Scott, 1991, J. Immunol. 147, 3149; Maggi et al., 1992, J. Immunol. 148, 2142; Parronchi et al., 1992, J. Immunol. 149, 2977; Fargeas et al., 1992, Eur. J. Immunol. 149, 2977; Manetti et al., 1993, J. Exp. Med. 177, 1199; Trinchieri, 1993, Immunol. Today 14, 335-338; Macatonia et al., 1993, Immunol. 5, 1119; Seder et al., 1993, Proc. Natl. Acad. Sci. USA 90, 10188-10192; Wu et al., 1993, J. Immunol. 151, 1938; Hsieh et al., 1993, Science 260, 547-549) (reviewed in (Seder and Paul, 1994, In Annual Review of Immunology, Vol. 12, 635-673; Paul and Seder, 1994, Cell 76, 241-251; O'Garra, 1998, Immunity 8, 275-283).

Over the last few years, significant progress has been made in identifying the transcription factors that control the transition of a Thp to a Th2 cell as evidenced by the capacity of such factors to drive IL-4 production (reviewed in Glimcher and Singh, 1999 Cell 96, 13-23; Szabo et al., 1997, Current Opinions in Immunology 9, 776-781). The provision of three distinct proteins, the c-Maf proto-oncogene, the transcription factor Nuclear Factor of Activated T cells (NFAT), and a novel nuclear antigen, NFAT-Interacting Protein 45 kD (NIP45), have been shown to confer on a non-T cell the ability to produce endogenous IL-4 (Hodge et al., 1996, Science 274, 1903-1905; Ho et al., 1998, J. Exp. Med. 188:1859-1866). These factors and others such as GATA-3 (Zheng and Flavell, 1997, Cell 89, 587-596) and Stat6 clearly can drive the production of IL-4, and therefore the development of Th2 cells, both in vitro and in vivo.

In contrast, little is known about the molecular basis of Th1 differentiation. For example, the only known transcription factors whose absence results in a failure to generate Th1 cells are Stat4 (Thierfelder et al., 1996, Nature 382, 171-174; Kaplan et al., 1996, Nature 382, 174-177) and IRF-1 (Lohoff et al., 1997, Immunity:681-689; Taki et al., 1997, Immunity 6:673-679), neither of which is Th1-specific. The Ets family member ERM which is induced by IL-12 in a Stat4-dependent manner has recently been reported to be Th1-specific but it does not affect the production of Th1 cytokines (Ouyang et al., 1999, Proc. Natl. Acad. Sci. 96:3888). The absence of Th1 cells in Stat4 deficient mice is secondary to the failure of IL-12 to drive the Th1 program while the lack of Th1 cells in IRF-1 deficient mice is likely due to its direct effect in controlling transcription of the IL-12 gene (Lohoff et al., 1997, Immunity 6: 681-689; Taki et al., 1997, Immunity 6:673-679). However, some of the signaling pathways upstream of such putative Th 1-specific regulatory factors are beginning to be elucidated.

The p38 kinase is one such signaling molecule as demonstrated by the ability of constitutively activated MAP kinase kinase 6 (MKK6) to boost IFN-γ production. Conversely, overexpression of a dominant negative p38 MAP kinase or targeted disruption of Jnk2 or Jnk1 reduces Th1 responses (Rincón et al., 1998, EMBO J. 17, 2817-2829; Yang et al., 1998, Immunity 9, 575-585; Dong et al., 1998, Science 282, 2092-2095). The JNK signaling pathway might affect Th development by a direct effect on the transcription of the IFN-γ gene, but this has not been shown. For example, the ATF-2 and AP-1 transcription factors are both substrates of JNK kinases and these factors as well as NFκB and Stat4 proteins are known to bind to sites in the IFN-γ promoter (Zhang et al., 1998, Immunol. 161, 6105-6112; Ye et al., 1996, Mol. Cell. Biol. 16:4744; Barbulescu et al., 1997, Eur. J. Immunol. 27, 1098-1107; Sica et al., 1997, J. Biol. Chem. 272, 30412-30420). The production of IFN-γ is, however, normal in mice lacking ATF-2. T-bet accomplishes the former by directly driving the transcription of the IFNγ gene as well as the IL-12Rβ2 chain. However, no clues to the mechanism by which it accomplishes the latter exist since T-bet does not directly repress IL-4 promoter activity. Identification of a mechanism by which T-bet directly modulates Th2 cytokine production would allow for modulation of the production of these cytokines and would be of great benefit.

### SUMMARY OF THE INVENTION

The instant invention is based, at least in part, on the identification of the mechanism by which T-bet directly represses Th2 cytokine production.

One aspect of the invention features a method for identifying a compound which directly increases Th2 lineage commitment during T cell differentiation, comprising contacting in the presence of the compound, T-bet and a Tec kinase molecule under conditions which allow interaction of the kinase molecule with T-bet; and detecting the interaction of T-bet and the kinase molecule, wherein the ability of the compound to increase Th2 lineage commitment during T cell differentiation is indicated by a decrease in the interaction as compared to the amount of interaction in the absence of the compound. In one embodiment, the interaction of T-bet and the kinase molecule is determined by measuring the formation of a complex between T-bet and the kinase. In another embodiment, the interaction of T-bet and the kinase molecule is determined by measuring the phosphorylation of T-bet. In a further embodiment, the phosphorylation of T-bet is determined by measuring the phosphorylation of the tyrosine residue at amino acid position 525 (Y525) of T-bet. In one embodiment, the kinase molecule is ITK.

Another aspect of the invention features a method of identifying compounds useful in increasing Th2 lineage commitment during T cell differentiation comprising, a) providing an indicator composition comprising ITK, T-bet and GATA3; b) contacting the indicator composition with each member of a library of test compounds; c) selecting from the library of test compounds a compound of interest that decreases the ITK-mediated interaction of T-bet and GATA3 to thereby identify a compound that increases Th2 lineage commitment. In one embodiment, interaction is determined by measuring Th2 cytokine production by a T cell. In a further embodiment, the cytokine is selected from the group consisting of IL-4, IL-5, and IL-10. In one embodiment, the ITK-mediated interaction of T-bet and GATA3 is determined by measuring the formation of a complex between T-bet and GATA3. In another embodiment, the ITK-mediated interaction of T-bet and GATA3 is determined by measuring a decrease in GATA3 binding to DNA. In yet another embodiment, the indicator composition is a cell that expresses a T-bet polypeptide. In a further embodiment, the cell is committed to a T cell lineage. In another further embodiment, the cell is not yet committed to a T cell lineage.

Another aspect of the invention features a method for identifying a compound which modulates the interaction of T-bet and GATA3 in a T cell, comprising contacting in the presence of the compound and ITK, T-bet and GATA3 under conditions which allow ITK-mediated binding of T-bet to GATA3 to form a complex; and detecting the formation of a complex of T-bet and GATA3 in which the ability of the compound to inhibit interaction between T-bet and GATA3 in the presence of ITK and the compound is indicated by a decrease in complex formation as compared to the amount of complex formed in the absence of ITK and the compound. In one embodiment, the compound increases the formation or stability of the complex. In another embodiment, the compound decreases the formation or stability of the complex.

Yet another aspect of the invention features a method of identifying compounds useful in directly increasing the production of at least one Th2 cytokine by a T cell, comprising, a) providing an indicator composition comprising ITK, T-bet and GATA3; b) contacting the indicator composition with each member of a library of test compounds; c) selecting from the library of test compounds a compound of interest that decreases the ITK-mediated interaction of T-bet and GATA3 to thereby identify a compound that increases the production of at least one cytokine. In one embodiment, the interaction of T-bet and GATA3 is determined by measuring the production of at least one cytokine. In another embodiment, the interaction of T-bet and GATA3 is determined by measuring the production of more than one cytokine. In yet another embodiment, the cell is selected from the group consisting of: a T cell, a B cell, and an NK cell.

One aspect of the invention features a method of treating or preventing a disorder that would benefit from treatment with an agent that directly increases Th2 cytokine production by T cells, comprising administering to a subject with said disorder an agent that decreases the ITK-mediated binding of T-bet and GATA3 in T cells, such that the disorder is treated or prevented. In one embodiment, the agent inhibits tyrosine phosphorylation of T-bet. In another embodiment, the T cells are Thp cells.

Another aspect of the invention features a method of directly increasing Th2 cytokine production by a T cell, comprising contacting the cell with an agent that decreases the ITK-mediated binding of T-bet and GATA3 in the T cell, such that Th2 cytokine production by the T cell is increased. In one embodiment, the agent inhibits tyrosine phosphorylation of T-bet. In another embodiment, the T cells are Thp cells.

Yet another aspect of the invention features a method of directly increasing Th2 lineage commitment during T cell differentiation, comprising contacting the cell with an agent that decreases the ITK-mediated binding of T-bet and GATA3 in the T cell, such that Th2 lineage commitment during T cell differentiation is increased. In one embodiment, the agent inhibits tyrosine phosphorylation of T-bet. In another embodiment, the T cells are Thp cells.

### BRIEF DESCRIPTION OF THE DRAWINGS

FIGS. 1A and 1B show an amino acid sequence alignment of murine and human T-bet prepared using the Lipman Pearson protein alignment program. FIG. 1C shows nuceleic acid sequence alignment of murine and human T-bet. The alignment was prepared using the ALIGN program. The T-box sequence is shown in bold. Tyrosine phosphorylation sites are underlined. The nuclear localization site is marked with arrows.

FIG. 2 shows the conserved structure of Tec family members.

FIG. 3 shows the predicted tyrosine phosphorylation sites of human T-bet.

FIG. 4 shows the modified forms of T-bet that were made and used as substrates in in vitro kinase assays.

FIG. 5 shows that both ITK and Rlk phosphorylated N-terminal and C-terminal but not DNA-binding regions of T-bet in in vitro kinase assays.

FIG. 6 shows that although T-bet is present in T cells from ITK knock out animals, tyrosine phosphorylation of the molecule is reduced. In contrast, T-bet was hyperphosphorylated in Rlk knockout T cells

FIGS. 7A-7G show that T-bet is tyrosine phosphorylated.

FIGS. 8A-8E show that tyrosine phosphorylation of T-bet is required for the optimal repression of Th2 cytokine production.

FIGS. 9A-9F show that T-bet physically interacts with ITK.

FIGS. 10A-10L show that T-bet directly sequesters GATA-3 away from binding to target DNA.

### DETAILED DESCRIPTION OF THE INVENTION

The instant invention is based, at least in part, on the identification of a mechanism by which T-bet directly modulates Th2 cytokine production. This invention pertains to, interia alia, methods of identifying agents that modulate the Tec kinase-mediated interaction of T-bet with GATA-3, as well as methods of use therefore (see appended examples). As discussed in more detail below, T-bet is an important intracellular transducer or mediator of a variety of extracellular signals. More specifically, T-bet is a transcription factor that operates in different cell types to transduce extracellular signals into specific patterns of gene expression. In particular, it has now been demonstrated that T-bet has a central role in both Th1 and Th2 cytokine gene expression. Different cell types and different genes respond to T-bet, which serves to modulate a variety of cellular responses. T-bet also controls expression of several genes, expression of these genes and others similarly affected can be modulated (e.g., enhanced or reduced) by controlling the expression and/or activity of T-bet.

Brachyury or T is the founding member of a family of transcription factors that share a 200 amino acid DNA-binding domain called the T-box (reviewed in Smith, 1997; Papaioannou, 1997; Meisler, 1997). The Brachyury (Greek for ‘short tail’) mutation was first described in 1927 in heterozygous mutant animals who had a short, slightly kinked tail (Herrmann et al., 1990). The amino-terminal half (amino acids 1-229) of the Brachyury T-box protein contains a conserved domain known as the T box which has been shown to exhibit sequence-specific DNA-binding activity (Kispert, A. & Herrmann, B. G. 1993. EMBO J. 12:3211; Papapetrou, C., et al. 1997. FEBS Lett. 409:201; Kispert, A., et al. 1995. EMBO J. 14:4763). The C-terminal half contains two pairs of transactivation and repression domains. The similarity of sequence between the T box region in orthologous species can be as high as 99% and is around 40-70% between non-orthologous genes. The T-box domain has recently been co-crystallized with DNA and demonstrates a novel sequence-specific DNA recognition architecture in which the protein contacts DNA in both the major and minor grooves (Müller, C. W. & Herrmann, B. G. 1997. Nature 389, 884).

A yeast one hybrid approach was used to identify Th-1 specific transcription factors. Yeast cells were made to express an IL-2 promoter-reporter gene construct and were transformed with a cDNA library made from an anti-CD3 activated Th1 cell clone. Inspection of the IL-2 promoter reveals an excellent T-box binding site at −240 to −220 just 5′ of the NFkB site. As described in the appended examples, T-bet was isolated in a yeast one hybrid screening assay based on its ability to bind to the IL-2 promoter.

The T-bet proteins of the invention have homology to T-box proteins. There are now more than eight T-box genes in the mouse not including Brachyury. These include Tbx 1-6, T-brain-1 (Thr-1), Eomes, T-pit, and T-bet, each with a distinct and usually complex expression pattern. T-brain-1 expression, for example is largely restricted to distinct domains within the cerebral cortex (Bulfone, A., et al. 1995. Neuron 15, 63. T-bet is most similar in sequence to Thr-1. Outside of the T-box, the T-bet proteins of the invention bear no similarity to other T-box proteins.

T-bet is a T-box protein expressed only in T cells and is most similar in sequence to Thr-1. Other species also express Brachyury-like genes. Such vertebrate species include Xenopus, zebrafish, chick and humans (Rao, 1994; Horb and Thomsen, 1997; Conlon et al., 1996; Ryan et al., 1996; Schulte-Merker et al., 1994; Edwards et al., 1996; Morrison et al., 1996; Law et al., 1995; Cambell et al., 1998) as well as more distant species such as amphioxus, ascidians, echinoderms, Caenorhabditis elegans, Drosophila and other insects (Holland et al., 1995). These genes are conserved both in sequence and in expression pattern.

T-bet is unique in that it is the only T-box protein to be tyrosine phosphorylated. There are three predicted tyrosine phosphorylation sites at Tyr 76, Tyr 119, and Tyr 531 of human T-bet and one at Tyr 525 of murine T-bet. A nuclear localization sequence is also present at amino acids 498-501 of human T-bet and 493-496 of murine T-bet. Mapping experiments locate two transactivation domains, one 5′ and one 3′ of the T-box domain. It has been shown that T-bet binds to a consensus T-box site (defined by target site selection (i.e., EMSA and DNA immunoprecipitation assays) in vitro as 5′-GGGAATTTCACACCTAGGTGTGAAATTCCC-3′) and to the human IL-2 promoter, the murine IL-2 promoter, the human IFN-γ intron III, and two binding sites in the murine IFN-γ proximal promoter. (Szabo et al. 2000. Cell 100:655-669). T-bet is expressed only in the thymus and in the peripheral lymphoid system. In the periphery, T-bet is expressed only in Th1 cells where it is induced both in response to TcR stimulation and to IL-12. In the thymus levels of T-bet are highest in DN and Rag2−/−thymocytes.

These data demonstrate that the selective expression of T-bet accounts for tissue-specific IFN-γ expression. T-bet is expressed only in Th1 and not in Th2 cells and is induced in the former upon transmission of signals through the T cell receptor.

In addition, T-bet is a potent transactivator of the IFN-γ gene. The expression of T-bet correlates with IFN-γ expression in cells of the adaptive and innate immune system including: Th1 cells, B cells, NK cells, and dendritic cells. T-bet is responsible for the genetic program that initiates Th1 lineage development from naïve Thp cells and acts both by initiating Th1 genetic programs and by repressing the opposing programs in Th2 cells.

So that the invention may be more readily understood, certain terms are first defined.

As used herein, the term “modulated” with respect to T-bet includes changing the expression, activity or function of T-bet in such a manner that it differs from the naturally-occurring expression, function or activity of T-bet under the same conditions. For example, the expression, function or activity can be greater or less than that of naturally occurring T-bet, e.g., owing to a change in binding specificity, etc. As used herein, the various forms of the term “modulate” include stimulation (e.g., increasing or upregulating a particular response or activity) and inhibition (e.g., decreasing or downregulating a particular response or activity).

As used herein, the term “T-bet molecules” includes T-bet nucleic acid molecules that share structural features with the nucleic acid molecules shown in SEQ ID NOs: 1 and 3 and T-bet proteins that share the distinguishing structural and functional features of the T-bet proteins shown in SEQ ID NOs 2 and 4. The T-bet proteins are members of the T-box family of proteins and share some amino acid sequence homology to Brachyury, Tbx1-6, T-brain-1 (Tbr-1). T-box proteins comprise a T-box domain which binds to DNA at a T-box binding site. Further structural and functional features of T-bet proteins are provided below.

As used herein, the term “nucleic acid molecule” is intended to include DNA molecules (e.g., cDNA or genomic DNA) and RNA molecules (e.g., mRNA). The nucleic acid molecule may be single-stranded or double-stranded, but preferably is double-stranded DNA. The term nucleic acid molecule is also intended to include fragments or equivalents thereof (e.g., fragments or equivalents thereof T-bet, Itk, and/or GATA3). The term “equivalent” is intended to include nucleotide sequences encoding functionally equivalent T-bet proteins, i.e., proteins which have the ability to interact, e.g., bind, to the natural binding partners of T-bet.

An used herein, an “isolated nucleic acid molecule” refers to a nucleic acid molecule that is free of gene sequences which naturally flank the nucleic acid in the genomic DNA of the organism from which the nucleic acid is derived (i.e., genetic sequences that are located adjacent to the gene for the isolated nucleic molecule in the genomic DNA of the organism from which the nucleic acid is derived). For example, in various embodiments, an isolated T-bet nucleic acid molecule typically contains less than about 10 kb of nucleotide sequences which naturally flank the nucleic acid molecule in genomic DNA of the cell from which the nucleic acid is derived, and more preferably contains less than about 5, kb, 4 kb, 3 kb, 2 kb, 1 kb, 0.5 kb or 0.1 kb of naturally flanking nucleotide sequences. An “isolated” T-bet nucleic acid molecule may, however, be linked to other nucleotide sequences that do not normally flank the T-bet sequences in genomic DNA (e.g., the T-bet nucleotide sequences may be linked to vector sequences). In certain preferred embodiments, an “isolated” nucleic acid molecule, such as a cDNA molecule, also may be free of other cellular material. However, it is not necessary for the T-bet nucleic acid molecule to be free of other cellular material to be considered “isolated” (e.g., a T-bet DNA molecule separated from other mammalian DNA and inserted into a bacterial cell would still be considered to be “isolated”).

The nucleic acids of the invention can be prepared, e.g., by standard recombinant DNA techniques. A nucleic acid of the invention can also be chemically synthesized using standard techniques. Various methods of chemically synthesizing polydeoxynucleotides are known, including solid-phase synthesis which has been automated in commercially available DNA synthesizers (See e.g., Itakura et al. U.S. Pat. No. 4,598,049; Caruthers et al. U.S. Pat. No. 4,458,066; and Itakura U.S. Pat. Nos. 4,401,796 and 4,373,071, incorporated by reference herein).

As used herein, the term “hybridizes under high stringency conditions” is intended to describe conditions for hybridization and washing under which nucleotide sequences having substantial homology (e.g., typically greater than 70% homology) to each other remain stably hybridized to each other. A preferred, non-limiting example of high stringency conditions are hybridization in a hybridization buffer that contains 6× sodium chloride/sodium citrate (SSC) at a temperature of about 45° C. for several hours to overnight, followed by one or more washes in a washing buffer containing 0.2×SSC, 0.1% SDS at a temperature of about 50-65° C.

The term “percent (%) identity” as used in the context of nucleotide and amino acid sequences (e.g., when one amino acid sequence is said to be X % identical to another amino acid sequence) refers to the percentage of identical residues shared between the two sequences, when optimally aligned. To determine the percent identity of two nucleotide or amino acid sequences, the sequences are aligned for optimal comparison purposes (e.g., gaps may be introduced in one sequence for optimal alignment with the other sequence). The residues at corresponding positions are then compared and when a position in one sequence is occupied by the same residue as the corresponding position in the other sequence, then the molecules are identical at that position. The percent identity between two sequences, therefore, is a function of the number of identical positions shared by two sequences (i.e., % identity=# of identical positions/total # of positions×100).

Computer algorithms known in the art can be used to optimally align and compare two nucleotide or amino acid sequences to define the percent identity between the two sequences. A preferred, non-limiting example of a mathematical algorithm utilized for the comparison of two sequences is the algorithm of Karlin and Altschul (1990) Proc. Natl. Acad. Sci. USA 87:2264-68, modified as in Karlin and Altschul (1993) Proc. Natl. Acad. Sci. USA 90:5873-77. Such an algorithm is incorporated into the NBLAST and XBLAST programs of Altschul, et al. ((1990) J. Mol. Biol. 215:403-10). To obtain gapped alignments for comparison purposes, Gapped BLAST can be utilized as described in Altschul et al. ((1997) Nucleic Acids Research 25(17):3389-3402). When utilizing BLAST and Gapped BLAST programs, the default parameters of the respective programs (e.g., XBLAST and NBLAST) can be used. See http://www.ncbi.nlm.nih.gov. For example, the nucleotide sequences of the invention were blasted using the default Blastn matrix 1-3 with gap penalties set at: existance 5 and extension 2. The amino acid sequences of the invention were blasted using the default settings: the Blosum62 matrix with gap penalties set at existance 11 and extension 1.

Another preferred, non-limiting example of a mathematical algorithm utilized for the comparison of sequences is the algorithm of Myers and Miller, CABIOS (1989). Such an algorithm is incorporated into the ALIGN program (version 2.0) which is part of the GCG sequence alignment software package. When utilizing the ALIGN program for comparing amino acid sequences, a PAM120 weight residue table, a gap length penalty of 12, and a gap penalty of 4 can be used. If multiple programs are used to compare sequences, the program that provides optimal alignment (i.e., the highest percent identity between the two sequences) is used for comparison purposes.

As used herein, a “naturally-occurring” nucleic acid molecule refers to an RNA or DNA molecule having a nucleotide sequence that occurs in nature (e.g., encodes a natural protein).

As used herein, an “antisense” nucleic acid comprises a nucleotide sequence which is complementary to a “sense” nucleic acid encoding a protein, e.g., complementary to the coding strand of a double-stranded cDNA molecule, complementary to an mRNA sequence or complementary to the coding strand of a gene. Accordingly, an antisense nucleic acid can hydrogen bond to a sense nucleic acid.

In one embodiment, nucleic acid molecule of the invention is an siRNA molecule. In one embodiment, a nucleic acid molecule of the invention mediates RNAi. RNA interference (RNAI) is a post-transcriptional, targeted gene-silencing technique that uses double-stranded RNA (dsRNA) to degrade messenger RNA (mRNA) containing the same sequence as the dsRNA (Sharp, P. A. and Zamore, P. D. 287, 2431-2432 (2000); Zamore, P. D., et al. Cell 101, 25-33 (2000). Tuschl, T. et al. Genes Dev. 13, 3191-3197 (1999); Cottrell T R, and Doering T L. 2003. Trends Microbiol. 11:37-43; Bushman F.2003. Mol Therapy. 7:9-10; McManus M T and Sharp P A. 2002. Nat Rev Genet. 3:737-47). The process occurs when an endogenous ribonuclease cleaves the longer dsRNA into shorter, e.g., 21- or 22-nucleotide-long RNAs, termed small interfering RNAs or siRNAs. The smaller RNA segments then mediate the degradation of the target mRNA. Kits for synthesis of RNAi are commercially available from, e.g. New England Biolabs or Ambion. In one embodiment one or more of the chemistries described above for use in antisense RNA can be employed in molecules that mediate RNAi.

As used herein, the term “coding region” refers to regions of a nucleotide sequence comprising codons which are translated into amino acid residues, whereas the term “noncoding region” refers to regions of a nucleotide sequence that are not translated into amino acids (e.g., 5′ and 3′ untranslated regions).

As used herein, the term “vector” refers to a nucleic acid molecule capable of transporting another nucleic acid to which it has been linked. One type of vector is a “plasmid”, which refers to a circular double stranded DNA loop into which additional DNA segments may be ligated. Another type of vector is a viral vector, wherein additional DNA segments may be ligated into the viral genome. Certain vectors are capable of autonomous replication in a host cell into which they are introduced (e.g., bacterial vectors having a bacterial origin of replication and episomal mammalian vectors). Other vectors (e.g., non-episomal mammalian vectors) are integrated into the genome of a host cell upon introduction into the host cell, and thereby are replicated along with the host genome. Moreover, certain vectors are capable of directing the expression of genes to which they are operatively linked. Such vectors are referred to herein as “recombinant expression vectors” or simply “expression vectors”. In general, expression vectors of utility in recombinant DNA techniques are often in the form of plasmids. In the present specification, “plasmid” and “vector” may be used interchangeably as the plasmid is the most commonly used form of vector. However, the invention is intended to include such other forms of expression vectors, such as viral vectors (e.g., replication defective retroviruses, adenoviruses and adeno-associated viruses), which serve equivalent functions.

As used herein, the term “host cell” is intended to refer to a cell into which a nucleic acid of the invention, such as a recombinant expression vector of the invention, has been introduced. The terms “host cell” and “recombinant host cell” are used interchangeably herein. It should be understood that such terms refer not only to the particular subject cell but to the progeny or potential progeny of such a cell. Because certain modifications may occur in succeeding generations due to either mutation or environmental influences, such progeny may not, in fact, be identical to the parent cell, but are still included within the scope of the term as used herein.

As used herein, a “transgenic animal” refers to a non-human animal, preferably a mammal, more preferably a mouse, in which one or more of the cells of the animal includes a “transgene”. The term “transgene” refers to exogenous DNA which is integrated into the genome of a cell from which a transgenic animal develops and which remains in the genome of the mature animal, for example directing the expression of an encoded gene product in one or more cell types or tissues of the transgenic animal.

As used herein, a “homologous recombinant animal” refers to a type of transgenic non-human animal, preferably a mammal, more preferably a mouse, in which an endogenous gene has been altered by homologous recombination between the endogenous gene and an exogenous DNA molecule introduced into a cell of the animal, e.g., an embryonic cell of the animal, prior to development of the animal.

As used herein, an “isolated protein” or “isolated polypeptide” refers to a protein or polypeptide that is substantially free of other proteins, polypeptides, cellular material and culture medium when isolated from cells or produced by recombinant DNA techniques, or chemical precursors or other chemicals when chemically synthesized. An “isolated” or “purified” protein or biologically active portion thereof is substantially free of cellular material or other contaminating proteins from the cell or tissue source from which the protein is derived, or substantially free from chemical precursors or other chemicals when chemically synthesized. The language “substantially free of cellular material” includes preparations of T-bet protein in which the protein is separated from cellular components of the cells from which it is isolated or recombinantly produced.

As used herein, the term “antibody” is intended to include immunoglobulin molecules and immunologically active portions of immunoglobulin molecules, i.e., molecules that contain an antigen binding site which specifically binds (immunoreacts with) an antigen, such as Fab and F(ab′)₂ fragments. The terms “monoclonal antibodies” and “monoclonal antibody composition”, as used herein, refer to a population of antibody molecules that contain only one species of an antigen binding site capable of immunoreacting with a particular epitope of an antigen, whereas the term “polyclonal antibodies” and “polyclonal antibody composition” refer to a population of antibody molecules that contain multiple species of antigen binding sites capable of interacting with a particular antigen. A monoclonal antibody compositions thus typically display a single binding affinity for a particular antigen with which it immunoreacts.

As used here, the term “intrabodies” refers to intracellularly expressed antibody constructs, usually single-chain Fv (scFv) antibodies, directed against a target inside a cell, e.g. an intracellular protein such as T-bet.

As used herein, the term “dominant negative T-bet protein” includes T-bet molecules (e.g., portions or variants thereof) that compete with native (i.e., naturally occurring wild-type) T-bet molecules, but which do not have T-bet activity. Such molecules effectively decrease T-bet activity in a cell. As used herein, “dominant negative T-bet protein” refers to a modified form of T-bet which is a potent inhibitor of T-bet activity.

As used herein, the term “cell” includes prokaryotic and eukaryotic cells. In one embodiment, a cell of the invention is a bacterial cell. In another embodiment, a cell of the invention is a fungal cell, such as a yeast cell. In another embodiment, a cell of the invention is a vertebrate cell, e.g., an avian or mammalian cell. In a preferred embodiment, a cell of the invention is a murine or human cell.

As used herein, the term “immune cell” includes cells that are of hematopoietic origin and that play a role in the immune response. Immune cells include lymphocytes, such as B cells and T cells; natural killer cells; and myeloid cells, such as monocytes, macrophages, eosinophils, mast cells, basophils, and granulocytes.

As used herein, the term “dendritic cell” refers to a type of antigen-presenting cell which is particularly active in stimulating T cells. Dendritic cells can be obtained by culturing bone-marrow cells in the presence of GM-CSF and selecting those cells that express MHC class II molecules and CD11c. Dendritic cells can also express CD11b⁺, DEC-205⁺, CD8-alpha⁺.

As used herein, the term “site of antigen presentation to a naïve T cell” includes those sites within lymphoid tissues where naive CD4+ T cells first come into contact with antigen, e.g., as presented by interdigitating dendritic cells during an in vivo primary immune response.

The terms “antigen presenting cell” and “APC”, as used interchangeably herein, include professional antigen presenting cells (e.g., B lymphocytes, monocytes, dendritic cells, and Langerhans cells) as well as other antigen presenting cells (e.g., keratinocytes, endothelial cells, astrocytes, fibroblasts, and oligodendrocytes).

As used herein, the term “T cell” (i.e., T lymphocyte) is intended to include all cells within the T cell lineage, including thymocytes, immature T cells, mature T cells and the like, from a mammal (e.g., human). T cells include mature T cells that express either CD4 or CD8, but not both, and a T cell receptor. The various T cell populations described herein can be defined based on their cytokine profiles and their function.

As used herein “progenitor T cells” (“Thp”) are naïve, pluripotent cells that express CD4.

As used herein, the term “naïve T cells” includes T cells that have not been exposed to cognate antigen and so are not activated or memory cells. Naïve T cells are not cycling and human naïve T cells are CD45RA+. If naïve T cells recognize antigen and receive additional signals depending upon but not limited to the amount of antigen, route of administration and timing of administration, they may proliferate and differentiate into various subsets of T cells, e.g., effector T cells.

As used herein, the term “peripheral T cells” refers to mature, single positive T cells that leave the thymus and enter the peripheral circulation.

As used herein, the term “differentiated” refers to T cells that have been contacted with a stimulating agent and includes effector T cells (e.g., Th1, Th2) and memory T cells. Differentiated T cells differ in expression of several surface proteins compared to naïve T cells and secrete cytokines that activate other cells.

As used herein, the term “memory T cell” includes lymphocytes which, after exposure to antigen, become functionally quiescent and which are capable of surviving for long periods in the absence of antigen. Human memory T cells are CD45RA−.

As used herein, the term “effector T cell” includes T cells which function to eliminate antigen (e.g., by producing cytokines which modulate the activation of other cells or by cytotoxic activity). The term “effector T cell” includes T helper cells (e.g., Th1 and Th2 cells) and cytotoxic T cells. Th1 cells mediate delayed type hypersensitivity responses and macrophage activation while Th2 cells provide help to B cells and are critical in the allergic response (Mosmann and Coffman, 1989, Annu. Rev. Immunol. 7, 145-173; Paul and Seder, 1994, Cell 76, 241-251; Arthur and Mason, 1986, J. Exp. Med. 163, 774-786; Paliard et al., 1988, J. Immunol. 141, 849-855; Finkelman et al., 1988, J. Immunol. 141, 2335-2341). As used herein, the term “T helper type 1 response” (Th1 response) refers to a response that is characterized by the production of one or more cytokines selected from IFN-γ, IL-2, TNF, and lymphotoxin (LT) and other cytokines produced preferentially or exclusively by Th1 cells rather than by Th2 cells.

As used herein, the term “regulatory T cell” includes T cells which produce low levels of IL-2, IL-4, IL-5, and IL-12. Regulatory T cells produce TNFα, TGFβ, IFN-γ, and IL-10, albeit at lower levels than effector T cells. Although TGFβ is the predominant cytokine produced by regulatory T cells, the cytokine is produced at lower levels than in Th1 or Th2 cells, e.g., an order of magnitude less than in Th1 or Th2 cells. Regulatory T cells can be found in the CD4+CD25+ population of cells (see, e.g., Waldmann and Cobbold. 2001. Immunity. 14:399). Regulatory T cells actively suppress the proliferation and cytokine production of Th1, Th2, or naïve T cells which have been stimulated in culture with an activating signal (e.g., antigen and antigen presenting cells or with a signal that mimics antigen in the context of MHC, e.g., anti-CD3 antibody plus anti-CD28 antibody).

As used herein, the term “cellular differentiation” includes the process by which the developmental potential of cells is restricted and they acquire specific developmental fates. Differentiated cells are recognizably different from other cell types.

As used herein, the term “lineage commitment” refers to the program that initiates T cell lineage development from a precursor cell, e.g., a Thp cell, into a fully differentiated effector cell of a specific lineage, e.g., into a T cell that secretes a specific profile of cytokines upon receptor-mediated stimulation, such as a Th1 or a Th2 cell.

As used herein, the term “Th2 lineage commitment” refers to the developmental program that initiates T cell lineage development from a precursor cell, e.g., a Thp cell, into a fully differentiated Th2 effector cell of a specific lineage”, e.g., drives Th2 genetic programs while repressing the development of the opposing Th1 genetic programs. As described herein, the interaction of, for example, T-bet, with a kinase molecule, e.g., a tyrosine kinase molecule, e.g., a Tec molecule, e.g., Itk, leads to the phosphorylation of T-bet and subsequently to a decrease in Th2 lineage commitment. A decrease in Th2 lineage commitment can be measured by, for example, measuring Th2-specific cytokines, e.g., IL-4, IL-5 and IL-10, or Th1 cytokines, e.g., IFNγ.

As used herein, the term “directly modulates Th2 lineage commitment” refers to modulation of Th2 lineage commitment by modulation of the kinase-mediated binding of T-bet to a GATA-3 to thereby control the transcription of Th2 cytokine genes. For example, as discussed above, the polarization of an uncommitteted or naïve T cell into a differentiated, committed T cell was previously thought to be controlled by the cytokines themselves by forming a positive and negative feedback system (Powrie and Coffinan, 1993, immunol. Today 14, 270-274; Scott, 1991, J. Immunol. 147, 3149; Maggi et al., 1992, J. Immunol. 148, 2142; Parronchi et al., 1992, J. Immunol. 149, 2977; Fargeas et al., 1992, Eur. J. Immunol. 149, 2977; Manetti et al., 1993, J. Exp. Med. 177, 1199; Trinchieri, 1993, Immunol. Today 14, 335-338; Macatonia et al., 1993, Immunol. 5, 1119; Seder et al., 1993, Proc. Natl. Acad. Sci. USA 90, 10188-10192; Wu et al., 1993, J. Immunol. 151, 1938; Hsieh et al., 1993, Science 260, 547-549) (reviewed in (Seder and Paul, 1994, In Annual Review of Immunology, Vol. 12, 635-673; Paul and Seder, 1994, Cell 76, 241-251; O'Garra, 1998, Immunity 8, 275-283). However, as described herein, it is not the opposition of Th1 and Th2 cytokines themselves, or the activation of Th1 cytokines, but rather it is the direct repression of GATA3, the transcription factor that promotes expression of Th2 cytokines. More specifically, Th2 lineage commitment is repressed by kinase-mediated interaction between GATA-3 and T-bet. Conversely, Th2 lineage commitment is increased by a reduction in the kinase-mediated interaction between GATA-3 and T-bet. Agents that enhance or reduce the the kinase-, e.g., tyrosine kinase-, mediated interaction between GATA-3 and T-bet, or the phosphorylation of T-bet by a kinase, e.g., a tyrosine kinase, e.g., Itk, are agents which directly modulate Th2 lineage commitment by modulating Th2 cytokine production.

As used herein, the term “indirectly modulates Th2 lineage commitment” refers to the modulation of Th2 lineage commitment, not by the direct modulation of kinase-mediated T-bet GATA3 interaction, but to the modulation of Th2 lineage commmitment by modulating the cytokine milieu, e.g., by modulating Th1 cytokine production or by modulating other components of a signal transduction pathway involving T-bet.

As used herein, the term “receptor” includes immune cell receptors that bind antigen, complexed antigen (e.g., in the context of MHC molecules), or antibodies. Activating receptors include T cell receptors (TCRs), B cell receptors (BCRs), cytokine receptors, LPS receptors, complement receptors, and Fc receptors. For example, T cell receptors are present on T cells and are associated with CD3 molecules. T cell receptors are stimulated by antigen in the context of MHC molecules (as well as by polyclonal T cell activating reagents). T cell activation via the TCR results in numerous changes, e.g., protein phosphorylation, membrane lipid changes, ion fluxes, cyclic nucleotide alterations, RNA transcription changes, protein synthesis changes, and cell volume changes.

As used herein, the term “immune response” includes immune cell-mediated (e.g., T cell and/or B cell-mediated) immune responses that are influenced by modulation of immune cell activation. Exemplary immune responses include B cell responses (e.g., antibody production, e.g., IgA production), T cell responses (e.g., proliferation, cytokine production and cellular cytotoxicity), and activation of cytokine responsive cells, e.g., macrophages. In one embodiment of the invention, an immune response is T cell mediated. In another embodiment of the invention, an immune response is B cell mediated. As used herein, the term “downregulation” with reference to the immune response includes a diminution in any one or more immune responses, preferably T cell responses, while the term “upregulation” with reference to the immune response includes an increase in any one or more immune responses, preferably T cell responses. It will be understood that upregulation of one type of immune response may lead to a corresponding downregulation in another type of immune response. For example, upregulation of the production of certain cytokines (e.g., IL-10) can lead to downregulation of cellular immune responses

As used herein, the term “T helper type 1 response” refers to a response that is characterized by the production of one or more cytokines selected from IFN-γ, IL-2, TNF, and lymphtoxin (LT) and other cytokines produced preferentially or exclusively by Th1 cells rather than by Th2 cells.

As used herein, a “T helper type 2 response” (Th2 response) refers to a response by CD4⁺ T cells that is characterized by the production of one or more cytokines selected from IL-4, IL-5, IL-6 and IL-10, and that is associated with efficient B cell “help” provided by the Th2 cells (e.g., enhanced IgG1 and/or IgE production).

As used herein, the term “disorders that would benefit from treatment with an agent that increases Th2 lineage commitment” includes disorders in which T-bet activity is aberrant or which would benefit from modulation of a T-bet activity. The agent may directly or indirectly increase Th2 lineage development.

As used herein, the term “contacting” (i.e., contacting a cell e.g. a cell, with a compound) includes incubating the compound and the cell together in vitro (e.g., adding the compound to cells in culture) as well as administering the compound to a subject such that the compound and cells of the subject are contacted in vivo. The term “contacting” does not include exposure of cells to an T-bet modulator that may occur naturally in a subject (i.e., exposure that may occur as a result of a natural physiological process).

As described in the appended Examples, T-bet modulates the production of Th1 and Th2 cytokines. In addition, when T-bet is inhibited, e.g., in T-bet deficient cells, it results in the increase in Th2 lineage commitment. In one embodiment, the T-bet activity is a direct activity, such as an association with a T-bet-target molecule or complex of T-bet with a binding partner, e.g., GATA3 and Tec kinase. As used herein, the term “target molecule” or “binding partner” is a molecule with which T-bet binds or interacts in nature, and which interaction results in a biological response. The target molecule can be a protein or a nucleic acid molecule. Exemplary target molecules of the invention include proteins in the same signaling pathway as the T-bet protein, e.g., proteins which may function upstream (including both stimulators and inhibitors of activity) or downstream of the T-bet protein in a pathway involving for example, modulation of T cell lineage commitment, modulating the production of cytokines, modulating TGF-β mediated signaling, modulating the Jak1/STAT-1 pathway, modulating IgG class switching, modulating B lymphocyte function, and modulating an autoimmune disease. Exemplary T-bet target molecules include tyrosine kinases, e.g., a Tec kinase such as ITK or Rik or DNA sequences with which T-bet interacts to modulate gene transcription.

As used herein, the term “gene whose transcription is regulated by T-bet”, includes genes having a regulatory region regulated by T-bet. Such genes can be positively or negatively regulated by T-bet. The term also includes genes which are indirectly modulated by T-bet, i.e., are modulated as the result of the activation of a signaling pathway in which T-bet is involved. Exemplary genes regulated by T-bet include, for example, GATA3, and the cytokine genes, e.g., IL-2, IFN-γ, IL-4, IL-5, TNFα, TGF-β, LT(lymphotoxin), and IL-10.

As used herein, the term “Th1-associated cytokine” is intended to refer to a cytokine that is produced preferentially or exclusively by Th1 cells rather than by Th2 cells. Examples of Th1-associated cytokines include IFN-γ, IL-2, TNF, and lymphtoxin (LT).

As used herein, the term “Th2-associated cytokine” is intended to refer to a cytokine that is produced preferentially or exclusively by Th2 cells rather than by Th1 cells. Examples of Th1-associated cytokines include IL-4, IL-5, and IL-10.

The term “interact” as used herein is meant to include detectable interactions between molecules, such as can be detected using, for example, a yeast two hybrid assay or coimmunoprecipitation. The term interact is also meant to include “binding” interactions between molecules. Interactions may be protein-protein or protein-nucleic acid in nature.

The term “agent” or “compound” or “test compound” includes reagents or test agents which are employed in the methods or assays or present in the compositions of the invention. The term “agent” or “compound” or “test compound” includes compounds that have not previously been identified as, or recognized to be, a modulator of T-bet expression or activity. In one embodiment, more than one compound, e.g., a plurality of compounds, can be tested at the same time in a screening assay for their ability to modulate expression and/or activity of T-bet or a molecule acting upstream or downstream of T-bet in a signal transduction pathway. The term “library of test compounds” refers to a panel comprising a multiplicity of test compounds.

In one embodiment, the term “agent” or “compound” or “test compound” excludes naturally occurring compounds such as cytokines. In another embodiment, the term agent excludes antibodies which bind to naturally occurring cytokines. In another embodiment, the term “agent” excludes antibodies that bind to cytokine receptors. In yet another embodiment, the term “agent” excludes those agents that transduce signals via the T cell receptor, e.g., antigen in the context of an MHC molecule or antibody to a component of the T cell receptor complex. In one embodiment, the agent or test compound is a compound that directly interacts with T-bet or directly interacts with a molecule with which T-bet interacts (e.g., a compound that inhibits or stimulates the interaction between T-bet and a T-bet target molecule, e.g., DNA or another protein). In another embodiment, the compound is one that indirectly modulates T-bet expression and/or activity, e.g., by modulating the activity of a molecule that is upstream or downstream of T-bet in a signal transduction pathway involving T-bet. Such compounds can be identified using screening assays that select for such compounds, as described in detail below.

The term “small molecule” is a term of the art and includes molecules that are less than about 1000 molecular weight or less than about 500 molecular weight. In one embodiment, small molecules do not exclusively comprise peptide bonds. In another embodiment, small molecules are not oligomeric. Exemplary small molecule compounds which can be screened for activity include, but are not limited to, peptides, peptidomimetics, nucleic acids, carbohydrates, small organic molecules (e.g., polyketides) (Cane et al. 1998. Science 282:63), and natural product extract libraries. In another embodiment, the compounds are small, organic non-peptidic compounds. In a further embodiment, a small molecule is not biosynthetic.

As used herein, the term “test compound” includes a compound that has not previously been identified as, or recognized to be, a modulator of T-bet activity and/or expression and/or a modulator of cell growth, survival, differentiation and/or migration.

The term “library of test compounds” is intended to refer to a panel comprising a multiplicity of test compounds.

As used herein, the term “engineered” (as in an engineered cell) refers to a cell into which a nucleic acid molecule encoding the T-bet protein has been introduced.

As used herein, the term “reporter gene” refers to any gene that expresses a detectable gene product, e.g., RNA or protein. Preferred reporter genes are those that are readily detectable. The reporter gene may also be included in a construct in the form of a fusion gene with a gene that includes desired transcriptional regulatory sequences or exhibits other desirable properties. Examples of reporter genes include, but are not limited to CAT (chloramphenicol acetyl transferase) (Alton and Vapnek (1979), Nature 282: 864-869) luciferase, and other enzyme detection systems, such as beta-galactosidase; firefly luciferase (deWet et al. (1987), Mol. Cell. Biol. 7:725-737); bacterial luciferase (Engebrecht and Silverman (1984), PNAS 1: 4154-4158; Baldwin et al. (1984), Biochemistry 23: 3663-3667); alkaline phosphatase (Toh et al. (1989) Eur. J. Biochem. 182: 231-238, Hall et al. (1983) J. Mol. Appl. Gen. 2: 101), human placental secreted alkaline phosphatase (Cullen and Malim (1992) Methods in Enzymol. 216:362-368) and green fluorescent protein (U.S. Pat. No. 5,491,084; WO 96/23898).

As used herein, the term “T-bet-responsive element” refers to a DNA sequence that is directly or indirectly regulated by the activity of T-bet (whereby activity of T-bet can be monitored, for example, via transcription of the reporter genes).

As used herein, the term “cells deficient in T-bet” is intended to include cells of a subject that are naturally deficient in T-bet, as wells as cells of a non-human T-bet deficient animal, e.g., a mouse, that have been altered such that they are deficient in T-bet. The term “cells deficient in T-bet” is also intended to include cells isolated from a non-human T-bet deficient animal or a subject that are cultured in vitro.

As used herein, the term “cell free composition” refers to an isolated composition which does not contain intact cells. Examples of cell free compositions include cell extracts and compositions containing isolated proteins.

As used herein, the term “indicator composition” refers to a composition that includes a protein of interest (e.g., T-bet), for example, a cell that naturally expresses the protein, a cell that has been engineered to express the protein by introducing an expression vector encoding the protein into the cell, or a cell free composition that contains the protein (e.g., purified naturally-occurring protein or recombinantly-engineered protein).

As used herein, the term “a modulator of T-bet” includes a modulator of T-bet expression, processing, post-translational modification, or activity. The term includes agents, for example a compound or compounds which modulates transcription of a T-bet gene, processing of a T-bet mRNA, translation of T-bet mRNA, post-translational modification of a T-bet protein (e.g., glycosylation, ubiquitinization or phosphorylation) or activity of a T-bet protein. A “modulator of T-bet activity” includes compounds that directly or indirectly modulate T-bet activity. For example, an indirect modulator of T-bet activity may modulate a signal transduction pathway that includes T-bet. Examples of modulators that directly modulate T-bet activity include antisense nucleic acid molecules that bind to T-bet mRNA or genomic DNA, intracellular antibodies that bind to T-bet intracellularly and modulate (i.e., inhibit) T-bet activity, T-bet peptides that inhibit the interaction of T-bet with a target molecule and expression vectors encoding T-bet that allow for increased expression of T-bet activity in a cell, dominant negative forms of T-bet, chemical compounds that act to specifically modulate the activity of T-bet, as well as Itk, a Tec kinase that phosphorylates, e.g., tyrosine phosphorylates T-bet, e.g., at tyrosine residue 525 (Y525).

As used herein an “agonist” of the T-bet proteins can retain substantially the same, or a subset, of the biological activities of the naturally occurring form of a T-bet protein. An “antagonist” of a T-bet protein can inhibit one or more of the activities of the naturally occurring form of the T-bet protein by, for example, competitively modulating a cellular activity of a T-bet protein.

As used interchangeably herein, “T-bet activity,” “biological activity of T-bet” or “functional activity T-bet,” include an activity exerted by T-bet protein on a T-bet responsive cell or tissue, e.g., a T cell, dendritic cells, NK cells, or on a T-bet target molecule, e.g., a nucleic acid molecule or protein target molecule, as determined in vivo, or in vitro, according to standard techniques. In one embodiment, T-bet activity is a direct activity, such as an association with a T-bet-target molecule. Alternatively, a T-bet activity is an indirect activity, such as a downstream biological event mediated by interaction of the T-bet protein with a T-bet target molecule. The biological activities of T-bet are described herein and include, but are not limited to: modulation, e.g., decrease of Th2 cell lineage commitment, modulation of IFN-γ production in cells of the innate and adaptive immune system, modulation of the production of cytokines, modulation of TGF-β mediated signaling, modulation of the Jak1/STAT-1 pathway, modulation of IgG class switching, modulation of B lymphocyte function, and modulation of disorders that would benefit from modulation of T-bet, e.g., autoimmune diseases, multiple sclerosis or rheumatoid arthritis, infection, e.g., with a virus or a bacterium, asthma, and other disorders or unwanted conditions in which Th1 or Th2 cytokines are implicated, e.g., inflammation. These findings provide for the use of T-bet (and other molecules in the pathways in which T-bet is involved) as drug targets and as targets for therapeutic intervention in various diseases, disorders or conditions. The invention yet further provides immunomodulatory compositions, such as vaccines, comprising agents which modulate T-bet activity.

As used herein, the term “signal transduction pathway” includes the means by which a cell converts an extracellular influence or signal (e.g., a signal transduced by a receptor on the surface of a cell, such as a cytokine receptor or an antigen receptor) into a cellular response (e.g., modulation of gene transcription). Exemplary signal transduction pathways include the JAK1/STAT-1 pathway (Leonard, W. 2001. Int. J. Hematol. 73:271) and the TGF-β pathway (Attisano and Wrana. 2002. Science. 296:1646) A “signal transduction pathway involving T-bet” is one in which T-bet is a signaling molecule which relays signals.

As used herein, the term “Tec kinase” refers to a family of tyrosine kinases (phosphotyrosine kinases (PTK)). Although similar in structure to the Src family kinases, the Tec kinases lack the C-terminal regulatory tyrosine and the N-terminal myristoylation signals that characterize the Src family. Instead the Tec kinases possess a proline-rich region just upstream of the SH3 domain. Tec kinases are, thus characterized by an NH2-terminal phosphatidylinositol phosphate binding pleckstrin homology domain, (PH) domain (absent in Txk), followed by a proline-rich region, Src-homology 3 (SH3) and SH2 interaction domains, and a COOH-terminal and a catalytic domain (PTK or SH1 domain, i.e., amino acid residues 355 to 615 of SEQ ID NO:14). Tec kinases are expressed in T cells, and are involved in signals emanating from cytokine receptors, antigen receptors, and other lymphoid cell surface receptors, such as T cell antigen receptor mediated activation of T cells (M. J. Czar, et al. (2001) Biochem. Soc. Trans. 29:863-867).

The Tec family of protein tyrosine kinases play an important role in signaling through antigen-receptors such as the TCR, BCR and Fcε receptor. Members of the Tec kinase family of tyrosine kinases include, for example, Tec, Btk, Itk, Rlk and Bmx. The nucleotide sequence and amino acid sequence of human Tec, is described in, for example, GenBank Accession Nos. gi:4507428 and gi:4507429 (SEQ ID Nos.:5 and 6). The nucleotide sequence and amino acid sequence of murine Tec, is described in, for example, GenBank Accession No. gi:24475948 and gi:7305569 (SEQ ID NOs.:7 and 8). The nucleotide sequence and amino acid sequence of human ITK, is described in, for example, GenBank Accession Nos. gi:21614549 and gi:15718680 (SEQ ID Nos.:13 and 14). The nucleotide sequence and amino acid sequence of murine Itk, is described in, for example, GenBank Accession No. gi:6754385 and gi:6754386 (SEQ ID NOs.:15 and 16). The nucleotide sequence and amino acid sequence of human RLK, is described in, for example, GenBank Accession No. gi:4507742 and gi:4507743 (SEQ ID NOs.:18 and 19). The nucleotide sequence and amino acid sequence of murine RLK, is described in, for example, GenBank Accession No. gi:7305600 and gi:7305601 (SEQ ID NOs.:20 and 21).

“GATA3” is a Th2-specific transcription factor that is required for the development of Th2 cells. GATA-binding proteins constitute a family of transcription factors that recognize a target site conforming to the consensus WGATAR (W=A or T and R=A or G). The nucleotide sequence and amino acid sequence of human GATA3, is described in, for example, GenBank Accession Nos. gi:4503928, gi:50541957, and gi:4503929 (SEQ ID Nos.:9, 10, and 17). The nucleotide sequence and amino acid sequence of murine GATA3, is described in, for example, GenBank Accession No. gi:40254638 and gi:6679951 (SEQ ID Nos.:11 and 12). The domains of GATA3 responsible for specific DNA-binding site recognition (amino acids 303 to 348) and trans activation (amino acids 30 to 74) have been identified. The signaling sequence for nuclear localization of human GATA-3 is a property conferred by sequences within and surrounding the amino finger (amino acids 249 to 311) of the protein. Exemplary genes whose transcription is regulated by GATA3 include IL-5, IL-12, IL-13, and IL-12Rβ2.

Various aspects of the invention are described in further detail in the following subsections:

I. Isolated Nucleic Acid Molecules

One aspect of the invention pertains to isolated nucleic acid molecules that encode T-bet. Such molecules may be used, for example, to make T-bet polypeptides or portions thereof for use in the subject methods. In a preferred embodiment, the nucleic acid molecule of the invention comprises the nucleotide sequence shown in SEQ ID NO:1 or SEQ ID NO:3. In another embodiment, a nucleic acid molecule of the invention comprises at least about 700 contiguous nucleotides of SEQ ID NO:1 or at least about 500 contiguous nucleotides of SEQ ID NO:3. In a preferred embodiment, a nucleic acid molecule of the invention comprises at least about 800, at least about 1000, at east about 1200, at least about 1400 or at least about 1600 contiguous nucleotides of SEQ ID NO:1. In another preferred embodiment, a nucleic acid molecule of the invention comprises at least about 600, at least about 800, at least about 1000, at least about 1200, or at least about 1400 contiguous nucleotides of SEQ ID NO:3.

In other embodiments, the nucleic acid molecule has at least 70% identity, more preferably 80% identity, and even more preferably 90% identity with a nucleic acid molecule comprising: at least about 700, at least about 800, at least about 1000, at east about 1200, at least about 1400 or at least about 1600 contiguous nucleotides of SEQ ID NO:1. In other embodiments, the nucleic acid molecule has at least 70% identity, more preferably 80% identity, and even more preferably 90% nucleotide identity with a nucleic acid molecule comprising: at least about 600, at least about 800, at least about 1000, at least about 1200, or at least about 1400 contiguous nucleotides of SEQ ID NO:3.

Nucleic acid molecules that differ from SEQ ID NO:1 or 3 due to degeneracy of the genetic code, and thus encode the same T-bet protein as that encoded by SEQ ID NO:1 and 3, are encompassed by the invention. Accordingly, in another embodiment, an isolated nucleic acid molecule of the invention has a nucleotide sequence encoding a protein having an amino acid sequence shown in SEQ ID NO: 2 or SEQ ID NO:4.

In addition, nucleic acid molecules encoding T-bet proteins can be isolated from other sources using standard molecular biology techniques and the sequence information provided herein. For example, a T-bet DNA can be isolated from a human genomic DNA library using all or portion of SEQ ID NO:1 or 3 as a hybridization probe and standard hybridization techniques (e.g., as described in Sambrook, J., et al. Molecular Cloning: A Laboratory Manual. 2nd, ed., Cold Spring Harbor Laboratory, Cold Spring Harbor, N.Y., 1989). Moreover, a nucleic acid molecule encompassing all or a portion of a T-bet gene can be isolated by the polymerase chain reaction using oligonucleotide primers designed based upon the sequence of SEQ ID NO: 1 or 3. For example, mRNA can be isolated from cells (e.g., by the guanidinium-thiocyanate extraction procedure of Chirgwin et al. (1979) Biochemistry 18: 5294-5299) and cDNA can be prepared using reverse transcriptase (e.g., Moloney MLV reverse transcriptase, available from Gibco/BRL, Bethesda, Md.; or AMV reverse transcriptase, available from Seikagaku America, Inc., St. Petersburg, Fla.). Synthetic oligonucleotide primers for PCR amplification can be designed based upon the nucleotide sequence shown in SEQ ID NO: 1 or 3. A nucleic acid of the invention can be amplified using cDNA or, alternatively, genomic DNA, as a template and appropriate oligonucleotide primers according to standard PCR amplification techniques. The nucleic acid so amplified can be cloned into an appropriate vector and characterized by DNA sequence analysis. Furthermore, oligonucleotides corresponding to a T-bet nucleotide sequence can be prepared by standard synthetic techniques, e.g., using an automated DNA synthesizer.

In addition to the T-bet nucleotide sequence shown in SEQ ID NO: 1 and 3, it will be appreciated by those skilled in the art that DNA sequence polymorphisms that lead to minor changes in the nucleotide or amino acid sequences of T-bet may exist within a population. Such genetic polymorphism in the T-bet gene may exist among individuals within a population due to natural allelic variation. Such natural allelic variations can typically result in 1-2% variance in the nucleotide sequence of the a gene. Any and all such nucleotide variations and resulting amino acid polymorphisms in T-bet that are the result of natural allelic variation and that do not alter the functional activity of T-bet are intended to be within the scope of the invention.

Nucleic acid molecules corresponding to natural allelic variants of the T-bet DNAs of the invention can be isolated based on their homology to the T-bet nucleic acid molecules disclosed herein using the human DNA, or a portion thereof, as a hybridization probe according to standard hybridization techniques under high stringency hybridization conditions. Exemplary high stringency conditions include hybridization in a hybridization buffer that contains 6× sodium chloride/sodium citrate (SSC) at a temperature of about 45° C. for several hours to overnight, followed by one or more washes in a washing buffer containing 0.2×SSC, 0.1% SDS at a temperature of about 50-65° C. Accordingly, in another embodiment, an isolated nucleic acid molecule of the invention hybridizes under high stringency conditions to a second nucleic acid molecule comprising the nucleotide sequence of SEQ ID NO: 1 or 3. Preferably, an isolated nucleic acid molecule of the invention that hybridizes under high stringency conditions to the sequence of SEQ ID NO: of SEQ ID NO:1 or 3. In one embodiment, such a nucleic acid molecule is at least about 700, 800, 900, 1000, 1200, 1300, 1400, 1500, or 1600 nucleotides in length. In another embodiment, such a nucleic acid molecule and comprises at least about 700, 800, 900, 1000, 1200, 1300, 1400, 1500, or 1600 contiguous nucleotides of SEQ ID NO: 1 or at least about 500, 600, 700, 800, 900, 1000, 1100, 1200, 1300, 1400, or 1500 contiguous nucleotides of SEQ ID NO: 3. Preferably, an isolated nucleic acid molecule corresponds to a naturally-occurring allelic variant of a T-bet nucleic acid molecule.

In addition to naturally-occurring allelic variants of the T-bet sequence that may exist in the population, the skilled artisan will further appreciate that minor changes may be introduced by mutation into the nucleotide sequence of SEQ ID NO: 1 or 3, thereby leading to changes in the amino acid sequence of the encoded protein, without altering the functional activity of the T-bet protein. For example, nucleotide substitutions leading to amino acid substitutions at “non-essential” amino acid residues may be made in the sequence of SEQ ID NO: 1 or 3. A “non-essential” amino acid residue is a residue that can be altered from the wild-type sequence of T-bet (e.g., the sequence of SEQ ID NO: 1 or 3) without altering the functional activity of T-bet, such as its ability to interact with DNA or its ability to enhance transcription from an IFN-γ promoter, whereas an “essential” amino acid residue is required for functional activity.

Accordingly, another aspect of the invention pertains to nucleic acid molecules encoding T-bet proteins that contain changes in amino acid residues that are not essential for T-bet activity. Such T-bet proteins differ in amino acid sequence from SEQ ID NO: 2 or 4 yet retain T-bet activity. An isolated nucleic acid molecule encoding a non-natural variant of a T-bet protein can be created by introducing one or more nucleotide substitutions, additions or deletions into the nucleotide sequence of SEQ ID NO: 1 or 3 such that one or more amino acid substitutions, additions or deletions are introduced into the encoded protein. Mutations can be introduced into SEQ ID NO: 1 or 3 by standard techniques, such as site-directed mutagenesis and PCR-mediated mutagenesis. Preferably, conservative amino acid substitutions are made at one or more non-essential amino acid residues. A “conservative amino acid substitution” is one in which the amino acid residue is replaced with an amino acid residue having a similar side chain. Families of amino acid residues having similar side chains have been defined in the art, including basic side chains (e.g., lysine, arginine, histidine), acidic side chains (e.g., aspartic acid, glutamic acid), uncharged polar side chains (e.g., glycine, asparagine, glutamine, serine, threonine, tyrosine, cysteine), nonpolar side chains (e.g., alanine, valine, leucine, isoleucine, proline, phenylalanine, methionine, tryptophan), beta-branched side chains (e.g., threonine, valine, isoleucine) and aromatic side chains (e.g., tyrosine, phenylalanine, tryptophan, histidine). Thus, a nonessential amino acid residue in T-bet is preferably replaced with another amino acid residue from the same side chain family.

Alternatively, in another embodiment, mutations can be introduced randomly along all or part of the T-bet coding sequence, such as by saturation mutagenesis, and the resultant mutants can be screened for their ability to bind to DNA and/or activate transcription, to identify mutants that retain functional activity. Following mutagenesis, the encoded T-bet mutant protein can be expressed recombinantly in a host cell and the functional activity of the mutant protein can be determined using assays available in the art for assessing T-bet activity (e.g., by measuring the ability of the protein to bind to a T-box binding element present in DNA or by measuring the ability of the protein to modulate a Th1 or Th2 phenotype in a T cell.

Another aspect of the invention pertains to isolated nucleic acid molecules that are antisense to the coding strand of a T-bet mRNA or gene. An antisense nucleic acid of the invention can be complementary to an entire T-bet coding strand, or to only a portion thereof. In one embodiment, an antisense nucleic acid molecule is antisense to a coding region of the coding strand of a nucleotide sequence encoding T-bet that is unique to the T-bet family of proteins or which is unique to a T-bet sequence from a particular species. In another embodiment, the antisense nucleic acid molecule is antisense to a noncoding region of the coding strand of a nucleotide sequence encoding T-bet that is unique to T-bet family of proteins or which is unique to a T-bet sequence from a particular species. In preferred embodiments, an antisense molecule of the invention comprises at least about 700 contiguous nucleotides of the noncoding strand of SEQ ID NO: 1, more preferably at least 800, 1000, 1200, 1400, or 1600 contiguous nucleotides of the noncoding strand of SEQ ID NO: 1 or at least about 500 contiguous nucleotides of the noncoding strand of SEQ ID NO: 3, more preferably at least 600, 800, 1000, 1200, or 1400 contiguous nucleotides of the noncoding strand of SEQ ID NO: 3.

Given the coding strand sequences encoding T-bet disclosed herein (e.g., SEQ ID NOs: 1 and 3, antisense nucleic acids of the invention can be designed according to the rules of Watson and Crick base pairing. The antisense nucleic acid molecule may be complementary to the entire coding region of T-bet mRNA, or alternatively can be an oligonucleotide which is antisense to only a portion of the coding or noncoding region of T-bet mRNA. For example, the antisense oligonucleotide may be complementary to the region surrounding the translation start site of T-bet mRNA. An antisense oligonucleotide can be, for example, about 15, 20, 21, 22, 23, 24, 25, 30, 35, 40, 45 or 50 nucleotides in length. An antisense nucleic acid of the invention can be constructed using chemical synthesis and enzymatic ligation reactions using procedures known in the art. For example, an antisense nucleic acid (e.g., an antisense oligonucleotide) can be chemically synthesized using naturally occurring nucleotides or variously modified nucleotides designed to increase the biological stability of the molecules or to increase the physical stability of the duplex formed between the antisense and sense nucleic acids, e.g., phosphorothioate derivatives and acridine substituted nucleotides can be used. Alternatively, the antisense nucleic acid can be produced biologically using an expression vector into which a nucleic acid has been subcloned in an antisense orientation (i.e., RNA transcribed from the inserted nucleic acid will be of an antisense orientation to a target nucleic acid of interest, described further in the following subsection).

In another embodiment, an antisense nucleic acid of the invention is a ribozyme. Ribozymes are catalytic RNA molecules with ribonuclease activity which are capable of cleaving a single-stranded nucleic acid, such as an mRNA, to which they have a complementary region. A ribozyme having specificity for a T-bet-encoding nucleic acid can be designed based upon the nucleotide sequence of a T-bet gene disclosed herein. For example, a derivative of a Tetrahymena L-19 IVS RNA can be constructed in which the base sequence of the active site is complementary to the base sequence to be cleaved in a T-bet-encoding mRNA. See for example Cech et al. U.S. Pat. No. 4,987,071; and Cech et al. U.S. Pat. No. 5,116,742. Alternatively, T-bet mRNA can be used to select a catalytic RNA having a specific ribonuclease activity from a pool of RNA molecules. See for example Bartel, D. and Szostak, J. W. (1993) Science 261: 1411-1418.

In another embodiment, RNAi can be used to inhibit T-bet expression. RNA interference (RNAi is a post-transcriptional, targeted gene-silencing technique that uses double-stranded RNA (dsRNA) to degrade messenger RNA (mRNA) containing the same sequence as the dsRNA (Sharp, P. A. and Zamore, P. D. 287, 2431-2432 (2000); Zamore, P. D., et al. Cell 101, 25-33 (2000). Tuschl, T. et al. Genes Dev. 13, 3191-3197 (1999)). The process occurs when an endogenous ribonuclease cleaves the longer dsRNA into shorter, 21- or 22-nucleotide-long RNAs, termed small interfering RNAs or siRNAs. The smaller RNA segments then mediate the degradation of the target mRNA.

The antisense RNA strand of RNAi can be antisense to at least a portion of the coding region of T-bet or to at least a portion of the 5′ or 3′ untranslated region of the T-bet gene. In one embodiment, siRNA duplexes are composed of 21-nt sense and 21-nt antisense strands, paired in a manner to have a 2-nt 3′ overhang. In one embodiment, siRNA sequences with TT in the overhang. The target region can be, e.g., 50 to 100 nt downstream of the start codon, 3′-UTRs may also be targeted. In one embodiment, a 23-nt sequence motif AA(N19)TT (N, any nucleotide) can be searched for and hits with between about 30-70% G/C-content can be selected. If no suitable sequences are found, the search is extended using the motifNA(N21). SiRNAs are preferably chemically synthesized using appropriately protected ribonucleoside phosphoramidites and a conventional DNA/RNA synthesizer. SiRNAs are also available commercially from, e.g., Dharmacon, Xeragon Inc, Proligo, and Ambion. In one embodiment one or more of the chemistries described above for use in antisense RNA can be employed.

Yet another aspect of the invention pertains to isolated nucleic acid molecules encoding T-bet fusion proteins. Such nucleic acid molecules, comprising at least a first nucleotide sequence encoding a T-bet protein, polypeptide or peptide operatively linked to a second nucleotide sequence encoding a non-T-bet protein, polypeptide or peptide, can be prepared by standard recombinant DNA techniques. T-bet fusion proteins are described in further detail below in subsection III.

II. Recombinant Expression Vectors and Host Cells

Another aspect of the invention pertains to vectors, preferably recombinant expression vectors, containing a nucleic acid encoding T-bet (or a portion thereof). The expression vectors of the invention comprise a nucleic acid of the invention in a form suitable for expression of the nucleic acid in a host cell, which means that the recombinant expression vectors include one or more regulatory sequences, selected on the basis of the host cells to be used for expression, which is operatively linked to the nucleic acid sequence to be expressed. Within a recombinant expression vector, “operably linked” is intended to mean that the nucleotide sequence of interest is linked to the regulatory sequence(s) in a manner which allows for expression of the nucleotide sequence (e.g., in an in vitro transcription/translation system or in a host cell when the vector is introduced into the host cell). The term “regulatory sequence” includes promoters, enhancers and other expression control elements (e.g., polyadenylation signals). Such regulatory sequences are described, for example, in Goeddel; Gene Expression Technology: Methods in Enzymology 185, Academic Press, San Diego, Calif. (1990). Regulatory sequences include those which direct constitutive expression of a nucleotide sequence in many types of host cell and those which direct expression of the nucleotide sequence only in certain host cells (e.g., tissue-specific regulatory sequences). It will be appreciated by those skilled in the art that the design of the expression vector may depend on such factors as the choice of the host cell to be transformed, the level of expression of protein desired, etc. The expression vectors of the invention can be introduced into host cells to thereby produce proteins or peptides, including fusion proteins or peptides, encoded by nucleic acids as described herein (e.g., T-bet proteins, mutant forms of T-bet proteins, T-bet fusion proteins and the like).

The recombinant expression vectors of the invention can be designed for expression of T-bet protein in prokaryotic or eukaryotic cells. For example, T-bet can be expressed in bacterial cells such as E. coli, insect cells (using baculovirus expression vectors) yeast cells or mammalian cells. Suitable host cells are discussed further in Goeddel, Gene Expression Technology: Methods in Enzymology 185, Academic Press, San Diego, Calif. (1990). Alternatively, the recombinant expression vector may be transcribed and translated in vitro, for example using T7 promoter regulatory sequences and T7 polymerase.

Expression of proteins in prokaryotes is most often carried out in E. coli with vectors containing constitutive or inducible promoters directing the expression of either fusion or non-fusion proteins. Fusion vectors add a number of amino acids to a protein encoded therein, usually to the amino terminus of the recombinant protein. Such fusion vectors can serve one or more purposes: 1) to increase expression of recombinant protein; 2) to increase the solubility of the recombinant protein; 3) to aid in the purification of the recombinant protein by acting as a ligand in affinity purification; 4) to provide an epitope tag to aid in detection and/or purification of the protein; and/or 5) to provide a marker to aid in detection of the protein (e.g., a color marker using β-galactosidase fusions). Often, in fusion expression vectors, a proteolytic cleavage site is introduced at the junction of the fusion moiety and the recombinant protein to enable separation of the recombinant protein from the fusion moiety subsequent to purification of the fusion protein. Such enzymes, and their cognate recognition sequences, include Factor Xa, thrombin and enterokinase. Typical fusion expression vectors include pGEX (Pharmacia Biotech Inc.; Smith, D. B. and Johnson, K. S. (1988) Gene 67:31-40), pMAL (New England Biolabs, Beverly, Mass.) and pRIT5 (Pharmacia, Piscataway, N.J.) which fuse glutathione S-transferase (GST), maltose E binding protein, or protein A, respectively, to the target recombinant protein. Recombinant proteins also can be expressed in eukaryotic cells as fusion proteins for the same purposes discussed above.

Examples of suitable inducible non-fusion E. coli expression vectors include pTrc (Amann et al., (1988) Gene 69:301-315) and pET 11d (Studier et al., Gene Expression Technology: Methods in Enzymology 185, Academic Press, San Diego, Calif. (1990) 60-89). Target gene expression from the pTrc vector relies on host RNA polymerase transcription from a hybrid trp-lac fusion promoter. Target gene expression from the pET 11d vector relies on transcription from a T7 gn10-lac fusion promoter mediated by a coexpressed viral RNA polymerase (T7 gn1). This viral polymerase is supplied by host strains BL21 (DE3) or HMS174(DE3) from a resident λ prophage harboring a T7 gn1 gene under the transcriptional control of the lacUV 5 promoter.

One strategy to maximize recombinant protein expression in E. coli is to express the protein in a host bacteria with an impaired capacity to proteolytically cleave the recombinant protein (Gottesman, S., Gene Expression Technology: Methods in Enzymology 185, Academic Press, San Diego, Calif. (1990) 119-128). Another strategy is to alter the nucleic acid sequence of the nucleic acid to be inserted into an expression vector so that the individual codons for each amino acid are those preferentially utilized in E. coli (Wada et al., (1992) Nuc. Acids Res. 20:2111-2118). Such alteration of nucleic acid sequences of the invention can be carried out by standard DNA synthesis techniques.

In another embodiment, the T-bet expression vector is a yeast expression vector. Examples of vectors for expression in yeast S. cerivisae include pYepSec1 (Baldari. et al., (1987) EMBO J. 6:229-234), pMFa (Kurjan and Herskowitz, (1982). Cell 30:933-943), pJRY88 (Schultz et al., (1987) Gene 54:113-123), and pYES2 (Invitrogen Corporation, San Diego, Calif.).

Alternatively, T-bet can be expressed in insect cells using baculovirus expression vectors. Baculovirus vectors available for expression of proteins in cultured insect cells (e.g., Sf 9 cells) include the pAc series (Smith et al., (1983) Mol. Cell Biol. 3:2156-2165) and the pVL series (Lucklow, V. A., and Summers, M. D., (1989) Virology 170:31-39).

In yet another embodiment, a nucleic acid of the invention is expressed in mammalian cells using a mammalian expression vector. Examples of mammalian expression vectors include pMex-NeoI, pCDM8 (Seed, B., (1987) Nature 329:840) and pMT2PC (Kaufman et al. (1987), EMBO J. 6:187-195). When used in mammalian cells, the expression vector's control functions are often provided by viral regulatory elements. For example, commonly used promoters are derived from polyoma, Adenovirus 2, cytomegalovirus and Simian Virus 40.

In another embodiment, the recombinant mammalian expression vector is capable of directing expression of the nucleic acid preferentially in a particular cell type (e.g., tissue-specific regulatory elements are used to express the nucleic acid). Tissue-specific regulatory elements are known in the art. Non-limiting examples of suitable tissue-specific promoters include lymphoid-specific promoters (Calame and Eaton (1988) Adv. Immunol. 43:235-275), in particular promoters of T cell receptors (Winoto and Baltimore (1989) EMBO J. 8:729-733) and immunoglobulins (Banerji et al. (1983) Cell 33:729-740; Queen and Baltimore (1983) Cell 33:741-748), the albumin promoter (liver-specific; Pinkert et al. (1987) Genes Dev. 1:268-277), neuron-specific promoters (e.g., the neurofilament promoter; Byrne and Ruddle (1989) Proc. Natl. Acad. Sci. USA 86:5473-5477), pancreas-specific promoters (Edlund et al. (1985) Science 230:912-916), and mammary gland-specific promoters (e.g., milk whey promoter; U.S. Pat. No. 4,873,316 and European Application Publication No. 264,166). Developmentally-regulated promoters are also encompassed, for example the murine hox promoters (Kessel and Gruss (1990) Science 249:374-379) and the α-fetoprotein promoter (Campes and Tilghman (1989) Genes Dev. 3:537-546).

Moreover, inducible regulatory systems for use in mammalian cells are known in the art, for example systems in which gene expression is regulated by heavy metal ions (see e.g., Mayo et al. (1982) Cell 29:99-108; Brinster et al. (1982) Nature 296:39-42; Searle et al. (1985) Mol. Cell. Biol. 5:1480-1489), heat shock (see e.g., Nouer et al (1991) in Heat Shock Response, e.d. Nouer, L., CRC, Boca Raton, Fla., pp 167-220), hormones (see e.g., Lee et al. (1981) Nature 294:228-232; Hynes et al. (1981) Proc. Natl. Acad. Sci. USA 78:2038-2042; Klock et al. (1987) Nature 329:734-736; Israel & Kaufman (1989) Nucl. Acids Res. 17:2589-2604; and PCT Publication No. WO 93/23431), FK506-related molecules (see e.g., PCT Publication No. WO 94/18317) or tetracyclines (Gossen, M. and Bujard, H. (1992) Proc. Natl. Acad. Sci. USA 89:5547-5551; Gossen, M. et al. (1995) Science 268:1766-1769; PCT Publication No. WO 94/29442; and PCT Publication No. WO 96/01313). Accordingly, in another embodiment, the invention provides a recombinant expression vector in which T-bet DNA is operatively linked to an inducible eukaryotic promoter, thereby allowing for inducible expression of T-bet protein in eukaryotic cells.

The invention further provides a recombinant expression vector comprising a DNA molecule of the invention cloned into the expression vector in an antisense orientation. That is, the DNA molecule is operatively linked to a regulatory sequence in a manner which allows for expression (by transcription of the DNA molecule) of an RNA molecule which is antisense to T-bet mRNA. Regulatory sequences operatively linked to a nucleic acid cloned in the antisense orientation can be chosen which direct the continuous expression of the antisense RNA molecule in a variety of cell types, for instance viral promoters and/or enhancers, or regulatory sequences can be chosen which direct constitutive, tissue specific or cell type specific expression of antisense RNA. The antisense expression vector can be in the form of a recombinant plasmid, phagemid or attenuated virus in which antisense nucleic acids are produced under the control of a high efficiency regulatory region, the activity of which can be determined by the cell type into which the vector is introduced. For a discussion of the regulation of gene expression using antisense genes see Weintraub, H. et al., Antisense RNA as a molecular tool for genetic analysis, Reviews—Trends in Genetics, Vol. 1(1) 1986.

Another aspect of the invention pertains to recombinant host cells into which a vector, preferably a recombinant expression vector, of the invention has been introduced. A host cell may be any prokaryotic or eukaryotic cell. For example, T-bet protein may be expressed in bacterial cells such as E. coli, insect cells, yeast or mammalian cells (such as Chinese hamster ovary cells (CHO) or COS cells). Other suitable host cells are known to those skilled in the art. Vector DNA can be introduced into prokaryotic or eukaryotic cells via conventional transformation or transfection techniques. As used herein, the terms “transformation” and “transfection” are intended to refer to a variety of art-recognized techniques for introducing foreign nucleic acid (e.g., DNA) into a host cell, including calcium phosphate or calcium chloride co-precipitation, DEAE-dextran-mediated transfection, lipofection, or electroporation. Suitable methods for transforming or transfecting host cells can be found in Sambrook et al. (Molecular Cloning: A Laboratory Manual, 2nd Edition, Cold Spring Harbor Laboratory press (1989)), and other laboratory manuals.

For stable transfection of mammalian cells, it is known that, depending upon the expression vector and transfection technique used, only a small fraction of cells may integrate the foreign DNA into their genome. In order to identify and select these integrants, a gene that encodes a selectable marker (e.g., resistance to antibiotics) is generally introduced into the host cells along with the gene of interest. Preferred selectable markers include those which confer resistance to compounds, such as G418, hygromycin and methotrexate. Nucleic acid encoding a selectable marker may be introduced into a host cell on the same vector as that encoding T-bet or may be introduced on a separate vector. Cells stably transfected with the introduced nucleic acid can be identified by compound selection (e.g., cells that have incorporated the selectable marker gene will survive, while the other cells die).

A host cell of the invention, such as a prokaryotic or eukaryotic host cell in culture, can be used to produce (i.e., express) T-bet protein. Accordingly, the invention further provides methods for producing T-bet protein using the host cells of the invention. In one embodiment, the method comprises culturing the host cell of invention (into which a recombinant expression vector encoding T-bet has been introduced) in a suitable medium until T-bet is produced. In another embodiment, the method further comprises isolating T-bet from the medium or the host cell. In its native form the T-bet protein is an intracellular protein and, accordingly, recombinant T-bet protein can be expressed intracellularly in a recombinant host cell and then isolated from the host cell, e.g., by lysing the host cell and recovering the recombinant T-bet protein from the lysate. Alternatively, recombinant T-bet protein can be prepared as a extracellular protein by operatively linking a heterologous signal sequence to the amino-terminus of the protein such that the protein is secreted from the host cells. In this case, recombinant T-bet protein can be recovered from the culture medium in which the cells are cultured.

Certain host cells of the invention can also be used to produce nonhuman transgenic animals. For example, in one embodiment, a host cell of the invention is a fertilized oocyte or an embryonic stem cell into which T-bet-coding sequences have been introduced. Such host cells can then be used to create non-human transgenic animals in which exogenous T-bet sequences have been introduced into their genome or homologous recombinant animals in which endogenous T-bet sequences have been altered. Such animals are useful for studying the function and/or activity of T-bet and for identifying and/or evaluating modulators of T-bet activity. Accordingly, another aspect of the invention pertains to nonhuman transgenic animals which contain cells carrying a transgene encoding a T-bet protein or a portion of a T-bet protein. In a subembodiment, of the transgenic animals of the invention, the transgene alters an endogenous gene encoding an endogenous T-bet protein (e.g., homologous recombinant animals in which the endogenous T-bet gene has been functionally disrupted or “knocked out”, or the nucleotide sequence of the endogenous T-bet gene has been mutated or the transcriptional regulatory region of the endogenous T-bet gene has been altered).

A transgenic animal of the invention can be created by introducing T-bet-encoding nucleic acid into the male pronuclei of a fertilized oocyte, e.g., by microinjection, and allowing the oocyte to develop in a pseudopregnant female foster animal. The T-bet nucleotide sequence of SEQ ID NO: 1 or 3 can be introduced as a transgene into the genome of a non-human animal. Intronic sequences and polyadenylation signals can also be included in the transgene to increase the efficiency of expression of the transgene. A tissue-specific regulatory sequence(s) can be operably linked to the T-bet transgene to direct expression of T-bet protein to particular cells. Methods for generating transgenic animals via embryo manipulation and microinjection, particularly animals such as mice, have become conventional in the art and are described, for example, in U.S. Pat. Nos. 4,736,866 and 4,870,009, both by Leder et al., U.S. Pat. No. 4,873,191 by Wagner et al. and in Hogan, B., Manipulating the Mouse Embryo, (Cold Spring Harbor Laboratory Press, Cold Spring Harbor, N.Y., 1986). Similar methods are used for production of other transgenic animals. A transgenic founder animal can be identified based upon the presence of the T-bet transgene in its genome and/or expression of T-bet mRNA in tissues or cells of the animals. A transgenic founder animal can then be used to breed additional animals carrying the transgene. Moreover, transgenic animals carrying a transgene encoding T-bet can further be bred to other transgenic animals carrying other transgenes.

To create a homologous recombinant animal, a vector is prepared which contains at least a portion of a T-bet gene into which a deletion, addition or substitution has been introduced to thereby alter, e.g., functionally disrupt, the endogenous T-bet gene. In one embodiment, a homologous recombination vector is designed such that, upon homologous recombination, the endogenous T-bet gene is functionally disrupted (i.e., no longer encodes a functional protein; also referred to as a “knock out” vector). Alternatively, the vector can be designed such that, upon homologous recombination, the endogenous T-bet gene replaced by the T-bet gene. In the homologous recombination vector, the altered portion of the T-bet gene is flanked at its 5′ and 3′ ends by additional nucleic acid of the T-bet gene to allow for homologous recombination to occur between the exogenous T-bet gene carried by the vector and an endogenous T-bet gene in an embryonic stem cell. The additional flanking T-bet nucleic acid is of sufficient length for successful homologous recombination with the endogenous gene. Typically, several kilobases of flanking DNA (both at the 5′ and 3′ ends) are included in the vector (see e.g., Thomas, K. R. and Capecchi, M. R. (1987) Cell 51:503 for a description of homologous recombination vectors). The vector is introduced into an embryonic stem cell line (e.g., by electroporation) and cells in which the introduced T-bet gene has homologously recombined with the endogenous T-bet gene are selected (see e.g., Li, E. et al. (1992) Cell 69:915). The selected cells are then injected into a blastocyst of an animal (e.g., a mouse) to form aggregation chimeras (see e.g., Bradley, A. in Teratocarcinomas and Embryonic Stem Cells: A Practical Approach, E. J. Robertson, ed. (IRL, Oxford, 1987) pp. 113-152). A chimeric embryo can then be implanted into a suitable pseudopregnant female foster animal and the embryo brought to term. Progeny harboring the homologously recombined DNA in their germ cells can be used to breed animals in which all cells of the animal contain the homologously recombined DNA by germline transmission of the transgene. Methods for constructing homologous recombination vectors and homologous recombinant animals are described further in Bradley, A. (1991) Current Opinion in Biotechnology 2:823-829 and in PCT International Publication Nos.: WO 90/11354 by Le Mouellec et al.; WO 91/01140 by Smithies et al.; WO 92/0968 by Zijlstra et al.; and WO 93/04169 by Berns et al.

In addition to the foregoing, the skilled artisan will appreciate that other approaches known in the art for homologous recombination can be applied to the instant invention. Enzyme-assisted site-specific integration systems are known in the art and can be applied to integrate a DNA molecule at a predetermined location in a second target DNA molecule. Examples of such enzyme-assisted integration systems include the Cre recombinase-lox target system (e.g., as described in Baubonis, W. and Sauer, B. (1993) Nucl. Acids Res. 21:2025-2029; and Fukushige, S. and Sauer, B. (1992) Proc. Natl. Acad. Sci. USA 89:7905-7909) and the FLP recombinase-FRT target system (e.g., as described in Dang, D. T. and Perrimon, N. (1992) Dev. Genet. 13:367-375; and Fiering, S. et al. (1993) Proc. Natl. Acad. Sci. USA 90:8469-8473). Tetracycline-regulated inducible homologous recombination systems, such as described in PCT Publication No. WO 94/29442 and PCT Publication No. WO 96/01313, also can be used.

In another embodiment, transgenic animals can be made in which T-bet is expressed in all T cells, e.g., using the CD4 enhancer (Zheng, W—P. & Flavell, R. A. 1997. Cell 89, 587). Recent work suggests the CD2 enhancer can also be used. In fact, it is more powerful in achieving high level expression in T cells, expression is not variegated and transgene expression is copy number-dependent (Zhumabekov, T., et al. 1995. J. Immunol. Meth. 185, 133; Sharp, L. L., et al. 1997. Immunity 7, 609). Mice with high level expression of T-bet RNA (using the human growth hormone intron as a probe to distinguish transgene driven T-bet RNA from endogenous T-bet) can be identified by screening adequate numbers of founders.

In another approach, a dominant repressor transgenic can be created. For example, a dominant-repressor T-bet can be made by using the proximal lck enhancer (Alberola-Ila, J., et al. 1996 J. Exp. Med. 184, 9) driving a fusion of T-bet and engrailed can be made (Taylor, D., 1996. Genes Dev. 10, 2732; Li, J., Thurm, H., et al. 1997. Proc. Natl. Acad. Sci. USA 94, 10885). This construct specifically represses T-bet transactivation of a multimerized T-bet reporter and does not affect NFAT-dependent reporter transactivation.

Alternatively, null mutations can be generated by targeted mutagenesis in ES cells (Ranger, A. M., et al. 1998. Nature 392, 186; Hodge, M. R., et al. 1996. Immunity 4:1, 144; Grusby, M. J., et al. 1991. Science 253, 1417; Reimold, A. M., et al. 1996. Nature 379: 262; Kaplan, M. H., 1996. Immunity:313; Kaplan, M. H., et al. 1996. Nature 382, 174; Smiley, S. T., et al. 1997. Science 275, 977). For example using techniques which are known in the art, a genomic T-bet clone can be isolated from a genomic library, the intron-exon organization delineated, and a targeting construct in the cre-lox vector (see discussion below) created which should delete the first exon and 450 bp of upstream promoter sequence. This construct can be electroporated into an ES cell line, and double compound resistant (e.g., neomycin, gancyclovir) clones identified by Southern blot analysis. Clones bearing homologous recombinant events in the T-bet locus can then be identified and injected into blastocysts obtained from day 3.5 BALB/c pregnant mice. Chimeric mice can then be produced and mated to wildtype BALB/c mice to generate germline transmission of the disrupted T-bet gene.

In another embodiment, implantation into RAG2-deficient blastocysts (Chen, J., et al. 1993. Proc. Natl. Acad. Sci. USA 90, 4528) or the cre-lox inducible deletion approach can be used to develop mice that are lacking T-bet only in the immune system. For example, the targeting construct can be made in the cre-lox vector. The blastocyst complementation system has been used to study NFATc, an embryonic lethal phenotype (Ranger, A. M., et al. 1998. Immunity 8:125). This approach requires disrupting the T-bet gene on both chromosomes in ES cells, which can be accomplished, e.g., by using a mutant neomycin gene and raising the concentration of G418 in the ES cultures, as described (Chen, J., 1993. Proc. Natl. Acad. Sci. USA 90;4528) or by flanking the neo gene with cre-lox sites. To disrupt the second allele, the neomycin gene can be deleted by transfecting the ES clone with the cre recombinase, and then the ES clone can be retransfected with the same targeting construct to select clones with T-bet deletions on both alleles. A third transfection with cre-recombinase yields the desired doubly-deficient ES cells. Such doubly targeted ES cells are then implanted into RAG2 blastocysts and the lymphoid organs of the chimeric mice thus generated will be entirely colonized by the transferred ES cells. This allows assessment of the effect of the absence of T-bet on cells of the lymphoid system without affecting other organ systems where the absence of T-bet might cause lethality.

The conditional ablation approach employing the cre-lox system can also be used. Briefly, a targeting construct is generated in which lox recombination sequences are placed in intronic regions flanking the exons to be deleted. This construct is then transfected into ES cells and mutant mice are generated as above. The resulting mutant mice are then mated to mice transgenic for the cre recombinase driven by an inducible promoter. When cre is expressed, it induces recombination between the introduced lox sites in the T-bet gene, thus effectively disrupting gene function. The key feature of this approach is that gene disruption can be induced in the adult animal at will by activating the cre recombinase.

A tissue-specific promoter can be used to avoid abnormalities in organs outside the immune system. The cre-expressing transgene may be driven by an inducible promoter. Several inducible systems are now being used in cre-lox recombination strategies, the most common being the tetracycline and ecdysone systems. A tissue-specific inducible promoter can be used if there is embryonic lethality in the T-bet null mouse.

An alternative approach is to generate a transgenic mouse harboring a regulated T-bet gene (for example using the tetracycline off promoter; e.g., St-Onge, et al. 1996. Nuc. Acid Res. 24, 3875-3877) and then breed this transgenic to the T-bet deficient mouse. This approach permits creation of mice with normal T-bet function; tetracycline can be administered to adult animals to induce disruption of T-bet function in peripheral T cells, and then the effect of T-bet deficiency can be examined over time. Repeated cycles of provision and then removal of compound (tetracycline) permits turning the T-bet gene on and off at will.

III. Isolated T-bet Proteins and Anti-T-bet Antibodies

Another aspect of the invention pertains to isolated T-bet proteins. Preferably, the T-bet protein comprises the amino acid sequence encoded by SEQ ID NO:1 or 3. In another preferred embodiment, the protein comprises the amino acid sequence of SEQ ID NO: 2 or 4. In other embodiments, the protein has at least 60% amino acid identity, more preferably 70% amino acid identity, more preferably 80%, and even more preferably, 90% or 95% amino acid identity with the amino acid sequence shown in SEQ ID NO: 2 or 4.

In other embodiments, the invention provides isolated portions of the T-bet protein. For example, the invention further encompasses an amino-terminal portion of T-bet that includes a T-box domain. In various embodiments, this amino terminal portion encompasses at least amino acids 138-327 of human T-bet or at least amino acids 137-326 of mouse T-bet. Another isolated portion of T-bet provided by the invention is a portion encompassing a tyrosine phosphorylation site. This portion comprises at least about 20, at least about 50, at least about 100, or at least about 200 amino acids of T-bet and includes at least amino acids Tyr 76, Tyr 119, and/or Tyr 531 of human T-bet or amino acids Tyr 525 of murine T-bet. Yet another isolated portion of T-bet provided herein is a portion encompassing a nuclear localization sequence shown in amino acids 498-501 of human T-bet or 493-496 of murine T-bet.

T-bet proteins of the invention are preferably produced by recombinant DNA techniques. For example, a nucleic acid molecule encoding the protein is cloned into an expression vector (as described above), the expression vector is introduced into a host cell (as described above) and the T-bet protein is expressed in the host cell. The T-bet protein can then be isolated from the cells by an appropriate purification scheme using standard protein purification techniques. Alternative to recombinant expression, a T-bet polypeptide can be synthesized chemically using standard peptide synthesis techniques. Moreover, native T-bet protein can be isolated from cells (e.g., from T cells), for example by immunoprecipitation using an anti-T-bet antibody.

The present invention also pertains to variants of the T-bet proteins which function as either T-bet agonists (mimetics) or as T-bet antagonists. Variants of the T-bet proteins can be generated by mutagenesis, e.g., discrete point mutation or truncation of a T-bet protein. Thus, specific biological effects can be elicited by treatment with a variant of limited function. In one embodiment, treatment of a subject with a variant having a subset of the biological activities of the naturally occurring form of the protein has fewer side effects in a subject relative to treatment with the naturally occurring form of the T-bet protein. In one embodiment, the invention pertains to derivatives of T-bet which may be formed by modifying at least one amino acid residue of T-bet by oxidation, reduction, or other derivatization processes known in the art.

In one embodiment, variants of a T-bet protein which function as either T-bet agonists (mimetics) or as T-bet antagonists can be identified by screening combinatorial libraries of mutants, e.g., truncation mutants, of a T-bet protein for T-bet protein agonist or antagonist activity. In one embodiment, a variegated library of T-bet variants is generated by combinatorial mutagenesis at the nucleic acid level and is encoded by a variegated gene library. A variegated library of T-bet variants can be produced by, for example, enzymatically ligating a mixture of synthetic oligonucleotides into gene sequences such that a degenerate set of potential T-bet sequences is expressible as individual polypeptides, or alternatively, as a set of larger fusion proteins (e.g., for phage display) containing the set of T-bet sequences therein. There are a variety of methods which can be used to produce libraries of potential T-bet variants from a degenerate oligonucleotide sequence. Chemical synthesis of a degenerate gene sequence can be performed in an automatic DNA synthesizer, and the synthetic gene then ligated into an appropriate expression vector. Use of a degenerate set of genes allows for the provision, in one mixture, of all of the sequences encoding the desired set of potential T-bet sequences. Methods for synthesizing degenerate oligonucleotides are known in the art (see, e.g., Narang, S. A., 1983, Tetrahedron 39:3; Itakura et al., 1984, Annu. Rev. Biochem. 53:323; Itakura et al., 1984, Science 198:1056; Ike et al., 1983, Nucleic Acid Res. 11:477).

In addition, libraries of fragments of a T-bet protein coding sequence can be used to generate a variegated population of T-bet fragments for screening and subsequent selection of variants of a T-bet protein. In one embodiment, a library of coding sequence fragments can be generated by treating a double stranded PCR fragment of a T-bet coding sequence with a nuclease under conditions wherein nicking occurs only about once per molecule, denaturing the double stranded DNA, renaturing the DNA to form double stranded DNA which can include sense/antisense pairs from different nicked products, removing single stranded portions from reformed duplexes by treatment with S1 nuclease, and ligating the resulting fragment library into an expression vector. By this method, an expression library can be derived which encodes N-terminal, C-terminal and internal fragments of various sizes of the T-bet protein.

Several techniques are known in the art for screening gene products of combinatorial libraries made by point mutations or truncation, and for screening cDNA libraries for gene products having a selected property. Such techniques are adaptable for rapid screening of the gene libraries generated by the combinatorial mutagenesis of T-bet proteins. The most widely used techniques, which are amenable to high through-put analysis, for screening large gene libraries typically include cloning the gene library into replicable expression vectors, transforming appropriate cells with the resulting library of vectors, and expressing the combinatorial genes under conditions in which detection of a desired activity facilitates isolation of the vector encoding the gene whose product was detected. Recursive ensemble mutagenesis (REM), a new technique which enhances the frequency of functional mutants in the libraries, can be used in combination with the screening assays to identify T-bet variants (Arkin and Yourvan, 1992, Proc. Natl. Acad. Sci. USA 89:7811-7815; Delgrave et al., 1993, Protein Engineering 6(3):327-331).

The invention also provides T-bet fusion proteins. As used herein, a T-bet “fusion protein” comprises a T-bet polypeptide operatively linked to a polypeptide other than T-bet. A “T-bet polypeptide” refers to a polypeptide having an amino acid sequence corresponding to T-bet protein, or a peptide fragment thereof which is unique to T-bet protein whereas a “polypeptide other than T-bet” refers to a polypeptide having an amino acid sequence corresponding to another protein. Within the fusion protein, the term “operatively linked” is intended to indicate that the T-bet polypeptide and the other polypeptide are fused in-frame to each other. The other polypeptide may be fused to the N-terminus or C-terminus of the T-bet polypeptide. For example, in one embodiment, the fusion protein is a GST-T-bet fusion protein in which the T-bet sequences are fused to the C-terminus of the GST sequences. In another embodiment, the fusion protein is a T-bet-HA fusion protein in which the T-bet nucleotide sequence is inserted in a vector such as pCEP4-HA vector (Herrscher, R. F. et al. (1995) Genes Dev. 9:3067-3082) such that the T-bet sequences are fused in frame to an influenza hemagglutinin epitope tag. Such fusion proteins can facilitate the purification of recombinant T-bet.

Preferably, a T-bet fusion protein of the invention is produced by standard recombinant DNA techniques. For example, DNA fragments coding for the different polypeptide sequences are ligated together in-frame in accordance with conventional techniques, for example employing blunt-ended or stagger-ended termini for ligation, restriction enzyme digestion to provide for appropriate termini, filling-in of cohesive ends as appropriate, alkaline phosphatase treatment to avoid undesirable joining, and enzymatic ligation. In another embodiment, the fusion gene can be synthesized by conventional techniques including automated DNA synthesizers. Alternatively, PCR amplification of gene fragments can be carried out using anchor primers which give rise to complementary overhangs between two consecutive gene fragments which can subsequently be annealed and reamplified to generate a chimeric gene sequence (see, for example, Current Protocols in Molecular Biology, eds. Ausubel et al. John Wiley & Sons: 1992). Moreover, many expression vectors are commercially available that already encode a fusion moiety (e.g., a GST polypeptide or an HA epitope tag). A T-bet-encoding nucleic acid can be cloned into such an expression vector such that the fusion moiety is linked in-frame to the T-bet protein.

An isolated T-bet protein, or fragment thereof, can be used as an immunogen to generate antibodies that bind specifically to T-bet using standard techniques for polyclonal and monoclonal antibody preparation. The T-bet protein can be used to generate antibodies. For example, polyclonal antisera, can be produced in rabbits using full-length recombinant bacterially produced T-bet as the immunogen. This same immunogen can be used to produce mAb by immunizing mice and removing spleen cells from the immunized mice. Spleen cells from mice mounting an immune response to T-bet can be fused to myeloma cells, e.g., SP2/O-Ag14 myeloma. As described in the appended examples, this methods were used to make polyclonal and monoclonal antibodies which bind to T-bet. In one embodiment, the antibodies can be produced in an animal that does not express T-bet, such as a T-bet knock-out animal. In another embodiment, the antibodies can be generated in a non-human animal having a specific genetic background, e.g., as achieved by backcrossing.

Alternatively, an antigenic peptide fragment of T-bet can be used as the immunogen. An antigenic peptide fragment of T-bet typically comprises at least 8 amino acid residues of the amino acid sequence shown in SEQ ID NO: 2 or 4 and encompasses an epitope of T-bet such that an antibody raised against the peptide forms a specific immune complex with T-bet. Preferably, the antigenic peptide comprises at least 10 amino acid residues, more preferably at least 15 amino acid residues, even more preferably at least 20 amino acid residues, and most preferably at least 30 amino acid residues. Preferred epitopes encompassed by the antigenic peptide are regions of T-bet that are located on the surface of the protein, e.g., hydrophilic regions, and that are unique to T-bet. In one embodiment such epitopes can be specific for T-bet proteins from one species, such as mouse or human (i.e., an antigenic peptide that spans a region of T-bet that is not conserved across species is used as immunogen; such non conserved residues can be determined using an alignment such as that provided herein). A standard hydrophobicity analysis of the T-bet protein can be performed to identify hydrophilic regions.

A T-bet immunogen typically is used to prepare antibodies by immunizing a suitable subject, (e.g., rabbit, goat, mouse or other mammal) with the immunogen. An appropriate immunogenic preparation can contain, for examples, recombinantly expressed T-bet protein or a chemically synthesized T-bet peptide. The preparation can further include an adjuvant, such as Freund's complete or incomplete adjuvant, or similar immunostimulatory agent. Immunization of a suitable subject with an immunogenic T-bet preparation induces a polyclonal anti-T-bet antibody response.

Accordingly, another aspect of the invention pertains to anti-T-bet antibodies. Polyclonal anti-T-bet antibodies can be prepared as described above by immunizing a suitable subject with a T-bet immunogen. The anti-T-bet antibody titer in the immunized subject can be monitored over time by standard techniques, such as with an enzyme linked immunosorbent assay (ELISA) using immobilized T-bet. If desired, the antibody molecules directed against T-bet can be isolated from the mammal (e.g., from the blood) and further purified by well known techniques, such as protein A chromatography to obtain the IgG fraction. At an appropriate time after immunization, e.g., when the anti-T-bet antibody titers are highest, antibody-producing cells can be obtained from the subject and used to prepare monoclonal antibodies by standard techniques, such as the hybridoma technique originally described by Kohler and Milstein (1975, Nature 256:495-497) (see also, Brown et al. (1981) J. Immunol 127:539-46; Brown et al. (1980) J. Biol Chem 255:4980-83; Yeh et al. (1976) PNAS 76:2927-31; and Yeh et al. (1982) Int. J. Cancer 29:269-75), the more recent human B cell hybridoma technique (Kozbor et al. (1983) Immunol Today 4:72), the EBV-hybridoma technique (Cole et al. (1985), Monoclonal Antibodies and Cancer Therapy, Alan R. Liss, Inc., pp. 77-96) or trioma techniques. The technology for producing monoclonal antibody hybridomas is well known (see generally R. H. Kenneth, in Monoclonal Antibodies: A New Dimension In Biological Analyses, Plenum Publishing Corp., New York, N.Y. (1980); E. A. Lerner (1981) Yale J. Biol. Med., 54:387-402; M. L. Gefter et al. (1977) Somatic Cell Genet., 3:231-36). Briefly, an immortal cell line (typically a myeloma) is fused to lymphocytes (typically splenocytes) from a mammal immunized with a T-bet immunogen as described above, and the culture supernatants of the resulting hybridoma cells are screened to identify a hybridoma producing a monoclonal antibody that binds specifically to T-bet.

Any of the many well known protocols used for fusing lymphocytes and immortalized cell lines can be applied for the purpose of generating an anti-T-bet monoclonal antibody (see, e.g., G. Galfre et al. (1977) Nature 266:55052; Gefter et al. Somatic Cell Genet., cited supra; Lerner, Yale J. Biol. Med., cited supra; Kenneth, Monoclonal Antibodies, cited supra). Moreover, the ordinary skilled worker will appreciate that there are many variations of such methods which also would be useful. Typically, the immortal cell line (e.g., a myeloma cell line) is derived from the same mammalian species as the lymphocytes. For example, murine hybridomas can be made by fusing lymphocytes from a mouse immunized with an immunogenic preparation of the present invention with an immortalized mouse cell line. Preferred immortal cell lines are mouse myeloma cell lines that are sensitive to culture medium containing hypoxanthine, aminopterin and thymidine (“HAT medium”). Any of a number of myeloma cell lines may be used as a fusion partner according to standard techniques, e.g., the P3-NS1/1-Ag4-1, P3-x63-Ag8.653 or Sp2/O-Ag14 myeloma lines. These myeloma lines are available from the American Type Culture Collection (ATCC), Rockville, Md. Typically, HAT-sensitive mouse myeloma cells are fused to mouse splenocytes using polyethylene glycol (“PEG”). Hybridoma cells resulting from the fusion are then selected using HAT medium, which kills unfused and unproductively fused myeloma cells (unfused splenocytes die after several days because they are not transformed). Hybridoma cells producing a monoclonal antibody of the invention are detected by screening the hybridoma culture supernatants for antibodies that bind T-bet, e.g., using a standard ELISA assay.

Using such methods several antibodies to T-bet have been generated. Both monoclonal and polyclonal antibodies were generated against full-length recombinant bacterially produced T-bet protein. The 3D10 antibody is of the IgG subtype and the 4B10 antibody was produced by fusion of mouse spleen cells to the SP2/0-Ag14 myeloma and is of the IgG subtype. The 39D antibody recognizes both human and murine T-bet.

Alternative to preparing monoclonal antibody-secreting hybridomas, a monoclonal anti-T-bet antibody can be identified and isolated by screening a recombinant combinatorial immunoglobulin library (e.g., an antibody phage display library) with T-bet to thereby isolate immunoglobulin library members that bind T-bet. Kits for generating and screening phage display libraries are commercially available (e.g., the Pharmacia Recombinant Phage Antibody System, Catalog No. 27-9400-01; and the Stratagene SurfZAP™ Phage Display Kit, Catalog No. 240612). Additionally, examples of methods and reagents particularly amenable for use in generating and screening antibody display library can be found in, for example, Ladner et al. U.S. Pat. No. 5,223,409; Kang et al. International Publication No. WO 92/18619; Dower et al. International Publication No. WO 91/17271; Winter et al. International Publication WO 92/20791; Markland et al. International Publication No. WO 92/15679; Breitling et al. International Publication WO 93/01288; McCafferty et al. International Publication No. WO 92/01047; Garrard et al. International Publication No. WO 92/09690; Ladner et al. International Publication No. WO 90/02809; Fuchs et al. (1991) Bio/Technology 9:1370-1372; Hay et al. (1992) Hum Antibod Hybridomas 3:81-85; Huse et al. (1989) Science 246:1275-1281; Griffiths et al. (1993) EMBO J. 12:725-734; Hawkins et al. (1992) J. Mol Biol 226:889-896; Clarkson et al. (1991) Nature 352:624-628; Gram et al. (1992) PNAS 89:3576-3580; Garrad et al. (1991) Bio/Technology 9:1373-1377; Hoogenboom et al. (1991) Nuc Acid Res 19:4133-4137; Barbas et al. (1991) PNAS 88:7978-7982; and McCafferty et al. Nature (1990) 348:552-554.

Additionally, recombinant anti-T-bet antibodies, such as chimeric and humanized monoclonal antibodies, comprising both human and non-human portions, which can be made using standard recombinant DNA techniques, are within the scope of the invention. Such chimeric and humanized monoclonal antibodies can be produced by recombinant DNA techniques known in the art, for example using methods described in Robinson et al. International Patent Publication PCT/US86/02269; Akira, et al. European Patent Application 184,187; Taniguchi, M., European Patent Application 171,496; Morrison et al. European Patent Application 173,494; Neuberger et al. PCT Application WO 86/01533; Cabilly et al. U.S. Pat. No. 4,816,567; Cabilly et al. European Patent Application 125,023; Better et al. (1988) Science 240:1041-1043; Liu et al. (1987) PNAS 84:3439-3443; Liu et al. (1987) J. Immunol. 139:3521-3526; Sun et al. (1987) PNAS 84:214-218; Nishimura et al. (1987) Canc. Res. 47:999-1005; Wood et al. (1985) Nature 314:446-449; and Shaw et al. (1988) J. Natl Cancer Inst. 80:1553-1559); Morrison, S. L. (1985) Science 229:1202-1207; Oi et al. (1986) BioTechniques 4:214; Winter U.S. Pat. No. 5,225,539; Jones et al. (1986) Nature 321:552-525; Verhoeyan et al. (1988) Science 239:1534; and Beidler et al. (1988) J. Immunol. 141:4053-4060.

In another embodiment, fully human antibodies can be made using techniques that are known in the art. For example, fully human antibodies against a specific antigen can be prepared by administering the antigen to a transgenic animal which has

been modified to produce such antibodies in response to antigenic challenge, but whose endogenous loci have been disabled. Exemplary techniques that can be used to make antibodies are described in US patents: U.S. Pat. Nos. 6,150,584; 6,458,592; 6,420,140. Other techniques are known in the art.

An anti-T-bet antibody (e.g., monoclonal antibody) can be used to isolate T-bet by standard techniques, such as affinity chromatography or immunoprecipitation. An anti-T-bet antibody can facilitate the purification of natural T-bet from cells and of recombinantly produced T-bet expressed in host cells. Moreover, an anti-T-bet antibody can be used to detect T-bet protein (e.g., in a cellular lysate or cell supernatant). Detection may be facilitated by coupling (i.e., physically linking) the antibody to a detectable substance. Accordingly, in one embodiment, an anti-T-bet antibody of the invention is labeled with a detectable substance. Examples of detectable substances include various enzymes, prosthetic groups, fluorescent materials, luminescent materials and radioactive materials. Examples of suitable enzymes include horseradish peroxidase, alkaline phosphatase, β-galactosidase, or acetylcholinesterase; examples of suitable prosthetic group complexes include streptavidin/biotin and avidin/biotin; examples of suitable fluorescent materials include umbelliferone, fluorescein, fluorescein isothiocyanate, rhodamine, dichlorotriazinylamine fluorescein, dansyl chloride or phycoerythrin; an example of a luminescent material includes luminol; and examples of suitable radioactive material include ¹²⁵I, ¹³¹I, ³⁵S or ³H.

Yet another aspect of the invention pertains to anti-T-bet antibodies that are obtainable by a process comprising:

(a) immunizing an animal with an immunogenic T-bet protein, or an immunogenic portion thereof unique to T-bet protein; and

(b) isolating from the animal antibodies that specifically bind to a T-bet protein.

Methods for immunization and recovery of the specific anti-T-bet antibodies are described further above.

In yet another aspect, the invention pertains to T-bet intrabodies. Intrabodies are intracellularly expressed antibody constructs, usually single-chain Fv (scFv) antibodies directed against a target inside a cell, e.g. an intracellular protein such as T-bet (Graus-Porta, D. et al. (1995) Mol. Cell Biol. 15(1):182-91). For example, an intrabody (e.g., and scFv) can contain the variable region of the heavy and the light chain, linked by a flexible linker and expressed from a single gene. The variable domains of the heavy and the light chain contain the complementarity determining regions (CDRs) of the parent antibody, i.e., the main antigen binding domains, which determine the specificity of the scFvs. The scFv gene can be transferred into cells, where scFv protein expression can modulate the properties of its target, e.g., T-bet. Accordingly, in one embodiment, the invention provides a method for using such T-bet intrabodies to prevent T-bet activity in cells, for example, in an in vivo or ex vivo approach, for which the cells are modified to express such intrabodies. In a particular embodiment, the T-bet intrabodies of the invention can be used to directly inhibit T-bet activity. In another embodiment, the T-bet intrabodies can be used to inhibit the interaction of T-bet and a protein with which T-bet interacts. Thus, the T-bet intrabodies of the invention are useful in modulating signaling pathways in which T-bet is involved.

The T-bet intrabodies can be prepared using techniques known in the art. For example, phage display technology can be used to isolate scFvs from libraries (Lowman, H B et al. (1991) Biochemistry 30(10): 832-8). To select scFvs binding to a particular antigen, the scFvs are fused to a coat protein, typically pIII (g3p) of filamentous M13 phage. An scFv on the phage that binds an immobilized antigen is enriched during consecutive cycles of binding, elution and amplification. In another example, ribosome display can used to prepare T-bet intrabodies (Hanes, J. et al. (1997) Proc. Natl. Acad. Sci. 94(1): 937-44). Ribosome display is an in vitro method that links the peptide directly to the genetic information (mRNA). An scFv cDNA library is expressed in vitro using a transcription translation system. The translated ScFvs are stalled to the ribosome linked to the encoding mRNA. The scFv is then bound to the immobilized antigen and unspecific ribosome complexes are removed by extensive washes. The remaining complexes are eluted and the RNA is isolated, reverse transcribed to cDNA and subsequently re-amplified by PCR. In yet another example, a Protein Fragment Complementation Assay (PCA) can be used to prepare T-bet intrabodies of the invention (Pelletier, J N et al. (1998) Proc. Natl. Acad. Sci. 95(12): 141-6.) This is a cellular selection procedure based on the complementation of a mutant dihydrofolate reductase (DHFR) in E. coli by the mouse protein (mDHFR). The murine DHFR is dissected into two parts, which are expressed as fusion proteins with potentially interacting peptides. The interaction of the fusion proteins restores the enzymatic activity of mDHFR, and thus bacterial proliferation. Only a specific interaction of antibody and antigen allows the functional complementation of DHFR which makes the system amenable for the selection of scFvs (Mossner, E. et al. (2001) J. Mol. Biol. 308:115-22).

IV. Pharmaceutical Compositions

Modulators of the invention (e.g., agents that directly stimulate or reduce Th2 cell lineage commitment) can be incorporated into pharmaceutical compositions suitable for administration. Such compositions typically comprise the modulatory agent and a pharmaceutically acceptable carrier. As used herein the term “pharmaceutically acceptable carrier” is intended to include any and all solvents, dispersion media, coatings, antibacterial and antifungal agents, isotonic and absorption delaying agents, and the like, compatible with pharmaceutical administration. The use of such media and agents for pharmaceutically active substances is well known in the art. Except insofar as any conventional media or agent is incompatible with the active compound, use thereof in the compositions is contemplated. Supplementary active compounds can also be incorporated into the compositions.

A pharmaceutical composition of the invention is formulated to be compatible with its intended route of administration. For example, solutions or suspensions used for parenteral, intradermal, or subcutaneous application can include the following components: a sterile diluent such as water for injection, saline solution, fixed oils, polyethylene glycols, glycerine, propylene glycol or other synthetic solvents; antibacterial agents such as benzyl alcohol or methyl parabens; antioxidants such as ascorbic acid or sodium bisulfite; chelating agents such as ethylenediaminetetraacetic acid; buffers such as acetates, citrates or phosphates and agents for the adjustment of tonicity such as sodium chloride or dextrose. pH can be adjusted with acids or bases, such as hydrochloric acid or sodium hydroxide. The parenteral preparation can be enclosed in ampoules, disposable syringes or multiple dose vials made of glass or plastic.

Pharmaceutical compositions suitable for injectable use include sterile aqueous solutions (where water soluble) or dispersions and sterile powders for the extemporaneous preparation of sterile injectable solutions or dispersion. For intravenous administration, suitable carriers include physiological saline, bacteriostatic water, Cremophor EL™ (BASF, Parsippany, N.J.) or phosphate buffered saline (PBS). In all cases, the composition must be sterile and should be fluid to the extent that easy syringability exists. It must be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol, and liquid polyetheylene glycol, and the like), and suitable mixtures thereof. The proper fluidity can be maintained, for example, by the use of a coating such as lecithin, by the maintenance of the required particle size in the case of dispersion and by the use of surfactants. Prevention of the action of microorganisms can be achieved by various antibacterial and antifungal agents, for example, parabens, chlorobutanol, phenol, ascorbic acid, thimerosal, and the like. In many cases, it will be preferable to include isotonic agents, for example, sugars, polyalcohols such as manitol, sorbitol, sodium chloride in the composition. Prolonged absorption of the injectable compositions can be brought about by including in the composition an agent which delays absorption, for example, aluminum monostearate and gelatin.

Sterile injectable solutions can be prepared by incorporating the active compound in the required amount in an appropriate solvent with one or a combination of ingredients enumerated above, as required, followed by filtered sterilization. Generally, dispersions are prepared by incorporating the active compound into a sterile vehicle which contains a basic dispersion medium and the required other ingredients from those enumerated above. In the case of sterile powders for the preparation of sterile injectable solutions, the preferred methods of preparation are vacuum drying and freeze-drying which yields a powder of the active ingredient plus any additional desired ingredient from a previously sterile-filtered solution thereof.

Oral compositions generally include an inert diluent or an edible carrier. They can be enclosed in gelatin capsules or compressed into tablets. For the purpose of oral therapeutic administration, the active compound can be incorporated with excipients and used in the form of tablets, troches, or capsules. Oral compositions can also be prepared using a fluid carrier for use as a mouthwash, wherein the compound in the fluid carrier is applied orally and swished and expectorated or swallowed. Pharmaceutically compatible binding agents, and/or adjuvant materials can be included as part of the composition. The tablets, pills, capsules, troches and the like can contain any of the following ingredients, or compounds of a similar nature: a binder such as microcrystalline cellulose, gum tragacanth or gelatin; an excipient such as starch or lactose, a disintegrating agent such as alginic acid, Primogel, or corn starch; a lubricant such as magnesium stearate or Sterotes; a glidant such as colloidal silicon dioxide; a sweetening agent such as sucrose or saccharin; or a flavoring agent such as peppermint, methyl salicylate, or orange flavoring.

In one embodiment, the active compounds are prepared with carriers that will protect the compound against rapid elimination from the body, such as a controlled release formulation, including implants and microencapsulated delivery systems. Biodegradable, biocompatible polymers can be used, such as ethylene vinyl acetate, polyanhydrides, polyglycolic acid, collagen, polyorthoesters, and polylactic acid. Methods for preparation of such formulations will be apparent to those skilled in the art. The materials can also be obtained commercially from Alza Corporation and Nova Pharmaceuticals, Inc. Liposomal suspensions (including liposomes targeted to infected cells with monoclonal antibodies to viral antigens) can also be used as pharmaceutically acceptable carriers. These may be prepared according to methods known to those skilled in the art, for example, as described in U.S. Pat. No. 4,522,811.

In one embodiment, compositions comprising modulating agents can comprise a second agent which is useful in modulating a cellular response affected by T-bet. For example, in one embodiment, an agent which downmodulates Th2 lineage commitment may be administered in combination with a second agent that downmodulates a humoral immune response. Alternatively, for example, in another embodiment, an agent that upmodulates Th2 lineage commitment may be administered with an agent that downmodulates a cellular immune response. Such agents may be administered as part of the same pharmaceutical composition as the T-bet modulating agent or may be formulated for separate administration.

V. Methods of the Invention

A. Diagnostic Assays/Prognostic Assays

Another aspect of the invention pertains to methods of using the various T-bet compositions of the invention. For example, the invention provides a method for detecting the presence of T-bet activity in a biological sample. Such an assay may be useful in identifying cells in which it may be desirable to modulate Th2 cell lineage commitment. The method involves contacting the biological sample with an agent capable of detecting T-bet activity, such as T-bet protein or T-bet mRNA, such that the presence of T-bet activity is detected in the biological sample.

A preferred agent for detecting T-bet mRNA is a labeled nucleic acid probe capable of specifically hybridizing to T-bet mRNA. The nucleic acid probe can be, for example, the T-bet DNA of SEQ ID NO: 1 or 3, such as an oligonucleotide of at least about 500, 600, 800, 900, 1000, 1200, 1400, or 1600 nucleotides in length and which specifically hybridizes under stringent conditions to T-bet mRNA.

A preferred agent for detecting T-bet protein is a labeled antibody capable of binding to T-bet protein. Antibodies can be polyclonal, or more preferably, monoclonal. An intact antibody, or a fragment thereof (e.g., Fab or F(ab′)₂) can be used. The term “labeled”, with regard to the probe or antibody, is intended to encompass direct labeling of the probe or antibody by coupling (i.e., physically linking) a detectable substance to the probe or antibody, as well as indirect labeling of the probe or antibody by reactivity with another reagent that is directly labeled. Examples of indirect labeling include detection of a primary antibody using a fluorescently labeled secondary antibody and end-labeling of a DNA probe with biotin such that it can be detected with fluorescently labeled streptavidin. The term “biological sample” is intended to include tissues, cells and biological fluids. For example, techniques for detection of T-bet mRNA include Northern hybridizations and in situ hybridizations. Techniques for detection of T-bet protein include enzyme linked immunosorbent assays (ELISAs), Western blots, immunoprecipitations and immunofluorescence.

Such assays are useful in detecting syndromes characterized by developmental defects. For example, mutations in the human T-box genes TBX5 and TBX3 (orthologs of mouse Tbx5 and Tbx3) are responsible for the autosomal dominant genetic diseases Holt-Oram syndrome and ulnar-mammary syndrome respectively (Bamshad, M., et al. 1997. Nature Genetics 16: 311; Basson, C. T., et al. 1997. Nature Genetics 15:30; Li, Q. Y., et al. 1997. Nature Genetics 15: 21; Spranger, S., et al. 1997. J. Med. Genet. 3:978). These syndromes are characterized by developmental defects and might have been predicted by the patterns of expression of Tbx5 and Tbx3 respectively. Holt-Oram syndrome affects the heart and upper limbs while ulnar-mammary syndrome affects limb, apocrine gland, tooth and genital development. Both syndromes are characterized by developmental defects and might have been predicted by the patterns of expression of Tbx5 and Tbx3 respectively. The mutations in these patients involve only one allele of the T-box gene-thus it has been postulated that haploinsufficiency of Tbx3 and Tbx 5 cause these two diseases. Recently it has been demonstrated that provision of Tbx4 and Tbx5 to developing chick embryos controls limb bud identity (Rodriguez-Esteban et al., 1999; Takeuchi et al., 1999). These discoveries emphasize the critical importance of this family in vertebrate development.

In addition, the existence of T-bet gene homologs in many species provides strong evidence for its function as a transcription factor that regulates a set of as yet unknown target genes involved in mesoderm development. The recent prominence of the T-box family arises from its clear importance in diverse developmental processes, exemplified most dramatically by the T-box mutations in human disease. The generation of mature T cells from thymocyte stem cells and of differentiated Th cells from naive precursors can also be viewed as tightly regulated developmental processes. This discovery that T-bet is responsible for the development of the Th1 lineage demonstrates an important role for this newest T-box family member in the lymphoid system.

B. Screening Methods

The invention further provides methods for identifying compounds, i.e., candidate or test compounds or agents (e.g., peptidomimetics, small molecules (e.g., small organic molecules, or other drugs) that directly modulate, e.g., increase or decrease Th2 lineage commitment and/or directly modulate, e.g., increase or decrease Th2 cytokine production. Modulators of Th2 lineage commitment can be known (e.g., dominant negative inhibitors of T-bet activity, GATA3 or one or more Tec kinases, antisense T-bet, GATA3 or Tec kinase, intracellular antibodies that interfere with T-bet, or Tec kinase activity, peptide inhibitors derived from T-bet, GATA3 or Tec kinase), nucleic acid or protein T-bet, GATA3 or Tec kinase molecules, kinase activators or inhibitors (e.g., tyrosine kinase activators or inhibitors), or can be identified using the methods described herein.

For example, in one embodiment, molecules which modulate the interaction, e.g., binding, of T-bet to a kinase molecule, e.g., Tec kinase, can be identified. For example, Tec kinase, e.g., Itk, mediates the interaction of T-bet with GATA3, and therefore, any of these molecules can be used in the subject screening assays. Although the specific embodiments described below in this section and in other sections may list one of these molecules as an example, other molecules that interact with and/or are involved in a signal transduction pathway involving T-bet can also be used in the subject screening assays.

In one embodiment, the ability of a compound to directly modulate, e.g., increase or stabilize, or decrease or destabilize, the formation of a complex between T-bet and a Tec kinase is measured. In other embodiments, the post-translational modification (e.g., phosphorylation) of T-bet, or the expression and/or activity of Itk or T-bet is measured in an indicator composition using a screening assay of the invention. In yet another embodiment, the formation of a complex between GATA3 and T-bet is measured. In another embodiment, Th2 cytokine production is measured.

The indicator composition can be a cell that expresses the T-bet protein or a molecule that interacts with T-bet or a molecule in a signal transduction pathway involving T-bet, for example, a cell that naturally expresses or, more preferably, a cell that has been engineered to express the protein by introducing into the cell an expression vector encoding the protein. Preferably, the cell is a mammalian cell, e.g., a human cell. In one embodiment, the cell is a T cell. In one preferred embodiment, the cell is committed to a T cell lineage. In another preferred embodiment, the cell is not yet committed to a T cell lineage. In another embodiment, the cell is a B cell. In yet another embodiment, the cell is a NK cell. Alternatively, the indicator composition can be a cell-free composition that includes the protein (e.g., a cell extract or a composition that includes, e.g., either purified natural or recombinant protein).

The ability of a compound to directly modulate Th2 lineage commitment can be determined by, for example, measuring the production of Th2-specific cytokines. The ability of a compound to directly modulate Th2 lineage commitment can also be determined by, for example, measuring the expression and/or activity of Itk. For example, Itk is a Tec kinase that phosphorylates, e.g., tyrosine phosphorylates, target molecules, such as T-bet, e.g., at tyrosine residue 525 (Y525) of T-bet. Additionally, the ability of a compound to directly modulate Th2 lineage commitment can also be determined by, for example, measuring the expression and/or activity of T-bet. For example, T-bet is a transcription factor and, therefore, has the ability to bind to DNA and to regulate expression of genes, e.g., cytokine genes as taught in the Examples. Accordingly, specific embodiments of the screening methods of the invention exploit the ability of T-bet polypeptides to bind to DNA or other target molecule; (e.g., GATA3, Tec kinase, or IL-2 or IFN-γ promoter); to regulate gene expression (e.g., regulate expression of a Th1-associated cytokine genes, e.g., by repressing the IL-2 gene, transactivating the IFN-γ gene, or to regulate the expression of a Th2-associated cytokine gene, e.g., the IL-4 gene or the IL-10 gene (e.g., by reducing the ability of GATA3 to bind to DNA), or to regulate the expression of other genes, (e.g., by repressing TGF-β or Toll-like receptor genes, such as TLR6)).

In one embodiment, the invention provides methods for identifying modulators, i.e., candidate or test compounds or agents (e.g., enzymes, peptides, peptidomimetics, small molecules, ribozymes, or T-bet antisense molecules) which bind to T-bet polypeptides; have a stimulatory or inhibitory effect on T-bet expression; T-bet processing; T-bet post-translational modification (e.g., glycosylation, ubiquitinization, or phosphorylation); or T-bet activity; or have a stimulatory or inhibitory effect on the expression, processing or activity of a T-bet binding partner or target molecule.

In one preferred embodiment, the invention features a method for identifying a compound which directly increases Th2 lineage commitment during T cell differentiation, comprising contacting in the presence of the compound, T-bet and a Tec kinase molecule under conditions which allow interaction of the kinase molecule with T-bet; and detecting the interaction of T-bet and the kinase molecule, wherein the ability of the compound to directly increase Th2 lineage commitment during T cell differentiation is indicated by a decrease in the interaction as compared to the amount of interaction in the absence of the compound.

In another embodiment, the invention features a method for identifying a compound which directly decreases Th2 lineage commitment during T cell differentiation, comprising contacting in the presence of the compound, T-bet and a Tec kinase molecule under conditions which allow interaction of the kinase molecule with T-bet; and detecting the interaction of T-bet and the kinase molecule, wherein the ability of the compound to directly decrease Th2 lineage commitment during T cell differentiation is indicated by in increase in the interaction as compared to the amount of interaction in the absence of the compound.

In another preferred embodiment, the invention features a method of identifying compounds useful in directly modulating (e.g., increasing or decreasing) Th2 lineage commitment during T cell differentiation comprising,

a) providing an indicator composition comprising ITK, T-bet and GATA3;

b) contacting the indicator composition with each member of a library of test compounds;

c) selecting from the library of test compounds a compound of interest that modulates (e.g., decreases or increases) the ITK-mediated interaction of T-bet and GATA3 to thereby identify a compound that directly modulates Th2 lineage commitment.

In yet another preferred embodiment, the invention features a method for identifying a compound which modulates the interaction of T-bet and GATA3 in a T cell, comprising contacting in the presence of the compound and ITK, T-bet and GATA3 under conditions which allow ITK-mediated binding of T-bet to GATA3 to form a complex; and detecting the formation of a complex of T-bet and GATA3 in which the ability of the compound to modulate (e.g., increase or decrease) interaction between T-bet and GATA3 in the presence of ITK and the compound is indicated by a modulation in complex formation as compared to the amount of complex formed in the absence of ITK and the compound.

In yet another preferred embodiment, the invention features a method of directly modulating (e.g., increasing or decreasing) Th2 lineage commitment during T cell differentiation, comprising contacting the cell with an agent that modulates, (e.g., decreases or increases) the ITK-mediated binding of T-bet and GATA3 in the T cell, such that Th2 lineage commitment during T cell differentiation is directly modulated.

Compounds identified using the assays described herein may be useful for treating disorders associated with aberrant T-bet expression, processing, post-translational modification, or activity, modulation of T cell lineage commitment, modulating the production of cytokines, modulating TGF-β mediated signaling, modulating the Jak1/STAT-1 pathway, modulating IgG class switching and modulating B lymphocyte function.

Conditions that may benefit from upmodulation of Th2 cytokine production by decreasing the formation and/or stability of a complex between T-bet and GATA3 and/or Tec kinase include disorders certain immune deficiency disorders or disorders in which Th1 cytokine production may be too high.

Conditions that may benefit from downmodulation of Th2 cytokine production by increasing the formation and/or stability of a complex between T-bet and GATA3 and/or Tec kinase include autoimmune disorders including: diabetes mellitus, rheumatoid arthritis, juvenile rheumatoid arthritis, osteoarthritis, psoriatic arthritis, multiple sclerosis, myasthenia gravis, systemic lupus erythematosis, autoimmune thyroiditis, atopic dermatitis and eczematous dermatitis, psoriasis, Sjögren's Syndrome, alopecia greata, allergic responses due to arthropod bite reactions, Crohn's disease, aphthous ulcer, iritis, conjunctivitis, keratoconjunctivitis, ulcerative colitis, allergic asthma, cutaneous lupus erythematosus, scleroderma, vaginitis, proctitis, compound eruptions, leprosy reversal reactions, erythema nodosum leprosum, autoimmune uveitis, allergic encephalomyelitis, acute necrotizing hemorrhagic encephalopathy, idiopathic bilateral progressive sensorineural hearing loss, aplastic anemia, pure red cell anemia, idiopathic thrombocytopenia, polychondritis, Wegener's granulomatosis, chronic active hepatitis, Stevens-Johnson syndrome, idiopathic sprue, lichen planus, Crohn's disease, Graves ophthalmopathy, sarcoidosis, primary biliary cirrhosis, uveitis posterior, experimental allergic encephalomyelitis (EAE), and interstitial lung fibrosis

The subject screening assays can be performed in the presence or absence of other agents. For example, the subject assays can be performed in the presence various agents that modulate the activation state of the cell being screened. For example, in one embodiment, agents that transduce signals via the T cell receptor are included. In another embodiment, a cytokine or an antibody to a cytokine receptor is included. In another embodiment, an agent that inhibits phosphorylation, e.g., tyrosine phosphorylation, can also be included.

In another aspect, the invention pertains to a combination of two or more of the assays described herein. For example, a modulating agent can be identified using a cell-based or a cell-free assay, and the ability of the agent to modulate the lineage commitment can be confirmed in vivo, e.g., in an animal such as an animal model for multiple sclerosis (EAE), rheumatoid arthritis, or infection.

Moreover, a modulator of Th2 lineage commitment and/or Th2 cytokine production identified as described herein (e.g., a dominant negative T-bet, GATA3 or Tec kinase molecule, a T-bet, GATA3 or Tec kinase nucleic acid or polypeptide molecule, an antisense T-bet, GATA3 or Tec kinase nucleic acid molecule, a T-bet, GATA3 or Tec kinase-specific antibody, or a small molecule) can be used in an animal model to determine the efficacy, toxicity, or side effects of treatment with such a modulator. Alternatively, a modulator identified as described herein can be used in an animal model to determine the mechanism of action of such a modulator.

In another embodiment, it will be understood that similar screening assays can be used to identify compounds that modulate Th2 lineage commitment, e.g., by performing screening assays such as those described above, but employing molecules with which T-bet interacts, i.e., molecules that act either upstream or downstream of T-bet in a signal transduction pathway, such as a Tec kinase or GATA3.

Accordingly, as described below, the invention provides a screening assay for identifying compounds that modulate the interaction of T-bet and a T-box binding region (e.g., a cytokine gene regulatory region, such as an IL-2 or IFN-γ gene regulatory region) or the ability of GATA3 (or a complex between T-bet and GATA3 and Tec kinase) to bind to DNA. Assays are known in the art that detect the interaction of a DNA binding protein with a target DNA sequence (e.g., electrophoretic mobility shift assays, DNAse I footprinting assays and the like). By performing such assays in the presence and absence of test compounds, these assays can be used to identify compounds that modulate (e.g., inhibit or enhance) the interaction of the DNA binding protein with its target DNA sequence.

The cell based and cell free assays of the invention are described in more detail below.

i. Cell Based Assays

The indicator compositions of the invention can be a cell that expresses a T-bet polypeptide (and/or one or more non-T-bet polypeptides such as a Tec kinase, e.g., Itk), for example, a cell that naturally expresses endogenous T-bet or, more preferably, a cell that has been engineered to express an exogenous T-bet polypeptide by introducing into the cell an expression vector encoding the polypeptide. Alternatively, the indicator composition can be a cell-free composition that includes T-bet and/or one or more non-T-bet polypeptides such as a Tec kinase, e.g., Itk (e.g., a cell extract from a T-bet-expressing cell or a composition that includes purified T-bet, either natural or recombinant polypeptide).

Compounds that modulate Th2 lineage commitment, e.g., directly modulate, and/or Th2 cytokine production can be identified using various “read-outs.”

For example, an indicator cell can be transfected with a T-bet expression vector, incubated in the presence and in the absence of a test compound, and the effect of the compound on the expression of the molecule or on a biological response regulated by T-bet can be determined. The biological activities of T-bet include activities determined in vivo, or in vitro, according to standard techniques. A T-bet activity can be a direct activity, such as an association of T-bet with a T-bet-target molecule (e.g., a nucleic acid molecule to which T-bet binds such as the transcriptional regulatory region of a cytokine gene or a polypeptide, e.g., a kinase (e.g., Tec kinase) or a transcription factor (GATA3)). Alternatively, a T-bet activity is a downstream activity, such as a cellular signaling activity occurring downstream of the interaction of the T-bet polypeptide with a T-bet target molecule or a biological effect occurring as a result of the signaling cascade triggered by that interaction. For example, biological activities of T-bet described herein include: modulation of T cell lineage commitment, e.g., by directly modulating the production of cytokines, modulation of downstream effects of cytokines produced. The various biological activities of T-bet can be measured using techniques that are known in the art. Exemplary techniques are described in more detail in the Examples.

To determine whether a test compound modulates cytokine expression, in vitro transcriptional assays can be performed. To perform such an assay, the full length promoter and enhancer (or portion thereof) of a cytokine can be operably linked to a reporter gene such as chloramphenicol acetyltransferase (CAT) or luciferase and introduced into host cells.

As used interchangeably herein, the terms “operably linked” and “operatively linked” are intended to mean that the nucleotide sequence is linked to a regulatory sequence in a manner which allows expression of the nucleotide sequence in a host cell (or by a cell extract). Regulatory sequences are art-recognized and can be selected to direct expression of the desired polypeptide in an appropriate host cell. The term regulatory sequence is intended to include promoters, enhancers, polyadenylation signals and other expression control elements. Such regulatory sequences are known to those skilled in the art and are described in Goeddel, Gene Expression Technology: Methods in Enzymology 185, Academic Press, San Diego, Calif. (1990). It should be understood that the design of the expression vector may depend on such factors as the choice of the host cell to be transfected and/or the type and/or amount of polypeptide desired to be expressed.

A variety of reporter genes are known in the art and are suitable for use in the screening assays of the invention. Examples of suitable reporter genes include those which encode chloramphenicol acetyltransferase, beta-galactosidase, alkaline phosphatase or luciferase. Standard methods for measuring the activity of these gene products are known in the art.

A variety of cell types are suitable for use as indicator cells in the screening assay. Preferably a cell line is used which does not normally express T-bet, such as a Th2 cell clone or a cell from a knock out animal. Nonlymphoid cell lines can also be used as indicator cells, such as the HepG2 hepatoma cell line. Yeast cells also can be used as indicator cells.

The cells used in the instant assays can be eukaryotic or prokaryotic in origin. For example, in one embodiment, the cell is a bacterial cell. In another embodiment, the cell is a fungal cell, e.g., a yeast cell. In another embodiment, the cell is a vertebrate cell, e.g., an avian or a mammalian cell. In a preferred embodiment, the cell is a human cell.

In one embodiment, the level of expression of the reporter gene in the indicator cell in the presence of the test compound is higher than the level of expression of the reporter gene in the indicator cell in the absence of the test compound and the test compound is identified as a compound that stimulates the expression of T-bet. In another embodiment, the level of expression of the reporter gene in the indicator cell in the presence of the test compound is lower than the level of expression of the reporter gene in the indicator cell in the absence of the test compound and the test compound is identified as a compound that inhibits the expression of T-bet.

In one embodiment, the invention provides methods for identifying compounds that modulate cellular responses in which T-bet is involved.

The ability of a test compound to modulate T-bet binding to a target molecule or to bind to T-bet can also be determined. Determining the ability of the test compound to modulate T-bet binding to a target molecule (e.g., a binding partner) can be accomplished, for example, by coupling the T-bet target molecule with a radioisotope, enzymatic or fluorescent label such that binding of the T-bet target molecule to T-bet can be determined by detecting the labeled T-bet target molecule in a complex. Alternatively, T-bet can be coupled with a radioisotope, enzymatic or fluorescent label to monitor the ability of a test compound to modulate T-bet binding to a T-bet target molecule in a complex. Determining the ability of the test compound to bind T-bet can be accomplished, for example, by coupling the compound with a radioisotope, enzymatic or fluorescent label such that binding of the compound to T-bet can be determined by detecting the labeled T-bet compound in a complex. For example, T-bet targets can be labeled with ¹²⁵I, ³⁵S, ¹⁴C, or ³H, either directly or indirectly, and the radioisotope detected by direct counting of radioemmission or by scintillation counting. Alternatively, compounds can be enzymatically labeled with, for example, horseradish peroxidase, alkaline phosphatase, or luciferase, and the enzymatic label detected by determination of conversion of an appropriate substrate to product.

It is also within the scope of this invention to determine the ability of a compound to interact with T-bet without the labeling of any of the interactants. For example, a microphysiometer can be used to detect the interaction of a compound with T-bet without the labeling of either the compound or the T-bet (McConnell, H. M. et al. (1992) Science 257:1906-1912). As used herein, a “microphysiometer” (e.g., Cytosensor) is an analytical instrument that measures the rate at which a cell acidifies its environment using a light-addressable potentiometric sensor (LAPS). Changes in this acidification rate can be used as an indicator of the interaction between a compound and T-bet.

In another embodiment, a different (i.e., non-T-bet) molecule acting in a pathway involving T-bet that acts upstream or downstream of T-bet can be included in an indicator composition for use in a screening assay. Compounds identified in a screening assay employing such a molecule would also be useful in modulating T-bet activity, albeit indirectly. An exemplary molecule with which T-bet interacts includes a Tec kinase, e.g., ITK or RLK and/or GATA3.

The cells of the invention can express endogenous T-bet (or another polypeptide in a signaling pathway involving T-bet) or may be engineered to do so. A cell that has been engineered to express the T-bet polypeptide or a non T-bet polypeptide which acts upstream or downstream of T-bet can be produced by introducing into the cell an expression vector encoding the T-bet polypeptide or a non T-bet polypeptide which acts upstream or downstream of T-bet.

Recombinant expression vectors that can be used for expression of T-bet polypeptide or a non T-bet polypeptide which acts upstream or downstream of T-bet in the indicator cell are known in the art. In one embodiment, within the expression vector the T-bet-coding sequences are operatively linked to regulatory sequences that allow for inducible or constitutive expression of T-bet in the indicator cell (e.g., viral regulatory sequences, such as a cytomegalovirus promoter/enhancer, can be used). Use of a recombinant expression vector that allows for inducible or constitutive expression of T-bet in the indicator cell is preferred for identification of compounds that enhance or inhibit the activity of T-bet. In an alternative embodiment, within the expression vector the T-bet-coding sequences are operatively linked to regulatory sequences of the endogenous T-bet gene (i.e., the promoter regulatory region derived from the endogenous T-bet gene). Use of a recombinant expression vector in which T-bet expression is controlled by the endogenous regulatory sequences is preferred for identification of compounds that enhance or inhibit the transcriptional expression of T-bet.

In methods in which a Th1-associated cytokine gene is utilized (e.g., as a reporter gene or as a readout to assess T-bet activity), preferably, the Th1-associated cytokine is interferon-γ or IL-2. As described in the appended examples, T-bet was isolated in a yeast one hybrid screening assay based on its ability to bind to the IL-2 promoter. Accordingly, in one embodiment, a method of the invention utilizes a reporter gene construct containing this region of the proximal IL-2 promoter, most preferably nucleotides-240 to -220 of the IL-2 promoter. Other sequences that can be employed include: the consensus T-box site, the human IL-2 promoter, the murine IL-2 promoter, the human IFN-γ intron III, two binding sites in the murine IFN-γ proximal promoter. (Szabo et al. 2000. Cell 100:655-669).

In one embodiment, an inducible system can be constructed and used in high throughput cell-based screens to identify and characterize target compounds that affect the expression and/or activity of T-bet. The inducible system can be constructed using a cell line that does not normally produce IFN-γ, for example, by using a subclone of the adherent 293T human embryonic kidney cell line that expresses the ecdysone receptor, co-transfected with an ecdysone-driven T-bet expression plasmid, and an IFN-γ promoter luciferase reporter. (Wakita et al. 2001. Biotechniques 31:414; No et al. Proceedings of the National Academy of Sciences USA 93:3346; Graham. 2002 Expert Opin. Biol. Ther. 2:525). Upon treatment with the insect hormone ecdysone, T-bet is expressed, the IFN-γ reporter is activated and luciferase activity is generated. In this system, T-bet confers on the cell line the ability to produce endogenous IFN-γ.

ii. Cell-Free Assays

In another embodiment, the indicator composition is a cell free composition. T-bet or a non-T-bet polypeptide which acts upstream or downstream of T-bet in a pathway involving T-bet expressed by recombinant methods in a host cells or culture medium can be isolated from the host cells, or cell culture medium using standard methods for purifying polypeptides, for example, by ion-exchange chromatography, gel filtration chromatography, ultrafiltration, electrophoresis, and immunoaffinity purification with antibodies specific for T-bet to produce protein that can be used in a cell free composition. Alternatively, an extract of T-bet or non-T-bet expressing cells can be prepared for use as cell-free composition.

In one embodiment, compounds that specifically modulate T-bet activity are identified based on their ability to modulate the interaction of T-bet with a target molecule to which T-bet binds. The target molecule can be a DNA molecule, e.g., a T-bet-responsive element, such as the regulatory region of a cytokine gene) or a polypeptide molecule, e.g., a Tec kinase. Suitable assays are known in the art that allow for the detection of protein-protein interactions (e.g., immunoprecipitations, fluorescent polarization or energy transfer, two-hybrid assays and the like) or that allow for the detection of interactions between a DNA binding protein with a target DNA sequence (e.g., electrophoretic mobility shift assays, DNAse I footprinting assays and the like). By performing such assays in the presence and absence of test compounds, these assays can be used to identify compounds that modulate (e.g., inhibit or enhance) the interaction of T-bet with a target molecule.

In one embodiment, the amount of binding of T-bet to the target molecule in the presence of the test compound is greater than the amount of binding of T-bet to the target molecule in the absence of the test compound, in which case the test compound is identified as a compound that enhances or stabilizes binding of T-bet. In another embodiment, the amount of binding of the T-bet to the target molecule in the presence of the test compound is less than the amount of binding of the T-bet to the target molecule in the absence of the test compound, in which case the test compound is identified as a compound that inhibits or destabilizes binding of T-bet.

Binding of the test compound to the T-bet polypeptide can be determined either directly or indirectly as described above. Determining the ability of the T-bet polypeptide to bind to a test compound can also be accomplished using a technology such as real-time Biomolecular Interaction Analysis (BIA) (Sjolander, S. and Urbaniczky, C. (1991) Anal. Chem. 63:2338-2345; Szabo et al. (1995) Curr. Opin. Struct. Biol. 5:699-705). As used herein, “BIA” is a technology for studying biospecific interactions in real time, without labeling any of the interactants (e.g., BLAcore). Changes in the optical phenomenon of surface plasmon resonance (SPR) can be used as an indication of real-time reactions between biological molecules.

In the methods of the invention for identifying test compounds that modulate an interaction between T-bet polypeptide and a target molecule, the full-length T-bet polypeptide may be used in the method, or, alternatively, only portions of the T-bet may be used. The degree of interaction between T-bet polypeptides and the target molecule can be determined, for example, by labeling one of the polypeptides with a detectable substance (e.g., a radiolabel), isolating the non-labeled polypeptide and quantitating the amount of detectable substance that has become associated with the non-labeled polypeptide. The assay can be used to identify test compounds that either stimulate or inhibit the interaction between the T-bet protein and a target molecule. A test compound that stimulates the interaction between the T-bet polypeptide and a target molecule is identified based upon its ability to increase the degree of interaction between the T-bet polypeptide and a target molecule as compared to the degree of interaction in the absence of the test compound. A test compound that inhibits the interaction between the T-bet polypeptide and a target molecule is identified based upon its ability to decrease the degree of interaction between the T-bet polypeptide and a target molecule as compared to the degree of interaction in the absence of the compound.

In more than one embodiment of the above assay methods of the present invention, it may be desirable to immobilize either T-bet or a T-bet target molecule, a kinase, for example, to facilitate separation of complexed from uncomplexed forms of one or both of the polypeptides, or to accommodate automation of the assay. Binding of a test compound to a T-bet polypeptide, or interaction of a T-bet polypeptide with a T-bet target molecule in the presence and absence of a test compound, can be accomplished in any vessel suitable for containing the reactants. Examples of such vessels include microtitre plates, test tubes, and micro-centrifuge tubes. In one embodiment, a fusion protein can be provided which adds a domain that allows one or both of the polypeptides to be bound to a matrix. For example, glutathione-S-transferase/T-bet fusion proteins or glutathione-S-transferase/target fusion proteins can be adsorbed onto glutathione sepharose beads (Sigma Chemical, St. Louis, Mo.) or glutathione derivatized microtitre plates, which are then combined with the test compound or the test compound and either the non-adsorbed target polypeptide or T-bet polypeptide, and the mixture incubated under conditions conducive to complex formation (e.g., at physiological conditions for salt and pH). Following incubation, the beads or microtitre plate wells are washed to remove any unbound components, the matrix is immobilized in the case of beads, and complex formation is determined either directly or indirectly, for example, as described above. Alternatively, the complexes can be dissociated from the matrix, and the level of T-bet binding or activity determined using standard techniques.

Other techniques for immobilizing polypeptides on matrices can also be used in the screening assays of the invention. For example, either a T-bet polypeptide or a T-bet target molecule can be immobilized utilizing conjugation of biotin and streptavidin. Biotinylated T-bet polypeptide or target molecules can be prepared from biotin-NHS(N-hydroxy-succinimide) using techniques known in the art (e.g., biotinylation kit, Pierce Chemicals, Rockford, Ill.), and immobilized in the wells of streptavidin-coated 96 well plates (Pierce Chemical). Alternatively, antibodies which are reactive with T-bet polypeptide or target molecules but which do not interfere with binding of the T-bet polypeptide to its target molecule can be derivatized to the wells of the plate, and unbound target or T-bet polypeptide is trapped in the wells by antibody conjugation. Methods for detecting such complexes, in addition to those described above for the GST-immobilized complexes, include immunodetection of complexes using antibodies reactive with the T-bet polypeptide or target molecule, as well as enzyme-linked assays which rely on detecting an enzymatic activity associated with the T-bet polypeptide or target molecule.

In yet another aspect of the invention, the T-bet polypeptide or fragments thereof can be used as “bait proteins” in a two-hybrid assay or three-hybrid assay (see, e.g., U.S. Pat. No. 5,283,317; Zervos et al. (1993) Cell 72:223-232; Madura et al. (1993) J. Biol. Chem. 268:12046-12054; Bartel et al. (1993) Biotechniques 14:920-924; Iwabuchi et al (1993) Oncogene 8:1693-1696; and Brent WO94/10300), to identify other polypeptides, which bind to or interact with T-bet (“T-bet-binding proteins” or “T-bet”) and are involved in T-bet activity. Such T-bet-binding proteins are also likely to be involved in the propagation of signals by the T-bet polypeptides or T-bet targets as, for example, downstream elements of a T-bet-mediated signaling pathway. Alternatively, such T-bet-binding polypeptides are likely to be T-bet inhibitors.

The two-hybrid system is based on the modular nature of most transcription factors, which consist of separable DNA-binding and activation domains. Briefly, the assay utilizes two different DNA constructs. In one construct, the gene that codes for a T-bet polypeptide is fused to a gene encoding the DNA binding domain of a known transcription factor (e.g., GAL-4). In the other construct, a DNA sequence, from a library of DNA sequences, that encodes an unidentified protein (“prey” or “sample”) is fused to a gene that codes for the activation domain of the known transcription factor. If the “bait” and the “prey” proteins are able to interact, in vivo, forming a T-bet-dependent complex, the DNA-binding and activation domains of the transcription factor are brought into close proximity. This proximity allows transcription of a reporter gene (e.g., LacZ) which is operably linked to a transcriptional regulatory site responsive to the transcription factor. Expression of the reporter gene can be detected and cell colonies containing the functional transcription factor can be isolated and used to obtain the cloned gene which encodes the polypeptide which interacts with the T-bet polypeptide.

In another embodiment, representational difference analysis (RDA) and microchip DNA array analysis to isolate T-bet target genes. For example, differential display or subtraction methods coupled with PCR (RDA; see e.g., Hubank, M. & Schatz, D. G. 1994. Nuc. Acid Res. 22, 5640-5648; Chang, Y., et al. 1994. Science 266, 1865; von Stein, O. D., et al. 1997. Nuc. Acid Res. 25, 2598; Lisitsyn, N. & Wigler, M. 1993. Science 259, 946) employing subtracted or unsubtracted probes or, most recently, DNA microchip array hybridization (Welford et al. 1998. Nucl. Acids. Res. 15:3059) can be used. In performing such assays, a variety of cells can be used, e.g., normal cells, cells engineered to express T-bet, or cells from mice lacking T-bet or overexpressing T-bet (e.g., from a transgenic non-human animal) can be used.

In yet another embodiment, proteomic approaches to describe T-bet target proteins can be performed. For example, subtractive analysis, analysis of expression patterns, identification of genotypic variations at the protein level and protein identification and detection of post-translational modifications can be performed as described in, e.g., Wang et al. (2002) J. Chromatogr. B. Technol. Biomed Life Sci. 782(1-2): 291-306; Lubman et al. (2002) J. Chromatogr. B. Technol. Biomed Life Sci. 782(1-2): 183-96; and Rai et al. (2002) Arch. Pathol. Lab. Med. 126(12):1518-26.

C. Assays Using T-bet Deficient Cells

In another embodiment, the invention provides methods for identifying compounds that modulate a biological effect of T-bet using cells deficient in T-bet. As previously described, inhibition of T-bet activity (e.g., by disruption of the T-bet gene) in B cells results in a deficiency of IgG2a production. Thus, cells deficient in T-bet can be used identify agents that modulate a biological response regulated by T-bet by means other than modulating T-bet itself (i.e., compounds that “rescue” the T-bet deficient phenotype). Alternatively, a “conditional knock-out” system, in which the T-bet gene is rendered non-functional in a conditional manner, can be used to create T-bet deficient cells for use in screening assays. For example, a tetracycline-regulated system for conditional disruption of a gene as described in WO 94/29442 and U.S. Pat. No. 5,650,298 can be used to create cells, or T-bet deficient animals from which cells can be isolated, that can be rendered T-bet deficient in a controlled manner through modulation of the tetracycline concentration in contact with the cells. For assays relating to other biological effects of T-bet a similar conditional disruption approach can be used or, alternatively, the RAG-2 deficient blastocyst complementation system can be used to generate mice with lymphoid organs that arise from embryonic stem cells with homozygous mutations of the T-bet gene. T-bet deficient lymphoid cells (e.g., thymic, splenic and/or lymph node cells) or purified T-bet deficient B cells from such animals can be used in screening assays.

In the screening method, cells deficient in T-bet are contacted with a test compound and a biological response regulated by T-bet is monitored. Modulation of the response in T-bet deficient cells (as compared to an appropriate control such as, for example, untreated cells or cells treated with a control agent) identifies a test compound as a modulator of the T-bet regulated response.

In one embodiment, the test compound is administered directly to a non-human T-bet deficient animal, preferably a mouse (e.g., a mouse in which the T-bet gene is conditionally disrupted by means described above, or a chimeric mouse in which the lymphoid organs are deficient in T-bet as described above), to identify a test compound that modulates the in vivo responses of cells deficient in T-bet. In another embodiment, cells deficient in T-bet are isolated from the non-human T-bet deficient animal, and contacted with the test compound ex vivo to identify a test compound that modulates a response regulated by T-bet in the cells deficient in T-bet.

Cells deficient in T-bet can be obtained from a non-human animals created to be deficient in T-bet. Preferred non-human animals include monkeys, dogs, cats, mice, rats, cows, horses, goats and sheep. In preferred embodiments, the T-bet deficient animal is a mouse. Mice deficient in T-bet can be made as described in the Examples. Non-human animals deficient in a particular gene product typically are created by homologous recombination. Briefly, a vector is prepared which contains at least a portion of the T-bet gene into which a deletion, addition or substitution has been introduced to thereby alter, e.g., functionally disrupt, the endogenous T-bet gene. The T-bet gene preferably is a mouse T-bet gene. For example, a mouse T-bet gene can be isolated from a mouse genomic DNA library using the mouse T-bet cDNA as a probe. The mouse T-bet gene then can be used to construct a homologous recombination vector suitable for altering an endogenous T-bet gene in the mouse genome. In a preferred embodiment, the vector is designed such that, upon homologous recombination, the endogenous T-bet gene is functionally disrupted (i.e., no longer encodes a functional polypeptide; also referred to as a “knock out” vector). Alternatively, the vector can be designed such that, upon homologous recombination, the endogenous T-bet gene is mutated or otherwise altered but still encodes functional polypeptide (e.g., the upstream regulatory region can be altered to thereby alter the expression of the endogenous T-bet polypeptide). In the homologous recombination vector, the altered portion of the T-bet gene is flanked at its 5′ and 3′ ends by additional nucleic acid of the T-bet gene to allow for homologous recombination to occur between the exogenous T-bet gene carried by the vector and an endogenous T-bet gene in an embryonic stem cell. The additional flanking T-bet nucleic acid is of sufficient length for successful homologous recombination with the endogenous gene. Typically, several kilobases of flanking DNA (both at the 5′ and 3′ ends) are included in the vector (see e.g., Thomas, K. R. and Capecchi, M. R. (1987) Cell 51:503 for a description of homologous recombination vectors). The vector is introduced into an embryonic stem cell line (e.g., by electroporation) and cells in which the introduced T-bet gene has homologously recombined with the endogenous T-bet gene are selected (see e.g., Li, E. et al. (1992) Cell 69:915). The selected cells are then injected into a blastocyst of an animal (e.g., a mouse) to form aggregation chimeras (see e.g., Bradley, A. in Teratocarcinomas and Embryonic Stem Cells: A Practical Approach, E. J. Robertson, ed. (IRL, Oxford, 1987) pp. 113-152). A chimeric embryo can then be implanted into a suitable pseudopregnant female foster animal and the embryo brought to term. Progeny harboring the homologously recombined DNA in their germ cells can be used to breed animals in which all cells of the animal contain the homologously recombined DNA by germline transmission of the transgene. Methods for constructing homologous recombination vectors and homologous recombinant animals are described further in Bradley, A. (1991) Current Opinion in Biotechnology 2:823-829 and in PCT International Publication Nos.: WO 90/11354 by Le Mouellec et al.; WO 91/01140 by Smithies et al.; WO 92/0968 by Zijlstra et al.; and WO 93/04169 by Berns et al.

In another embodiment, retroviral transduction of donor bone marrow cells from both wild type and T-bet null mice can be performed with the DN or dominant negative constructs to reconstitute irradiated RAG recipients. This will result in the production of mice whose lymphoid cells express only a dominant negative version of T-bet. B cells from these mice can then be tested for compounds that modulate a biological response regulated by T-bet.

In one embodiment of the screening assay, compounds tested for their ability to modulate a biological response regulated by T-bet are contacted with T-bet deficient cells by administering the test compound to a non-human T-bet deficient animal in vivo and evaluating the effect of the test compound on the response in the animal. The test compound can be administered to a non-human T-bet deficient animal as a pharmaceutical composition. Such compositions typically comprise the test compound and a pharmaceutically acceptable carrier. As used herein the term “pharmaceutically acceptable carrier” is intended to include any and all solvents, dispersion media, coatings, antibacterial and antifungal compounds, isotonic and absorption delaying compounds, and the like, compatible with pharmaceutical administration. The use of such media and compounds for pharmaceutically active substances is well known in the art. Except insofar as any conventional media or compound is incompatible with the active compound, use thereof in the compositions is contemplated. Supplementary active compounds can also be incorporated into the compositions.

D. Test Compounds

A variety of test compounds can be evaluated using the screening assays described herein. In certain embodiments, the compounds to be tested can be derived from libraries (i.e., are members of a library of compounds). While the use of libraries of peptides is well established in the art, new techniques have been developed which have allowed the production of mixtures of other compounds, such as benzodiazepines (Bunin et al. (1992). J. Am. Chem. Soc. 114:10987; DeWitt et al. (1993). Proc. Natl. Acad. Sci. USA 90:6909) peptoids (Zuckermann. (1994). J. Med. Chem. 37:2678) oligocarbamates (Cho et al. (1993). Science. 261:1303-), and hydantoins (DeWitt et al. supra). An approach for the synthesis of molecular libraries of small organic molecules with a diversity of 104-105 as been described (Carell et al. (1994). Angew. Chem. Int. Ed. Engl. 33:2059-; Carell et al. (1994) Angew. Chem. Int. Ed. Engl. 33:2061-).

The compounds of the present invention can be obtained using any of the numerous approaches in combinatorial library methods known in the art, including: biological libraries; spatially addressable parallel solid phase or solution phase libraries, synthetic library methods requiring deconvolution, the ‘one-bead one-compound’ library method, and synthetic library methods using affinity chromatography selection. The biological library approach is limited to peptide libraries, while the other four approaches are applicable to peptide, non-peptide oligomer or small molecule libraries of compounds (Lam, K. S. (1997) Anticancer Compound Des. 12:145). Other exemplary methods for the synthesis of molecular libraries can be found in the art, for example in: Erb et al. (1994). Proc. Natl. Acad. Sci. USA 91:11422; Horwell et al. (1996) Immunopharmacology 33:68; and in Gallop et al. (1994); J. Med. Chem. 37:1233.

Libraries of compounds may be presented in solution (e.g., Houghten (1992) Biotechniques 13:412-421), or on beads (Lam (1991) Nature 354:82-84), chips (Fodor (1993) Nature 364:555-556), bacteria (Ladner U.S. Pat. No. 5,223,409), spores (Ladner USP '409), plasmids (Cull et al. (1992) Proc Natl. Acad Sci USA 89:1865-1869) or on phage (Scott and Smith (1990) Science 249:386-390); (Devlin (1990) Science 249:404-406); (Cwirla et al. (1990) Proc. Natl. Acad. Sci. 87:6378-6382); (Felici (1991) J. Mol. Biol. 222:301-310); In still another embodiment, the combinatorial polypeptides are produced from a cDNA library.

Exemplary compounds which can be screened for activity include, but are not limited to, peptides, nucleic acids, carbohydrates, small organic molecules, and natural product extract libraries.

Candidate/test compounds include, for example, 1) peptides such as soluble peptides, including Ig-tailed fusion peptides and members of random peptide libraries (see, e.g., Lam, K. S. et al. (1991) Nature 354:82-84; Houghten, R. et al. (1991) Nature 354:84-86) and combinatorial chemistry-derived molecular libraries made of D- and/or L-configuration amino acids; 2) phosphopeptides (e.g., members of random and partially degenerate, directed phosphopeptide libraries, see, e.g., Songyang, Z. et al. (1993) Cell 72:767-778); 3) antibodies (e.g., polyclonal, monoclonal, humanized, anti-idiotypic, chimeric, and single chain antibodies as well as Fab, F(ab′)₂, Fab expression library fragments, and epitope-binding fragments of antibodies); 4) small organic and inorganic molecules (e.g., molecules obtained from combinatorial and natural product libraries); 5) enzymes (e.g., endoribonucleases, hydrolases, nucleases, proteases, synthatases, isomerases, polymerases, kinases, phosphatases, oxido-reductases and ATPases), and 6) mutant forms or T-bet molecules, e.g., dominant negative mutant forms of the molecules.

The test compounds of the present invention can be obtained using any of the numerous approaches in combinatorial library methods known in the art, including: biological libraries; spatially addressable parallel solid phase or solution phase libraries; synthetic library methods requiring deconvolution; the ‘one-bead one-compound’ library method; and synthetic library methods using affinity chromatography selection. The biological library approach is limited to peptide libraries, while the other four approaches are applicable to peptide, non-peptide oligomer or small molecule libraries of compounds (Lam, K. S. (1997) Anticancer Compound Des. 12:145).

Examples of methods for the synthesis of molecular libraries can be found in the art, for example in: DeWitt et al. (1993) Proc. Natl. Acad. Sci. U.S.A. 90:6909; Erb et al. (1994) Proc. Natl. Acad. Sci. USA 91:11422; Zuckermann et al. (1994) J. Med. Chem. 37:2678; Cho et al. (1993) Science 261:1303; Carrell et al. (1994) Angew. Chem. Int. Ed. Engl. 33:2059; Carell et al. (1994) Angew. Chem. Int. Ed. Engl. 33:2061; and Gallop et al. (1994) J. Med. Chem. 37:1233.

Libraries of compounds may be presented in solution (e.g., Houghten (1992) Biotechniques 13:412-421), or on beads (Lam (1991) Nature 354:82-84), chips (Fodor (1993) Nature 364:555-556), bacteria (Ladner U.S. Pat. No. 5,223,409), spores (Ladner USP '409), plasmids (Cull et al. (1992) Proc Natl. Acad Sci USA 89:1865-1869) or phage (Scott and Smith (1990) Science 249:386-390; Devlin (1990) Science 249:404-406; Cwirla et al. (1990) Proc. Natl. Acad. Sci. 87:6378-6382; Felici (1991) J. Mol. Biol. 222:301-310; Ladner supra.).

Compounds identified in the subject screening assays can be used in methods of modulating one or more of the biological responses regulated by T-bet. It will be understood that it may be desirable to formulate such compound(s) as pharmaceutical compositions (described supra) prior to contacting them with cells.

Once a test compound is identified that directly or indirectly modulates T-bet expression and/or activity, by one of the variety of methods described hereinbefore, the selected test compound (or “compound of interest”) can then be further evaluated for its effect on cells, for example by contacting the compound of interest with cells either in vivo (e.g., by administering the compound of interest to a subject) or ex vivo (e.g., by isolating cells from the subject and contacting the isolated cells with the compound of interest or, alternatively, by contacting the compound of interest with a cell line) and determining the effect of the compound of interest on the cells, as compared to an appropriate control (such as untreated cells or cells treated with a control compound, or carrier, that does not modulate the biological response). Compounds of interest can also be identified using structure based drug design using techniques known in the art.

The instant invention also pertains to compounds identified in the above assays.

VI. Methods for Modulating Biological Responses Regulated by T-Bet

Yet another aspect of the invention pertains to methods of modulating T-bet expression and/or activity in a cell. The modulatory methods of the invention involve contacting a cell with an agent that modulates Th2 cell lineage commitment such that Th2 cell lineage commitmentis modulated. In order for T-bet expression and/or activity to be modulated in a cell, the cell is contacted with a modulatory agent in an amount sufficient to modulate the expression and/or activity of T-bet.

In one embodiment, the modulatory methods of the invention are performed in vitro. In another embodiment, the modulatory methods of the invention are performed in vivo, e.g., in a subject having a disorder or condition that would benefit from modulation of Th2 cell lineage commitment.

The agent may act by modulating the activity of T-bet polypeptide in the cell, (e.g., by contacting a cell with an agent that, e.g., interferes with the binding of T-bet to a molecule with which it interacts, changes the binding specificity of T-bet or a binding partner, or modulates the post-translational modification of T-bet) or the expression of T-bet or a binding partner, (e.g., by modulating transcription of the T-bet gene or translation of the T-bet mRNA).

Accordingly, the invention features methods for modulating Th2 cell lineage commitment by contacting the cells with a modulator such that the biological response is modulated.

In another embodiment, a gene whose transcription is directly modulated by T-bet can be modulated using the methods of the invention. In one embodiment, the instant methods can be performed in vitro In a preferred embodiment, T-bet can be modulated in a cell in vitro and then the treated cells can be administered to a subject.

The subject invention can also be used to treat various conditions or disorders that would benefit from modulation of Th2 cell lineage commitment. Exemplary disorders that would benefit from modulation of Th2 cell lineage commitment are set forth herein. In one embodiment, the invention provides for the direct modulation of Th2 cytokine production in vivo, by administering to a subject with a disorder that would benefit therefrom, a therapeutically effective amount of an agent that decrease the Itk-mediated binding of T-bet and GATA3 in T cells such that the disorder is treated or prevented. For example, Th2 cytokine production can be modulated to treat an autoimmune disorder, or an immunodeficiency.

The term “subject” is intended to include living organisms in which an immune response can be elicited. Preferred subjects are mammals. Particularly preferred subjects are humans. Other examples of subjects include monkeys, dogs, cats, mice, rats cows, horses, goats, sheep as well as other farm and companion animals. Modulation of T-bet expression and/or activity, in humans as well as veterinary applications, provides a means to regulate disorders arising from aberrant T-bet expression and/or activity in various disease states and is encompassed by the present invention.

A modulatory agent, such as a chemical compound, can be administered to a subject as a pharmaceutical composition. Such compositions typically comprise the modulatory agent and a pharmaceutically acceptable carrier. As used herein the term “pharmaceutically acceptable carrier” is intended to include any and all solvents, dispersion media, coatings, antibacterial and antifungal agents, isotonic and absorption delaying agents, and the like, compatible with pharmaceutical administration. The use of such media and agents for pharmaceutically active substances is well known in the art. Except insofar as any conventional media or agent is incompatible with the active compound, use thereof in the compositions is contemplated. Supplementary active compounds can also be incorporated into the compositions. Pharmaceutical compositions can be prepared as described above in subsection IV.

The identification of T-bet as a key regulator of the development of Th1 cells described herein, and in the direct repression of the Th2 phenotype, allows for selective manipulation of T cell subsets in a variety of clinical situations using the modulatory methods of the invention. In one method of the invention (i.e., methods that of increasing the formation or stability of a complex between Tbet/GATA3/Tec kinase) result in decreased production of Th2 cytokines, thus downmodulating the Th2 response. In contrast, the in another method of the invention (i.e., of decreasing the formation or stability of a complex between T-bet/GATA3/Tec kinase) the production of Th2 cytokines is increased, thereby promoting of a Th2 response. Thus, to treat a disease condition wherein a Th2 response is detrimental, a method of stabilizing or increasing the formation of the complex (stimulatory methods) is selected such that Th2 responses are downregulated. Alternatively, to treat a disease condition wherein a Th2 response is beneficial, an method of reducing the stability of or reducing the formation of the complex (inhibitory methods) is selected such that Th2 responses are promoted. Application of the methods of the invention to the treatment of diseases or conditions may result in cure of the condition, a decrease in the type or number of symptoms associated with the condition, either in the long term or short term (i.e., amelioration of the condition) or simply a transient beneficial effect to the subject.

Numerous diseases or conditions associated with a predominant Th1 or Th2-type response have been identified and would benefit from modulation of the type of response mounted in the individual suffering from the disease condition. Application of the immunomodulatory methods of the invention to such diseases or conditions is described in further detail below.

A. Allergies

Allergies are mediated through IgE antibodies whose production is regulated by the activity of Th2 cells and the cytokines produced thereby. In allergic reactions, IL-4 is produced by Th2 cells, which further stimulates production of IgE antibodies and activation of cells that mediate allergic reactions, i.e., mast cells and basophils. IL-4 also plays an important role in eosinophil mediated inflammatory reactions. Accordingly, the stimulatory methods of the invention can be used to inhibit the production of Th2-associated cytokines, and in particular IL-4, in allergic patients as a means to downregulate production of pathogenic IgE antibodies. A stimulatory agent may be directly administered to the subject or cells (e.g., Thp cells or Th2 cells) may be obtained from the subject, contacted with a stimulatory agent ex vivo, and readministered to the subject. Moreover, in certain situations it may be beneficial to coadminister to the subject the allergen together with the stimulatory agent or cells treated with the stimulatory agent to inhibit (e.g., desensitize) the allergen-specific response. The treatment may be further enhanced by administering other Th1-promoting agents, such as the cytokine IL-12 or antibodies to Th2-associated cytokines (e.g., anti-IL-4 antibodies), to the allergic subject in amounts sufficient to further stimulate a Th1-type response.

B. Cancer

The expression of Th2-promoting cytokines has been reported to be elevated in cancer patients (see e.g., Yamamura, M., et al. (1993) J. Clin. Invest. 91:1005-1010; Pisa, P., et al. (1992) Proc. Natl. Acad. Sci. USA 89:7708-7712) and malignant disease is often associated with a shift from Th1 type responses to Th2 type responses along with a worsening of the course of the disease. Accordingly, the stimulatory methods of the invention can be used to inhibit the production of Th2-associated cytokines in cancer patients, as a means to counteract the Th1 to Th2 shift and thereby promote an ongoing Th 1 response in the patients to ameliorate the course of the disease. The stimulatory method can involve either direct administration of an stimulatory agent to a subject with cancer or ex vivo treatment of cells obtained from the subject (e.g., Thp or Th2 cells) with a stimulatory agent followed by readministration of the cells to the subject. The treatment may be further enhanced by administering other Th1-promoting agents, such as the cytokine IL-12 or antibodies to Th2-associated cytokines (e.g., anti-IL-4 antibodies), to the recipient in amounts sufficient to further stimulate a Th1-type response.

C. Infectious Diseases

The expression of Th2-promoting cytokines also has been reported to increase during a variety of infectious diseases, including HIV infection, tuberculosis, leishmaniasis, schistosomiasis, filarial nematode infection and intestinal nematode infection (see e.g.; Shearer, G. M. and Clerici, M. (1992) Prog. Chem. Immunol. 54:21-43; Clerici, M and Shearer, G. M. (1993) Immunology Today 14:107-111; Fauci, A. S. (1988) Science 239:617-623; Locksley, R. M. and Scott, P. (1992) Immunoparasitology Today 1:A58-A61; Pearce, E. J., et al. (1991) J. Exp. Med. 173:159-166; Grzych, J-M., et al. (1991) J. Immunol. 141:1322-1327; Kullberg, M. C., et al. (1992) J. Immunol. 148:3264-3270; Bancroft, A. J., et al. (1993) J. Immunol. 150:1395-1402; Pearlman, E., et al. (1993) Infect. Immun. 61:1105-1112; Else, K. J., et al. (1994) J. Exp. Med. 179:347-351) and such infectious diseases are also associated with a Th1 to Th2 shift in the immune response. Accordingly, the stimulatory methods of the invention can be used to inhibit the production of Th2-associated cytokines in subjects with infectious diseases, as a means to counteract the Th1 to Th2 shift and thereby promote an ongoing Th1 response in the patients to ameliorate the course of the infection. The stimulatory method can involve either direct administration of an inhibitory agent to a subject with an infectious disease or ex vivo treatment of cells obtained from the subject (e.g., Thp or Th2 cells) with a stimulatory agent followed by readministration of the cells to the subject. The treatment may be further enhanced by administering other Th1-promoting agents, such as the cytokine IL-12 or antibodies to Th2-associated cytokines (e.g., anti-IL-4 antibodies), to the recipient in amounts sufficient to further stimulate a Th1-type response.

D. Autoimmune Diseases

The inhibitory methods of the invention can be used therapeutically in the treatment of autoimmune diseases that are associated with a Th2-type dysfunction. Many autoimmune disorders are the result of inappropriate activation of T cells that are reactive against self tissue and that promote the production of cytokines and autoantibodies involved in the pathology of the diseases. Modulation of T helper-type responses can have an effect on the course of the autoimmune disease. For example, in experimental allergic encephalomyelitis (EAE), stimulation of a Th2-type response by administration of IL-4 at the time of the induction of the disease diminishes the intensity of the autoimmune disease (Paul, W. E., et al. (1994) Cell 76:241-251). Furthermore, recovery of the animals from the disease has been shown to be associated with an increase in a Th2-type response as evidenced by an increase of Th2-specific cytokines (Koury, S. J., et al. (1992) J. Exp. Med. 176:1355-1364). Moreover, T cells that can suppress EAE secrete Th2-specificcytokines (Chen, C., et al. (1994) Immunity 1:147-154). Since stimulation of a Th2-type response in EAE has a protective effect against the disease, stimulation of a Th2 response in subjects with multiple sclerosis (for which EAE is a model) is likely to be beneficial therapeutically. The inhibitory methods of the invention can be used to effect such a decrease.

Similarly, stimulation of a Th2-type response in type I diabetes in mice provides a protective effect against the disease. Indeed, treatment of NOD mice with IL-4 (which promotes a Th2 response) prevents or delays onset of type I diabetes that normally develops in these mice (Rapoport, M. J., et al. (1993) J. Exp. Med. 178:87-99). Thus, stimulation of a Th2 response, e.g., using an inhibitor of the complex, in a subject suffering from or susceptible to diabetes may ameliorate the effects of the disease or inhibit the onset of the disease.

Yet another autoimmune disease in which stimulation of a Th2-type response may be beneficial is rheumatoid arthritis (RA). Studies have shown that patients with rheumatoid arthritis have predominantly Th1 cells in synovial tissue (Simon, A. K., et al. (1994) Proc. Natl. Acad. Sci. USA 91:8562-8566). By stimulating a Th2 response in a subject with RA, the detrimental Th1 response can be concomitantly downmodulated to thereby ameliorate the effects of the disease.

Accordingly, the inhibitory methods of the invention can be used to stimulate production of Th2-associated cytokines in subjects suffering from, or susceptible to, an autoimmune disease in which a Th2-type response is beneficial to the course of the disease. The inhibitory method can involve either direct administration of an inhibitory agent to the subject or ex vivo treatment of cells obtained from the subject (e.g., Thp, Th1 cells, B cells, non-lymphoid cells) with an inhibitory agent followed by readministration of the cells to the subject. The treatment may be further enhanced by administering other Th2-promoting agents, such as IL-4 itself or antibodies to Th1-associated cytokines, to the subject in amounts sufficient to further stimulate a Th2-type response.

In contrast to the autoimmune diseases described above in which a Th2 response is desirable, other autoimmune diseases may be ameliorated by a Th1-type response. Such diseases can be treated using a stimulatory agent of the invention (as described above for cancer and infectious diseases). The treatment may be further enhanced by administrating a Th1-promoting cytokine (e.g., IFN-γ) to the subject in amounts sufficient to further stimulate a Th1-type response.

The efficacy of agents for treating autoimmune diseases can be tested in the above described animal models of human diseases (e.g., EAE as a model of multiple sclerosis and the NOD mice as a model for diabetes) or other well characterized animal models of human autoimmune diseases. Such animal models include the mrl/lpr/lpr mouse as a model for lupus erythematosus, murine collagen-induced arthritis as a model for rheumatoid arthritis, and murine experimental myasthenia gravis (see Paul ed., Fundamental Immunology, Raven Press, New York, 1989, pp. 840-856). A modulatory (i.e., stimulatory or inhibitory) agent of the invention is administered to test animals and the course of the disease in the test animals is then monitored by the standard methods for the particular model being used. Effectiveness of the modulatory agent is evidenced by amelioration of the disease condition in animals treated with the agent as compared to untreated animals (or animals treated with a control agent).

Non-limiting examples of autoimmune diseases, disorders and conditions having an autoimmune component that may be treated according to the invention include diabetes mellitus, arthritis (including rheumatoid arthritis, juvenile rheumatoid arthritis, osteoarthritis, psoriatic arthritis), multiple sclerosis, myasthenia gravis, systemic lupus erythematosis, autoimmune thyroiditis, dermatitis (including atopic dermatitis and eczematous dermatitis), psoriasis, Sjögren's Syndrome, including keratoconjunctivitis sicca secondary to Sjögren's Syndrome, alopecia greata, allergic responses due to arthropod bite reactions, Crohn's disease, aphthous ulcer, iritis, conjunctivitis, keratoconjunctivitis, ulcerative colitis, allergic asthma, cutaneous lupus erythematosus, scleroderma, vaginitis, proctitis, compound eruptions,

leprosy reversal reactions, erythema nodosum leprosum, autoimmune uveitis, allergic encephalomyelitis, acute necrotizing hemorrhagic encephalopathy, idiopathic bilateral progressive sensorineural hearing loss, aplastic anemia, pure red cell anemia, idiopathic thrombocytopenia, polychondritis, Wegener's granulomatosis, chronic active hepatitis, Stevens-Johnson syndrome, idiopathic sprue, lichen planus, Crohn's disease, Graves ophthalmopathy, sarcoidosis, primary biliary cirrhosis, uveitis posterior, and interstitial lung fibrosis.

In a particular embodiment, diseases, disorders and conditions that may be treated by the methods of the invention include Crohn's disease and ulcerative colitis, which are the two major forms of inflammatory bowel diseases (IBD) in humans. Cytokines produced by T lymphocytes appear to initiate and perpetuate chronic intestinal inflammation. Crohn's disease is associated with increased production of T helper 1 (Th1) type cytokines such as IFN-γ and TNF. Ulcerative colitis is generally associated with T cells producing large amounts of the Th2 type cytokines and is referred to herein as “Th2-mediated colitis.” “Th1-mediated colitis” refers to a Crohn's disease profile as well as to the Th1 type response which can occur in ulcerative colitis. In Th1-mediated colitis, agents which inhibit the activity of T-bet provide a protective effect. In Th2-mediated colitis, agents which stimulate the activity of T-bet provide a protective effect.

In another particular embodiment, diseases, disorders and conditions that may be treated by the methods of the invention include asthma, which is a disease of the bronchial tubes, or airways of the lungs, characterized by tightening of these airways. Production of IL-4, IL-5 and IL-13 has been associated with the development of an asthma-like phenotype. Accordingly, agents of the invention which stimulate the activity of T-bet provide a protective effect against asthma.

E. Transplantation

While graft rejection or graft acceptance may not be attributable exclusively to the action of a particular T cell subset (i.e., Th1 or Th2 cells) in the graft recipient (for a discussion see Dallman, M. J. (1995) Curr. Opin. Immunol. 7:632-638), numerous studies have implicated a predominant Th2 response in prolonged graft survival or a predominant Th1 response in graft rejection. For example, graft acceptance has been associated with production of a Th2 cytokine pattern and/or graft rejection has been associated with production of a Th1 cytokine pattern (see e.g., Takeuchi, T. et al. (1992) Transplantation 53:1281-1291; Tzakis, A. G. et al. (1994) J. Pediatr. Surg. 29:754-756; Thai, N. L. et al. (1995) Transplantation 59:274-281). Additionally, adoptive transfer of cells having a Th2 cytokine phenotype prolongs skin graft survival (Maeda, H. et al. (1994) Int. Immunol. 6:855-862) and reduces graft-versus-host disease (Fowler, D. H. et al. (1994) Blood 84:3540-3549; Fowler, D. H. et al. (1994) Prog. Clin. Biol. Res. 389:533-540). Still further, administration of IL-4, which promotes Th2 differentiation, prolongs cardiac allograft survival (Levy, A. E. and Alexander, J. W. (1995) Transplantation 60:405-406), whereas administration of IL-12 in combination with anti-IL-10 antibodies, which promotes Th1 differentiation, enhances skin allograft rejection (Gorczynski, R. M. et al. (1995) Transplantation 60:1337-1341).

Accordingly, the inhibitory methods of the invention can be used to stimulate production of Th2-associated cytokines in transplant recipients to prolong survival of the graft. The inhibitory methods can be used both in solid organ transplantation and in bone marrow transplantation (e.g., to inhibit graft-versus-host disease). The inhibitory method can involve either direct administration of an inhibitory agent to the transplant recipient or ex vivo treatment of cells obtained from the subject (e.g., Thp, Th1 cells, B cells, non-lymphoid cells) with an inhibitory agent followed by readministration of the cells to the subject. The treatment may be further enhanced by administering other Th2-promoting agents, such as IL-4 itself or antibodies to Th1-associated cytokines, to the recipient in amounts sufficient to further inhibit a Th2-type response.

In addition to the foregoing disease situations, the modulatory methods of the invention also are useful for other purposes. For example, the stimulatory methods of the invention (i.e., methods using a stimulatory agent) can be used to stimulate production of Th1-promoting cytokines (e.g., interferon-γ) in vitro for commercial production of these cytokines (e.g., cells can be contacted with the stimulatory agent in vitro to stimulate interferon-γ production and the interferon-γ can be recovered from the culture supernatant, further purified if necessary, and packaged for commercial use).

Furthermore, the modulatory methods of the invention can be applied to vaccinations to promote either a Th1 or a Th2 response to an antigen of interest in a subject. That is, the agents of the invention can serve as adjuvants to direct an immune response to a vaccine either to a Th1 response or a Th2 response. For example, to promote an antibody response to an antigen of interest (i.e., for vaccination purposes), the antigen and an inhibitory agent of the invention can be coadministered to a subject to promote a Th2 response to the antigen in the subject, since Th2 responses provide efficient B cell help and promote IgG1 production. Alternatively, to promote a cellular immune response to an antigen of interest, the antigen and a stimulatory agent of the invention can be coadministered to a subject to promote a Th1 response to the antigen in a subject, since Th 1 responses favor the development of cell-mediated immune responses (e.g., delayed hypersensitivity responses). The antigen of interest and the modulatory agent can be formulated together into a single pharmaceutical composition or in separate compositions. In a preferred embodiment, the antigen of interest and the modulatory agent are administered simultaneously to the subject. Alternatively, in certain situations it may be desirable to administer the antigen first and then the modulatory agent or vice versa (for example, in the case of an antigen that naturally evokes a Th1 response, it may be beneficial to first administer the antigen alone to stimulate a Th1 response and then administer an inhibitory agent, alone or together with a boost of antigen, to shift the immune response to a Th2 response).

VII. Kits of the Invention

Another aspect of the invention pertains to kits for carrying out the screening assays, modulatory methods or diagnostic assays of the invention. For example, a kit for carrying out a screening assay of the invention can include a T-bet-containing indicator composition, means for measuring a readout (e.g., polypeptide secretion) and instructions for using the kit to identify modulators of biological effects of T-bet. In another embodiment, a kit for carrying out a screening assay of the invention comprises T-bet deficient cells, means for measuring the readout and instructions for using the kit to identify modulators of a biological effect of T-bet.

In another embodiment, the invention provides a kit for carrying out a modulatory method of the invention. The kit can include, for example, a modulatory agent of the invention (e.g., T-bet inhibitory or stimulatory agent) in a suitable carrier and packaged in a suitable container with instructions for use of the modulator to modulate a biological effect of T-bet.

Another aspect of the invention pertains to a kit for diagnosing a disorder associated with a biological activity of T-bet in a subject. The kit can include a reagent for determining expression of T-bet (e.g., a nucleic acid probe for detecting T-bet mRNA or an antibody for detection of T-bet polypeptide), a control to which the results of the subject are compared, and instructions for using the kit for diagnostic purposes.

VIII. Immunomodulatory Compositions

Agents that modulate Th2 cell lineage commitment are also appropriate for use in immunomodulatory compositions. Stimulatory or inhibitory agents of the invention can be used to up or down regulate the immune response in a subject. In preferred embodiments, the humoral immune response is regulated.

Th2 cell lineage commitment modulating agents can be given alone, or in combination with an antigen to which an enhanced immune response or a reduced immune response is desired.

In another embodiment, agents which are known adjuvants can be administered with the subject modulating agents. At this time, the only adjuvant widely used in humans has been alum (aluminum phosphate or aluminum hydroxide). Saponin and its purified component Quil A, Freund's complete adjuvant and other adjuvants used in research and veterinary applications have potential use in human vaccines. However, new chemically defined preparations such as muramyl dipeptide, monophosphoryl lipid A, phospholipid conjugates such as those described by Goodman-Snitkoff et al. J. Immunol. 147:410-415 (1991) resorcinols, non-ionic surfactants such as polyoxyethylene oleyl ether and n-hexadecyl polyethylene ether, enzyme inhibitors include pancreatic trypsin inhibitor, diisopropylfluorophosphate (DEP) and trasylol can also be used. In embodiments in which antigen is administered, the antigen can e.g., be encapsulated within a proteoliposome as described by Miller et al., J. Exp. Med. 176:1739-1744 (1992) and incorporated by reference herein, or in lipid vesicles, such as Novasome™ lipid vesicles (Micro Vescular Systems, Inc., Nashua, N.H.), to further enhance immune responses.

In one embodiment, a nucleic acid molecule encoding a Th2 cell lineage commitment is administered as a DNA vaccine. This can be done using a plasmid DNA construct which is similar to those used for delivery of reporter or therapeutic genes. Such a construct preferably comprises a bacterial origin of replication that allows amplification of large quantities of the plasmid DNA; a prokaryotic selectable marker gene; a nucleic acid sequence encoding a T-bet polypeptide or portion thereof; eukaryotic transcription regulatory elements to direct gene expression in the host cell; and a polyadenylation sequence to ensure appropriate termination of the expressed mRNA (Davis. 1997. Curr. Opin. Biotechnol. 8:635). Vectors used for DNA immunization may optionally comprise a signal sequence (Michel et al. 1995. Proc. Natl. Acad. Sci USA. 92:5307; Donnelly et al. 1996. J. Infect Dis. 173:314). DNA vaccines can be administered by a variety of means, for example, by injection (e.g., intramuscular, intradermal, or the biolistic injection of DNA-coated gold particles into the epidermis with a gene gun that uses a particle accelerator or a compressed gas to inject the particles into the skin. (Haynes et al. 1996. J Biotechnol. 44:37)). Alternatively, DNA vaccines can be administered by non-invasive means. For example, pure or lipid-formulated DNA can be delivered to the respiratory system or targeted elsewhere, e.g., Peyers patches by oral delivery of DNA (Schubbert. 1997. Proc. Natl. Acad. Sci. USA 94:961). Attenuated microorganisms can be used for delivery to mucosal surfaces. (Sizemore et al. 1995. Science. 270:29) In one embodiment, plasmids for DNA vaccination can express the Th2 cell lineage commitment modulating agent as well as the antigen against which the immune response is desired or can encode modulators of immune responses such as lymphokine genes or costimulatory molecules (Iwasaki et al. 1997. J. Immunol. 158:4591).

In another embodiment, retroviral vectors are also appropriate for expression of T-bet immunomodulatory compositions. Recombinant retroviral vectors allow for integration of a transgene into a host cell genome. To transduce dividing cells, lentiviral vectors can be used as immunomodulatory compositions, and are intended to be encompassed by the present invention. Lentiviruses are complex retroviruses which, based on their higher level of complexity, can integrate into the genome of nonproliferating cells and modulate their life cycles, as in the course of latent infection. These viruses include HIV-1, HIV-2, SIV, FIV and EIV. Like other retroviruses, lentiviruses possess gag, pol and env genes which are flanked by two long terminal repeat (LTR) sequences. Each of these genes encodes multiple polypeptides, initially expressed as one precursor polyprotein. The gag gene encodes the internal structural (matrix capsid and nucleocapsid) polypeptides. The pol gene encodes the RNA-directed DNA polymerase (reverse transcriptase, integrase and protease). The env gene encodes viral envelope glycoproteins and additionally contains a cis-acting element (RRE) responsible for nuclear export of viral RNA.

The 5′ and 3′ LTRs serve to promote transcription and polyadenylation of the virion RNAs and contains all other cis-acting sequences necessary for viral replication. Adjacent to the 5′ LTR are sequences necessary for reverse transcription of the genome (the tRNA primer binding site) and for efficient encapsidation of viral RNA into particles (the Psi site). If the sequences necessary for encapsidation (or packaging of retroviral RNA into infectious virions) are missing from the viral genome, the result is a cis defect which prevents encapsidation of genomic RNA. However, the resulting mutant is still capable of directing the synthesis of all virion proteins. A comprehensive review of lentiviruses, such as HIV, is provided, for example, in Field's Virology (Raven Publishers), eds. B. N. Fields et al., 1996.

This invention is further illustrated by the following example, which should not be construed as limiting. The contents of all references, patents and published patent applications cited throughout this application are hereby incorporated by reference. Additionally, all nucleotide and amino acid sequences deposited in public databases referred to herein are also hereby incorporated by reference.

A nucleic acid molecule comprising a mouse T-bet cDNA cloned into the EcoRI site of the pJG4-5 vector was deposited with the American Type Culture Collection (Manassas, Va.) on Nov. 9, 1999 and assigned Deposit Number PTA-930. A nucleic acid molecule comprising a human T-bet cDNA (prepared from RNA from the human Th1 clone ROT-10) cloned into the PCR 2.1-TOPO vector was deposited with the American Type Culture Collection (Manassas, Va.) on Jan. 28, 2000 and assigned Deposit Number PTA-1339. Both deposits were made under the provisions of the Budapest Treaty.

### EXAMPLES

### Example 1

### Cloning of a Novel Transcription Factor, T-Bet

Since the Th1-specific region of the IL-2 promoter had been well localized (Brombacher, F., et al. 1994. Int. Immunol. 6:189-197; Rooney, J., et al. 1995. Mol. Cell. Biol. 15, 6299-6310; Lederer, J. A., et al. 1994. J. Immunol. 152, 77-86; Durand, D., et al. 1988. Mol. Cell. Biol. 8, 1715-1724; Hoyos, B., et al. 1989. Science 244, 457-450), a yeast one hybrid approach using an IL-2 promoter-reporter and a cDNA library made from the OF6 Th1 clone was chosen to identify Th1 specific transcription factors. To validate this approach, the Th2-specific region of the IL-4 promoter was expressed in yeast and demonstrated to be transactivated by the introduction of c-Maf, but not by several other transcription factors (e.g. NFAT). C-Maf transactivation did not occur when the c-Maf response element (MARE) was mutated. Thus, the yeast one hybrid approach was utilized.

The EGY48 yeast strain was stably integrated with the IL-2 promoter/histidine construct and transformed with a cDNA library made from an anti-CD3 activated Th1 cell clone, OF6. Of 5.6×10⁶ clones screened, 488 were positive in primary screening. Of the 210 clones tested during the secondary screen, 72 proved to be specific for the IL-2 promoter. To reduce the number of positive clones, we hybridized the yeast clone cDNA with cDNAs that were differentially expressed in Th1 and Th2 cell lines. These Th1-Th2 and Th2-Th1 cDNAs were made using the Clontech PCR select kit, radiolabeled and initially used in a pilot experiment to screen the 16 most strongly positive yeast clones. Of those 16 clones, 8 were positive with the Th1 (PL17) specific cDNA product probe and not with the Th2 (D10) specific cDNA product probe. Representational difference analysis (RDA; e.g., Lisitsyn. 1993. Science. 259:946; O'Neill and Sinclair. 1997. Nucleic Acids Res. 25:2681; Hubank and Schatz. 1994. Nucleic Acids Research. 22:5640; Welford et al. 1998. Nucleic Acids Research. 26:3059) with Th1-Th2 probe on 16 positive clones with control hybridization of the probe to IL-2, IFN-γ and IL-4 was performed. The specificity of the Th1 and Th2 -subtracted cDNA probes is demonstrated by their detection of IL-2 and IFN-γ versus IL-4 respectively.

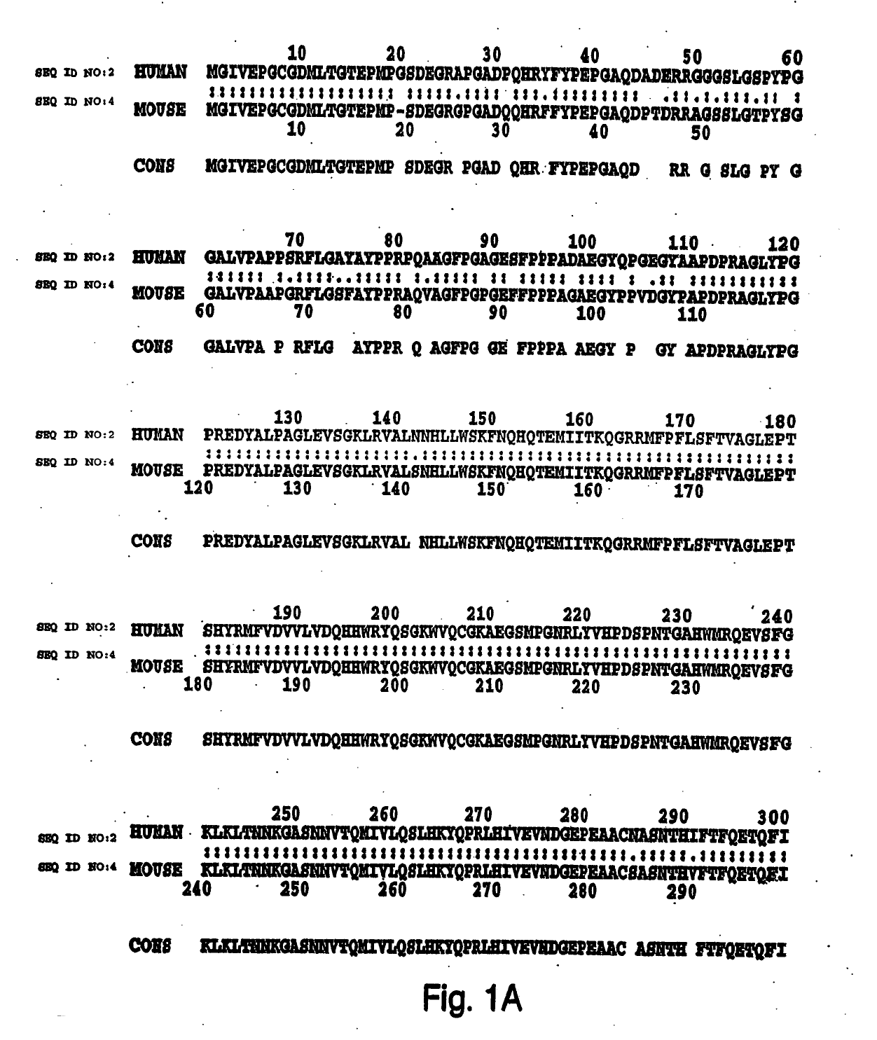

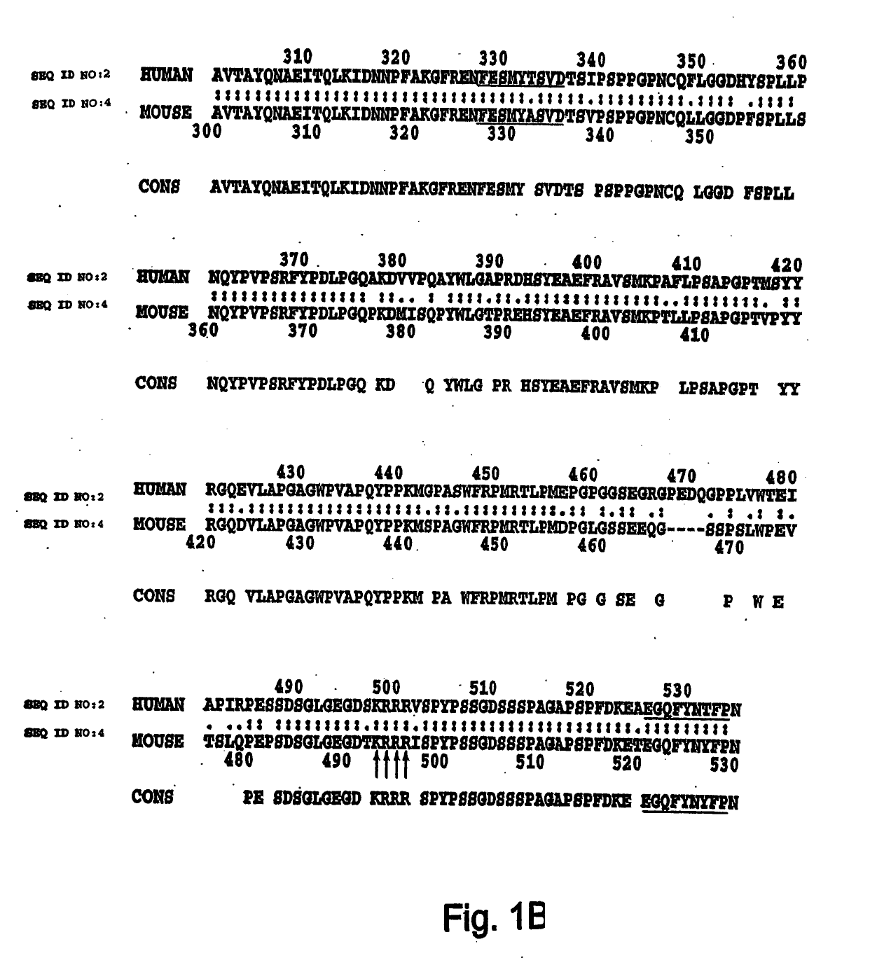

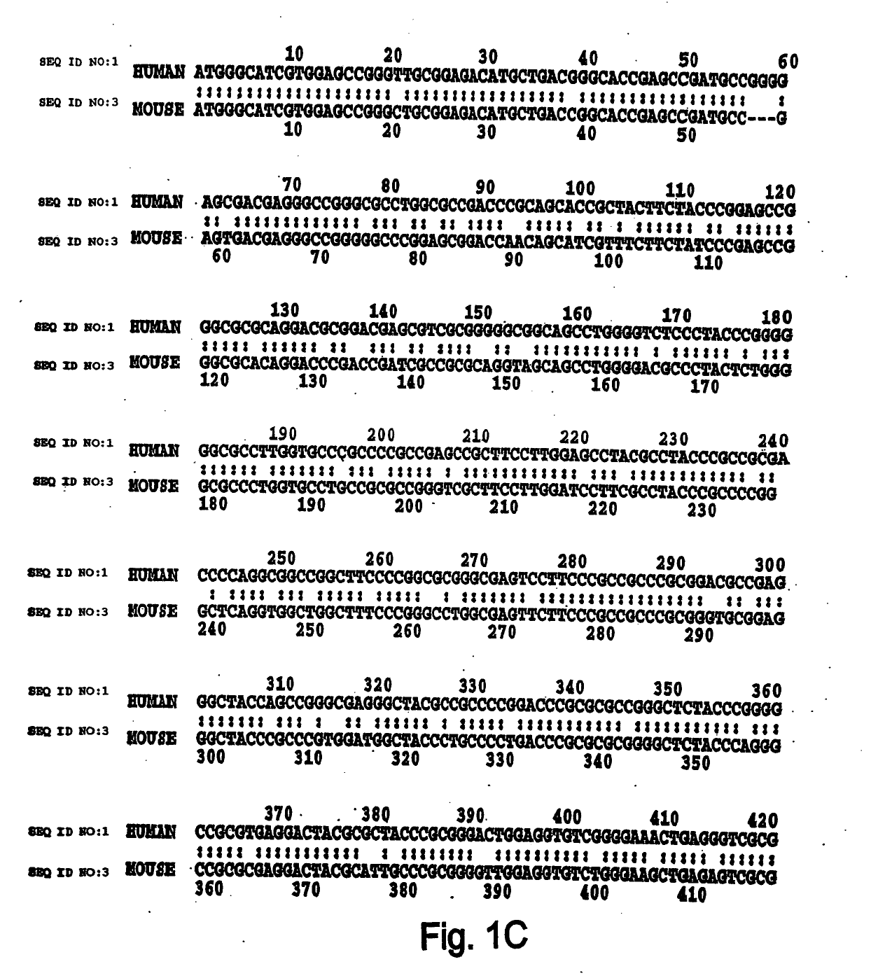

Restriction enzyme analyses and sequencing data revealed that all 8 of the clones were related. They fell into three groupings based on differences in the 5′ and 3′ untranslated regions, each of these categories representing an independent cDNA molecule. Comparing the sequence of these clones with the NCBI GenBank Sequence Database yielded homology with the T-box family of transcription factors. FIG. 1 shown the nucleotide and amino acid sequences of T-bet.

### Example 2

### T-Bet Shares a Region of Homology with the T-Box Family Members T-Brain and Eomesodermin

Brachyury or T is the founding member of a family of transcription factors that share a 200 amino acid DNA-binding domain called the T-box (reviewed in (Smith, J. 1997. Current Opinion in Genetics & Development 7, 474-480; Papaioannou, and Silver. 1998. Bioessay. 20:9; Meisler, M. H. 1997. Mammalian Genome 8, 799-800). The Brachyury (Greek for ‘short tail’) mutation was first described in 1927 in heterozygous mutant animals who had a short, slightly kinked tail (Herrmann, B. G., 1990. Nature 343, 617-622). There are now eight T-box genes in the mouse not including Brachyury. These include Tbx1-6, T-brain-1 (Tbr-1) and now, T-bet, each with a distinct and usually complex expression pattern. The T-box family of transcription factors is defined by homology of family members in the DNA binding domain. The T-bet DNA binding domain (residues 138-327 of murine T-bet) is most similar to the T-box domains of murine T-brain and Xenopus eomesodermin and thus places T-bet in the Tbr1 subfamily of the T-box gene family. The human homologue of the murine T-bet protein is approximately 88% identical to the mouse T-bet. FIG. 1A was derived using a Lipman-Pearson protein alignment (with G penalty set at 4 and gap length penalty set at 12. The similarity index was calculated to be 86.6; the gap number2, the gap length5, and the consensus length 535). T-bet shares a region of homology with the T-box family members T-brain and eomesodermin. The murine T-bet DNA binding domain is most similar to the T-box domains of murine T-brain and Xenopus eomesodermin. There is approximately 69% amino acid identity between the three T-box regions. T-bet bears no sequence homology to other T-box family members outside of the T-box domain.

### Example 3

### Phosphorylation of T-Bet by Tec Kinases

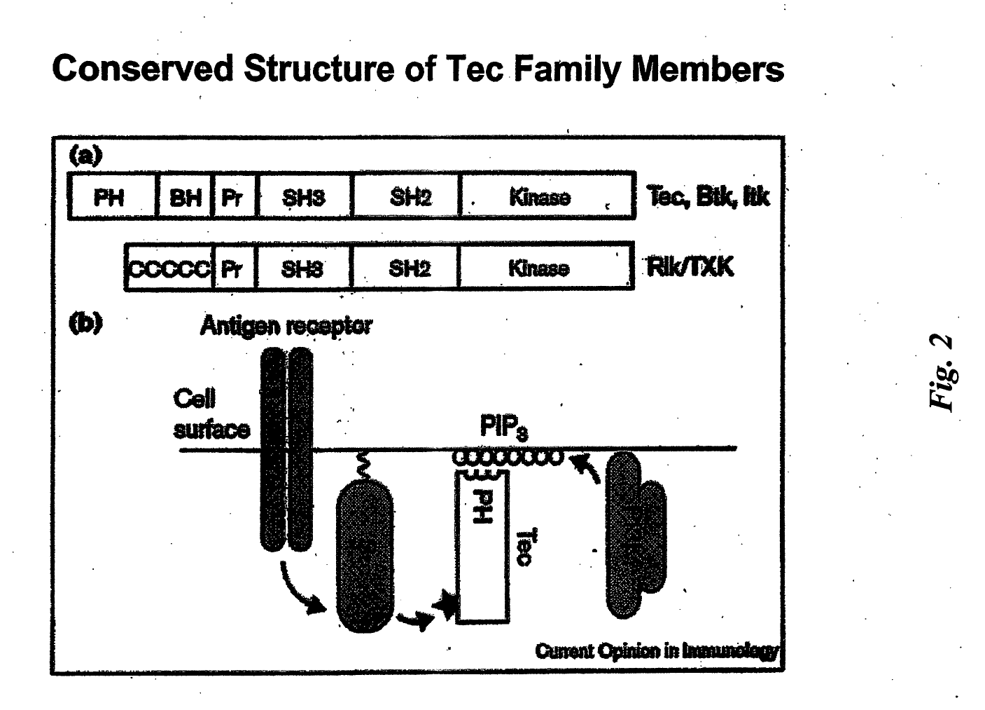

The T-bet protein is phosphorylated. The kinase which phosphorylates T-bet has been identified as a member of the Tec family of tyrosine kinases. ITK and Rlk/Txk are the predominant Tec family of tyrosine kinases expressed in T cells. FIG. 2 shows the conserved structure of Tec family members. The Tec family kinases have been shown to be important in cytokine secretion. Rlk/itk is Thy specific and plays a role in the control of IFN-γ production. Itk−/− mice have reduced IL-4 production while rlk/itk−/− mice demonstrated reduced Th1 and Th2 cytokines. RIBP is an adapter protein that binds rlk and itk. RIBP−/− mice exhibit reduced IFN-γ and IL-2.

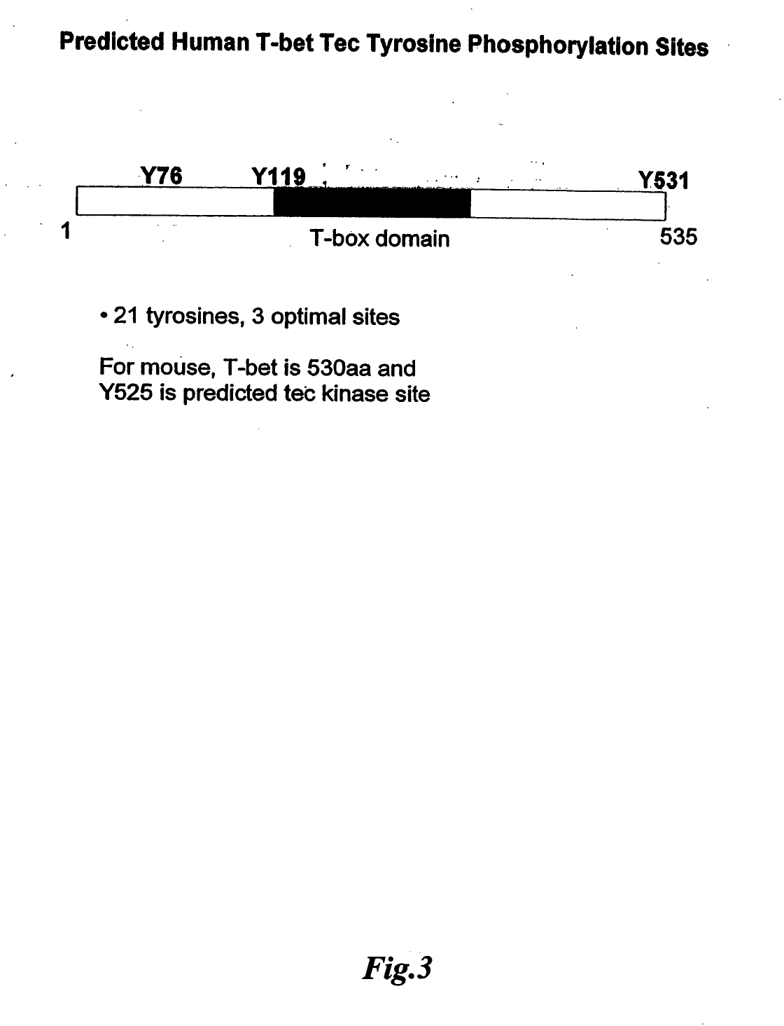

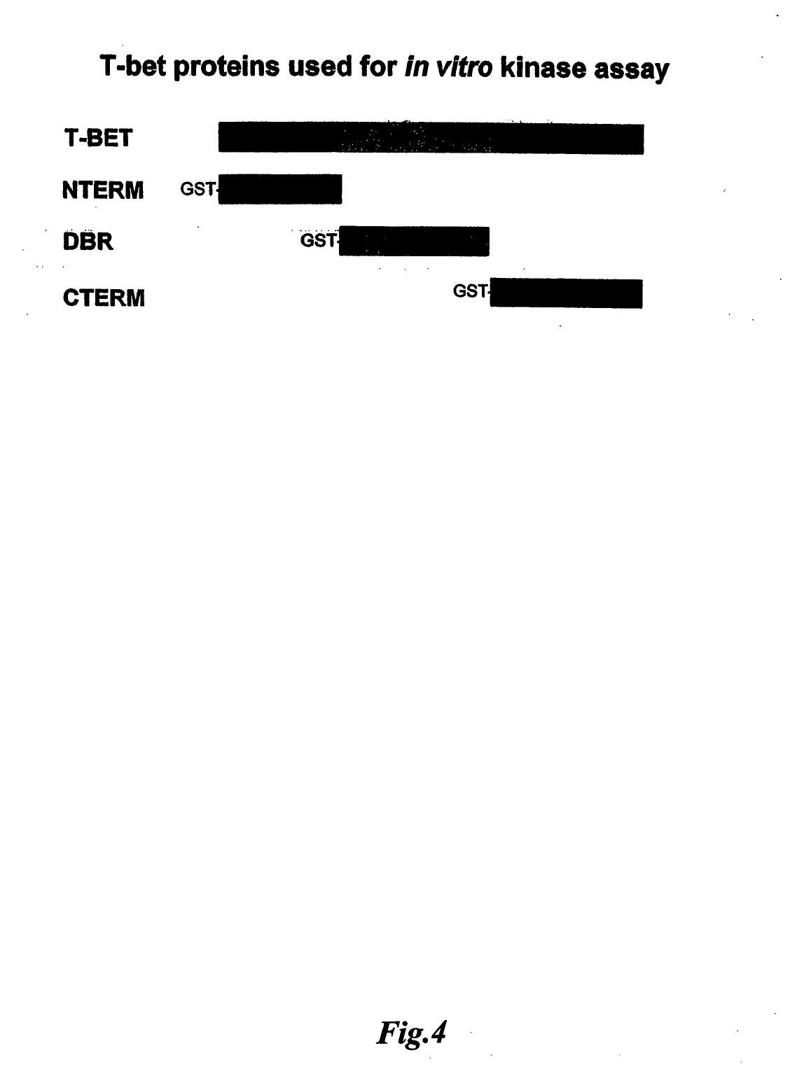

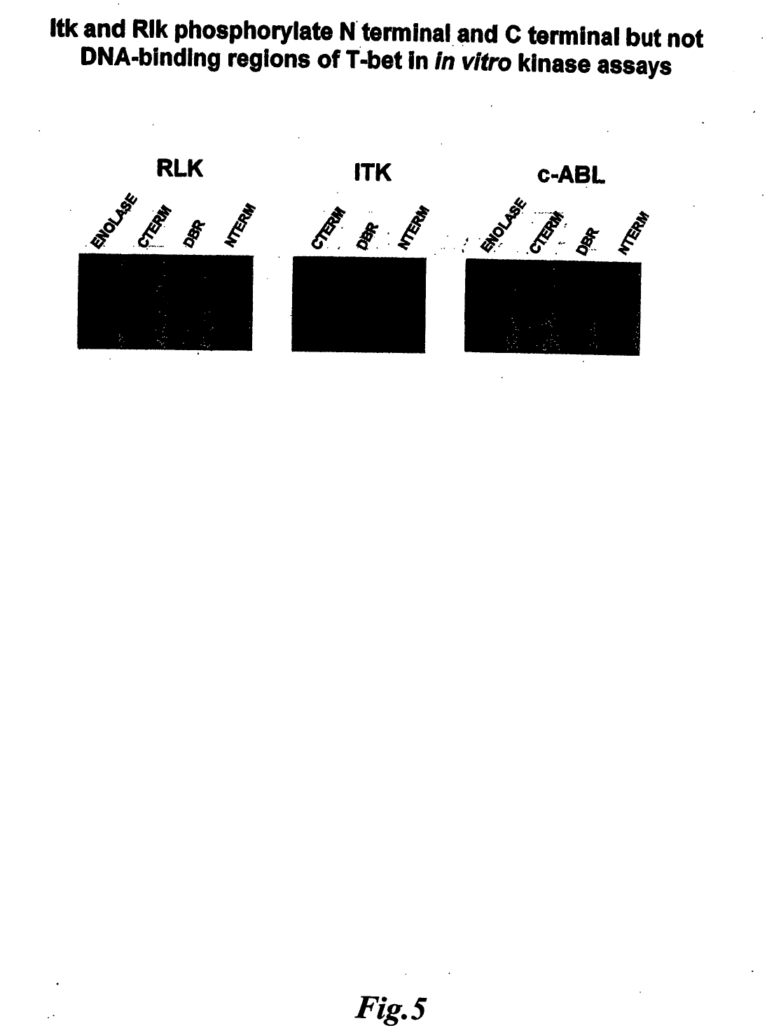

Both the ITK and Rlk/txk kinases have been found to phosphorylate T-bet in vitro. The predicted tyrosine phosphorylation sites of human T-bet are shown in FIG. 3. Modified forms of the T-bet protein were made and used as substrates in in vitro kinase assays (FIG. 4). Both ITK and Rlk phosphorylated N-terminal and C-terminal but not DNA-binding regions of T-bet in in vitro kinase assays (FIG. 5).

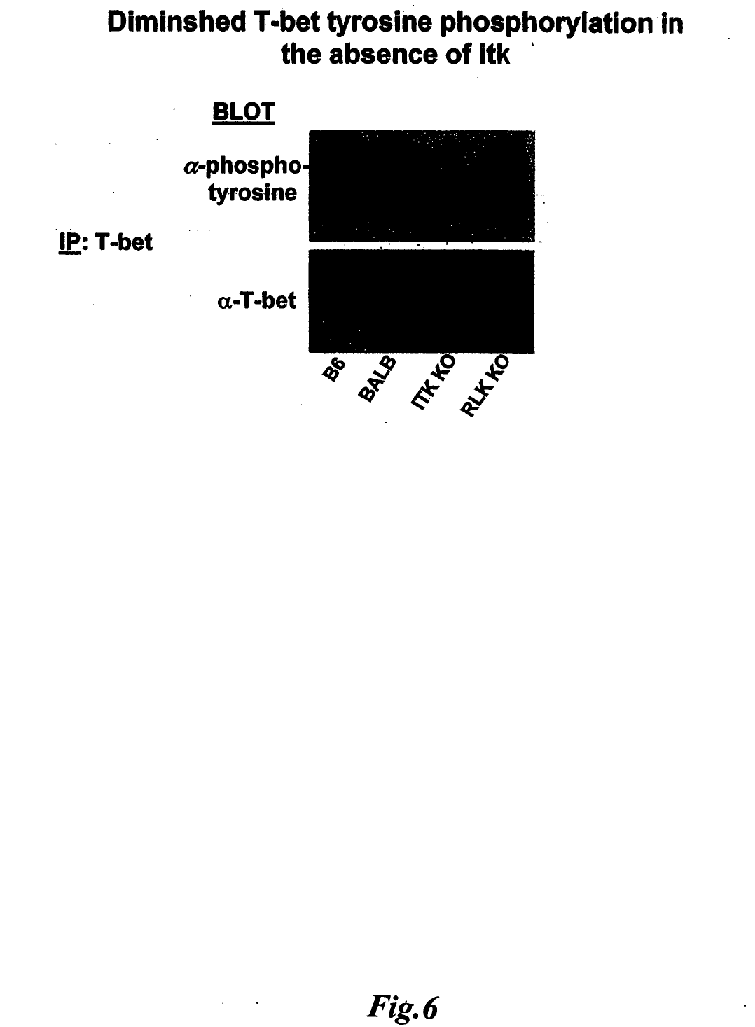

Further indicating the importance of Tec kinases, diminished tyrosine phosphorylation of T-bet has been observed in ITK knock-out animals. T-bet was immunoprecipitated from T cells from B6, Balb/C, ITK knock out and RLK knock out animals. Western blots of the immunoprecipitates were probed with either anti-phosphotyrosine antibodies or anti-T-bet antibodies. As shown in FIG. 6 although T-bet is present in T cells from ITK knock out animals, tyrosine phosphorylation of the molecule is reduced. In contrast, T-bet was hyperphosphorylated in Rlk knockout T cells indicating a role for Rlk in inhibiting T-bet tyrosine phosphorylation.

### Example 4

### T-Bet is Tyrosine Phosphorylated

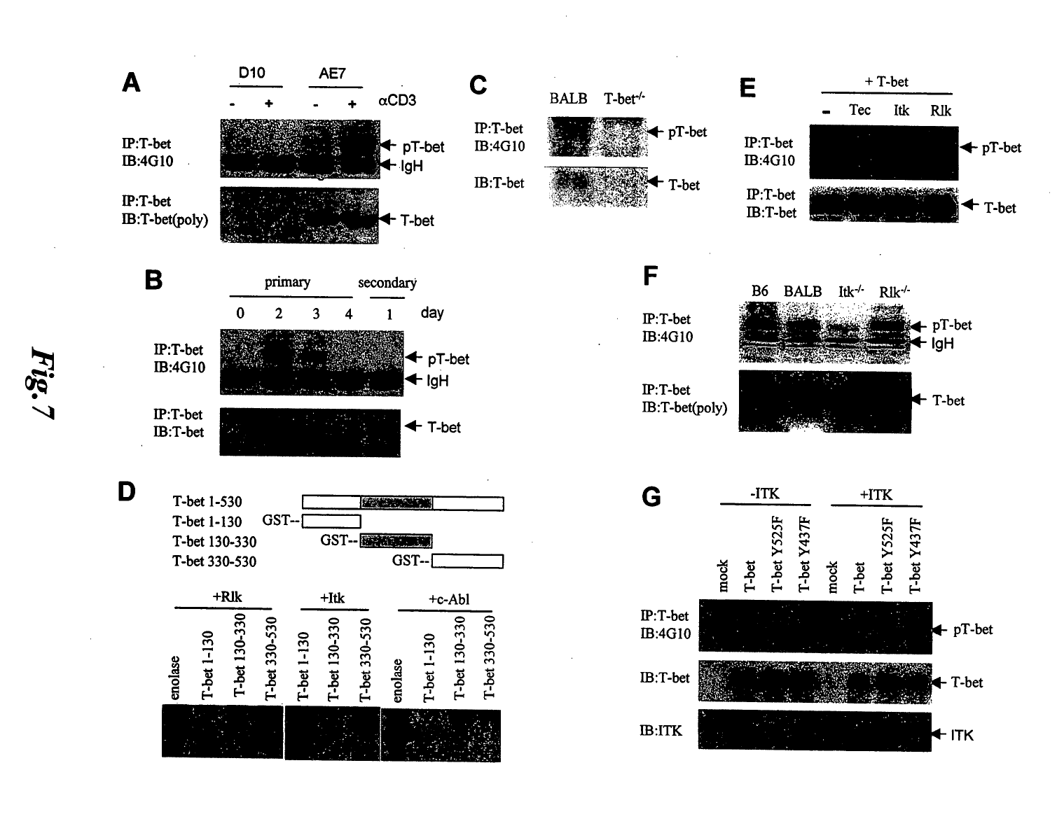

Posttranslational modification of transcription factors by phosphorylation, ubiquitination or methylation may lead to their activation and is often initiated by signaling from surface receptors. Reversible phosphorylation of tyrosines regulates many fundamental physiological processes, such as cell cycle control, growth and differentiation, and gene transcription (Chernoff, J. (1999) J. Cell Physiol 180:173-81; Hunter, T. (1998) Harvey Lect 94:81-119). In T cells, stimulation through the TCR results in tyrosine phosphorylation of cellular proteins leading to activation. T-bet is positioned downstream of the TCR, and therefore it was determined whether TCR engagement resulted in modification of T-bet protein. Whole cell lysates from the AE7 Th1 clone or control D10 Th2 clone clones maintained in RPMI-1640 with recombinant human IL-2 (200U/ml) were stimulated with (+) or without (−) anti-CD3 (1 μg/ml) overnight and treated with pervanadate for 15 min before total lysates were prepared. Total lysates were immunoprecipitated with monoclonal anti-T-bet antibody (4B10) and immune complexes resolved in 7.5% Tris-glycine gel. These complexes were separated by SDS-PAGE, transferred to nitrocellulose, and probed with an anti-phosphotyrosine mAb 4G10 (Upstate USA, Inc., Charlottesville) and assayed by chemiluminescence (Amersham Biosciences, Piscataway). Following exposure, blots were stripped and reprobed with anti-T-bet antisera. Inspection of the blot revealed specific phosphorylated immunoreactive species in AE7 cells, not present in D10 cells, which were induced by anti-CD3 treatment (FIG. 7A).

T-bet is rapidly induced in early Th1 differentiation and gradually decreases in later stages (FIG. 7B, lower panel). The timing of T-bet tyrosine phosphorylation in differentiating Th cells was examined. CD4+ Thp cells were isolated from lymph node and spleen and stimulated with plate bound anti-CD3 (2 μg/ml), anti-CD28 (1 μg/ml), and IL-2 (100 U/ml) in the presence of IL-12 (1 ng/ml) and anti-IL-4 (10 μg/ml). Total cell extracts were prepared on day 0, 2, 3, 4 after primary stimulation and on day 1 after secondary stimulation. Pervanadate (100 mM) was added 15 minutes prior to lysis of cells. Tyrosine phosphorylation of T-bet occurred in primary Thp cells upon TCR engagement, and was most pronounced early in differentiation (day 2), declining by day 4 and not detectable upon secondary stimulation (FIG. 37B). As reported, tyrosine phosphorylation was enhanced in the presence of pervanadate, but was also clearly detected in primary Th cells stimulated in vitro for 48 h with anti-CD3/CD28 in the absence of pervanadate (FIG. 7C). Total cell lysates from CD4+ Thp cells stimulated with anti-CD3/anti-CD28 for 48 h and prepared as described for 7B. Therefore, T-bet is tyrosine phosphorylated early in Thp differentiation, consistent with a role for this modification in the Th progenitor cell, the stage of differentiation where lineage commitment is determined.

The TCR initiates signal transduction cascades by interacting with and activating at least three cytoplasmic PTKs, Lck, Fyn and ZAP-70 (Alberola-Ila, J., et al. (1997) Ann. Rev. Immunol. 15:125-154) whose combined actions result in tyrosine phosphorylation of downstream cellular substrates such as IL-2 inducible T cell tyrosine kinase (ITK), phospholipase-Cy1, the Vav protooncogene, and the adaptor protein SLP-76 (Iwashima, M., et al. (1994) Science 263, 1136-1139; Chan A. C., et al. (1992) Cell 71, 649-62; Cooke, M. P., et al. (1991) Cell 65, 281-291; Wu, J., et al. (2002) J. Cell Sci 115, 3039-48). Western blot analysis of nuclear and cytoplasmic fractions of anti-CD3-stimulated Th1 cells revealed that T-bet was constitutively nuclear. Thus the tyrosine kinase responsible for T-bet phosphorylation must be one of the very few nuclear tyrosine kinases identified in T cells. These include the c-Abl kinase and members of the Tec kinase family, ITK, resting lymphocyte kinase (RLK) and TEC (Takesone, A., et al. (2002) J Cell Sci 115, 3039-48; Lucas, J. A., et al. (2003) Immunol Rev 191, 119-38). The scansite program, designed to identify residues within proteins that are likely to be phosphorylated by specific protein kinases (Yaffe, M. B. et al. (2001) Nat Biotechnol 19, 348-53), predicted an ITK phosphorylation site at the C-terminus of T-bet (Y525), a motif conserved between both human and mouse T-bet, as well as three conserved c-Abl sites (Y76, Y107, and Y117). In vitro kinase assays were performed by incubating truncated GST-fusion T-bet proteins and PTKs and c-Abl, followed by immunoprecipitation with anti-PTKs or c-Abl Abs, and 10 μCi of (γ-³²P)ATP (6000 Ci/mM). Enolase was used as a positive control exogenous substrate. Reaction mixtures were resolved by SDS-PAGE, and the resulting gels dried, and subjected to autoradiography. These in vitro kinase assays, performed initially to verify that T-bet could serve as a substrate for these kinases, revealed that T-bet, both the N and C terminal fragments but not the DNA binding domain, could be phosphorylated by the Tec kinases, ITK and RLK, but not by c-Abl (FIG. 7D). However, coexpression of PTKs and T-bet in 293T cells, a more reliable readout than in vitro kinase assays, revealed more efficient phosphorylation of T-bet by ITK than by TEC or RLK (FIG. 7E). This was determined by cotransfection of T-bet with Tec kinases, TEC, ITK or RLK in 293T cells and total cell lysates were prepared post incubation with pervanadate for 15 min.

More definitive proof that ITK was the relevant kinase came from the analysis of primary CD4 T cells isolated from ITK or RLK or double ITK/RLK deficient mice (Schaeffer, E. M., et al. (2001) Nat. Immunol. 2, 1183-1188). CD4+ T cells isolated from the lymph nodes of the kinase deficient mice were stimulated by combined anti-CD3/anti-CD28 treatment under Th1-skewing condition for 2 days. T-bet was isolated by immunoprecipitation and tyrosine phosphorylation status assessed by Western blotting with 4G10. T-bet tyrosine phosphorylation was greatly diminished in cells lacking ITK or both ITK and RLK but normal in the absence of RLK alone (FIG. 7F). These data show that ITK is an upstream tyrosine kinase of T-bet in primary T cells. Nonetheless, a small amount of residual phosphorylation of T-bet is observed in Itk−/− CD4 cells. This may reflect phosphorylation by other Tec kinases or other tyrosine kinases. To determine whether phosphorylation by ITK was specific for tyrosine residue 525 within T-bet as predicted by scansite, tyrosine residue 525 as well as a control tyrosine residue 437 were mutated to phenylalanine, and the ability of these mutants to be phosphorylated by ITK was assessed. While expression as detected by Western blot using total cell lysates of wild-type (wt) or mutant T-bet alone in 293T cells did not result in detectable tyrosine phosphorylation, coexpression of ITK resulted in phosphorylation of wt T-bet and markedly diminished phosphorylation of the Y525F mutant. Furthermore, phosphorylation of the control mutant Y437F by ITK was not reduced (FIG. 7G). Therefore, ITK phosphorylates T-bet at residue Y525.

### Example 5

### Tyrosine Phosphorylation of T-Bet is Required for the Optimal Repression of Th2 Cytokine Production

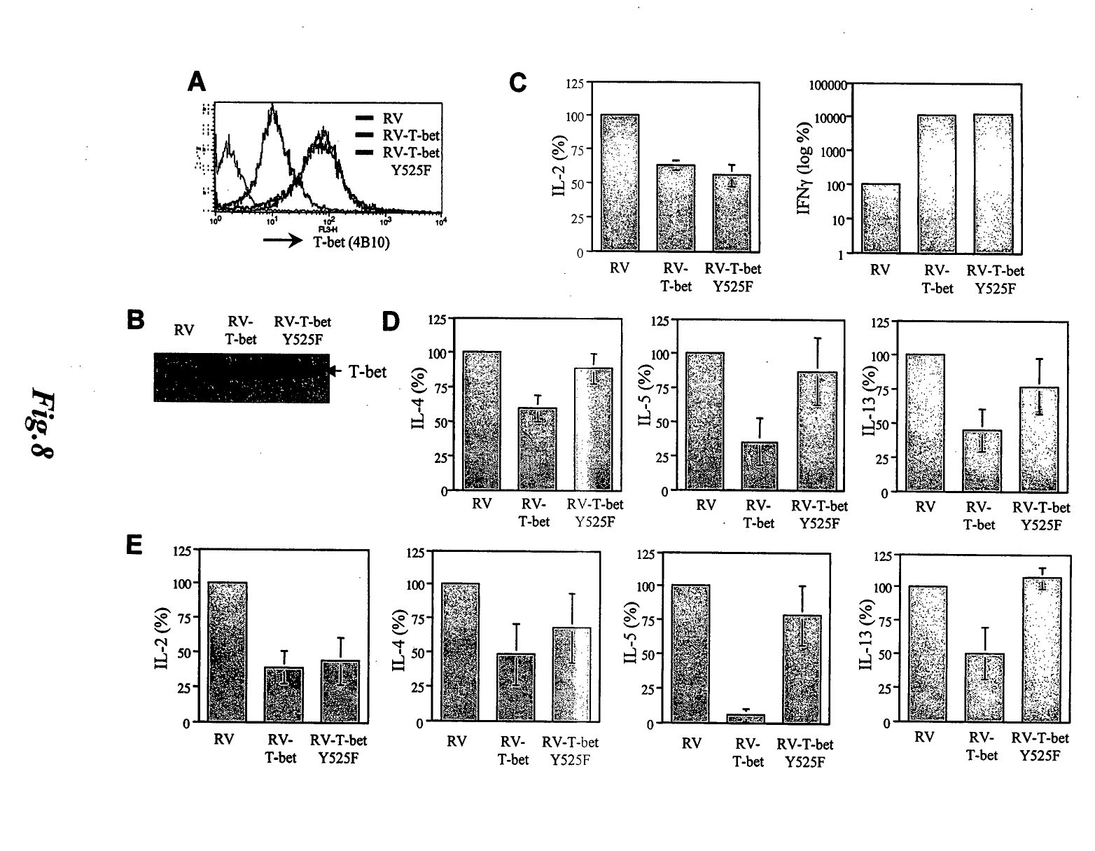

The activity of some transcription factors is controlled by cellular localization, which in turn is regulated by phosphorylation (NFAT, Stats) (Wen, Z., et al. (1995) Cell 82, 241-250; Winslow, M. M., et al. (2003) Curr Opin Immunol 15, 299-307). However, subcellular localization of T-bet is not affected by tyrosine phosphorylation, as endogenous T-bet remains in the nucleus in Itk^{-/-} cells and the Y525F mutant was constitutively nuclear. To assess the function of ITK-induced T-bet phosphorylation, T-bet wt (RV-T-bet) and Y525F (RV-T-bet Y525F) mutant GFP retroviruses were transduced between 24-36 hours into CD4⁺ T-bet^{-/-} Thp cells stimulated with anti-CD3 and anti-CD28 and cultured under Th2 skewing conditions. GFP positive cells were sorted at day 5, expanded for an additional 2 days in the presence of IL-2, restimulated with anti-CD3 and 24 hours later, cytokine production assessed by ELISA. Expression of wt and mutant T-bet was measured by FACS (FIG. 8A) and by Western blot analysis using anti-T-bet mAb, 4B10 (FIG. 8B), revealing equivalent expression of wt and Y525F T-bet in transduced cells. The percentage of sorted cells expressing GFP was over 98%. As expected, T-bet^{-/-} Thp cells transduced with wt T-bet had restored T-bet function in T-bet^{-/-} Th cells, as evidenced by repression of IL-2 production and by induction of IFNγ production by 100-fold compared with control RV vector transduced cells (FIG. 8C). Y525F T-bet was equally effective in repressing IL-2 and inducing IFNγ production as well as wt T-bet. Strikingly, however, while wt T-bet exhibited a significant repression of Th2 cytokine production (FIG. 8D), Y525F T-bet was much less effective than wt T-bet in repressing expression of Th2 cytokines, such as IL-4, IL-5 and IL-13 (FIG. 8D). The repression of IL-4 production by wt T-bet in six independent experiments ranged from 29 to 56% with an average of 41%. In contrast the repression of IL-4 by the Y525F mutant ranged from 1 to 22% with an average of 11%, which was statistically significant at a P value of 0.0002. A similar difference was seen between wt and Y525F T-bet for IL-5 and IL-13. For IL-5, wt repression was 39 to 87% (average 63%) while mutant T-bet repressed −18 to 38% (average 11.5%), significant at a P value of 0.0074. For IL-13, wt repression in six experiments ranged from 34 to 71% (average 53%) while Y525F mutant repression ranged from 2 to 40% (average 22%), P value of 0.002. Intracellular cytokine analyses were consistent with the ELISA results and similar results were obtained in transduction experiments using TCR transgenic DO11.10/T-bet^{-/-} CD4+ T cells stimulated by peptide and APC.

Although the Y525F T-bet mutant appeared to be as effective as wt T-bet in restoring IFNγ production, it was formally possible that very small differences in IFNγ might influence the robustness of Th2 differentiation. Furthermore, to rule out an effect of IFNγ in inhibiting Th2 differentiation, these same experiments were performed in T-bet^{-/-}×IFNγ^{-/-} CD4+ Th cells and obtained the similar results (FIG. 8E; Results are expressed designated as percentage of RV control. Note the use of log scale for IFNγ production). Thus, the role of tyrosine phosphorylation of T-bet in repressing Th2 cytokines is independent of IFNγ. Cytokine transcripts were also measured after transduction with wt or Y525F mutant T-bet retroviruses and a similar impairment of the latter in repressing Th2 cytokine mRNA was observed. Therefore, the two major functions of T-bet are biochemically separable: phosphorylation of Y525 by ITK is selectively required for T-bet's repression of Th2 differentiation, but not for its function in the generation of the Th1 lineage differentiation as measured by cytokine profiles.

### Example 6

### T-Bet Physically Interacts with ITK

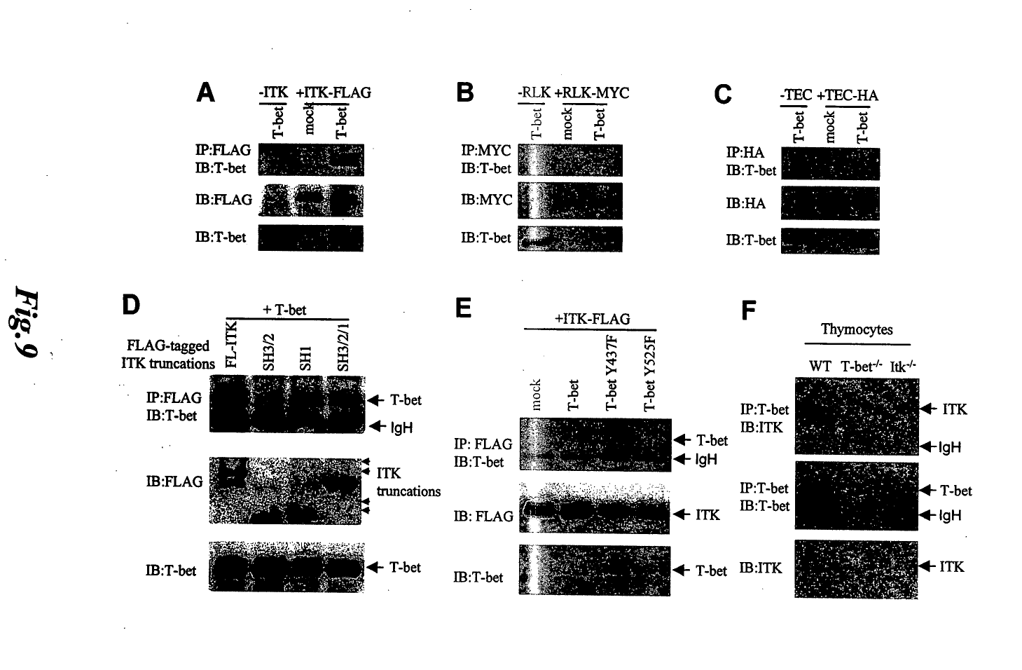

ITK is a modular 72 kDa protein containing Src homology (SH), SH2, SH3, kinase (SH1), Tec homology (TH) and pleckstrin homology (PH) domains (Lucas, J. A., et al. (2003) Immunol Rev 191, 119-38). Upon T cell activation, ITK associates with the adaptor proteins LAT and SLP76, is transphosphorylated by Lck, autophosphorylates and localizes to the cell membrane with the TCR via its PH domain (Bunnell, S. C., et al. (2000) J. Biol Chem 275, 2219-30; Su, Y. W., et al. (1999) Eur J Immunol 29, 3702-11). However, ITK also resides in the nucleus where T-bet is located. It was therefore determined whether ITK physically associated with T-bet. Coexpression of T-bet with epitope tagged Tec kinases (ITK-FLAG, RLK-MYC or TEC-HA) was followed by immunoprecipitation with anti-FLAG, MYC or HA antibodies, and immunocomplexes were resolved by 7.5% Tris-Glycine gel. The resulting protein blots were probed with anti-T-bet Ab. Expression of T-bet or TEC kinases were was assayed by Western blot using total cell lysates. The data revealed selective association of ITK with T-bet (FIG. 9A). Consistent with their inability to phosphorylate T-bet in similar assays, neither RLK, nor TEC, coimmunoprecipitated with T-bet (FIGS. 9B and 9C). Mapping studies using a series of ITK mutants revealed that the site of interaction with T-bet was the ITK SH1 domain. The FLAG-tagged ITK truncations were cotransfected with T-bet into 293T cells and immunoprecipitated with anti-FLAG Ab. The presence of T-bet in immune complexes was assayed with anti-T-bet Ab. The ITK truncations containing either the SH1 domain alone or SH1, SH2 and SH3 domains associated with T-bet as well as full length ITK, indicating that the PH and TH domains were not necessary, but that the SH1 domain was required for, the interaction with T-bet (FIG. 9D). Additionally, the ITK/T-bet interaction was largely dependent upon the presence of tyrosine 525 within T-bet, as shown by coexpression of FLAG-tagged ITK with wt or tyrosine mutants (Y525F or Y437F) of T-bet immunoprecipitated with FLAG-M2 agarose (Sigma, St. Louis) and subsequent probing of the resolved protein blot with anti-T-bet Ab. The results of these experiments, showed that ITK coimmunoprecipitated less well with the Y525F T-bet mutant (FIG. 9E). Similar expression levels of T-bet proteins and ITK were detected in 30 μg of total cell lysates.

Most important, it was determined whether ITK interacted with T-bet under physiological conditions, by determining endogenous association in primary thymocytes. Single cell suspensions were obtained from thymi of BALB/c wt, T-bet^{-/-} and ITK−/− mice and nuclear extracts were prepared with NE-PER (Pierce, Rockford) according to the manufacturer's instructions. Two mg of nuclear extracts were incubated with anti-T-bet mAb, 4B10, in 150 mM NaCl. Immune complexes were resolved and probed with anti-ITK mAb (2F12), and sequentially with 4B10 after stripping. ITK expression was assayed in 30 μg of nuclear extracts. Initial attempts to perform coimmunoprecipitation experiments in naïve Thp cells 24 and 48 hours after TCR stimulation failed, likely secondary to both the low levels of endogenous T-bet expressed at this early time point and the competing processes of phosphorylation and dephosphorylation occurring in activated cells. However, immunoprecipitation of T-bet from nuclear extracts of BALB/c wt, T-bet^{-/-} and Itk^{-/-} thymocytes followed by Western blotting with an anti-ITK antibody, revealed the presence of endogenous ITK in immune complexes from Balb/c wt but not T-bet^{-/-} or Itk^{-/-} thymocytes (FIG. 9F). The data show that the kinase domain of ITK interacts with T-bet in a tyrosine 525 dependent manner, resulting in T-bet phosphorylation and subsequent modulation of Th2 cytokine production.

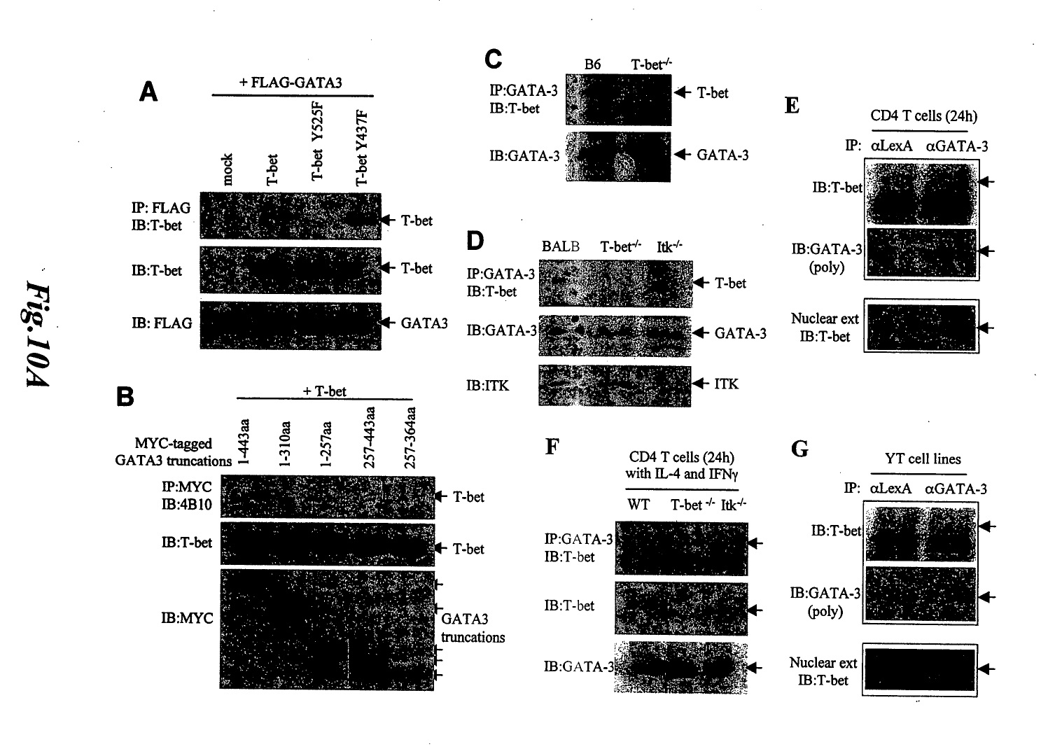

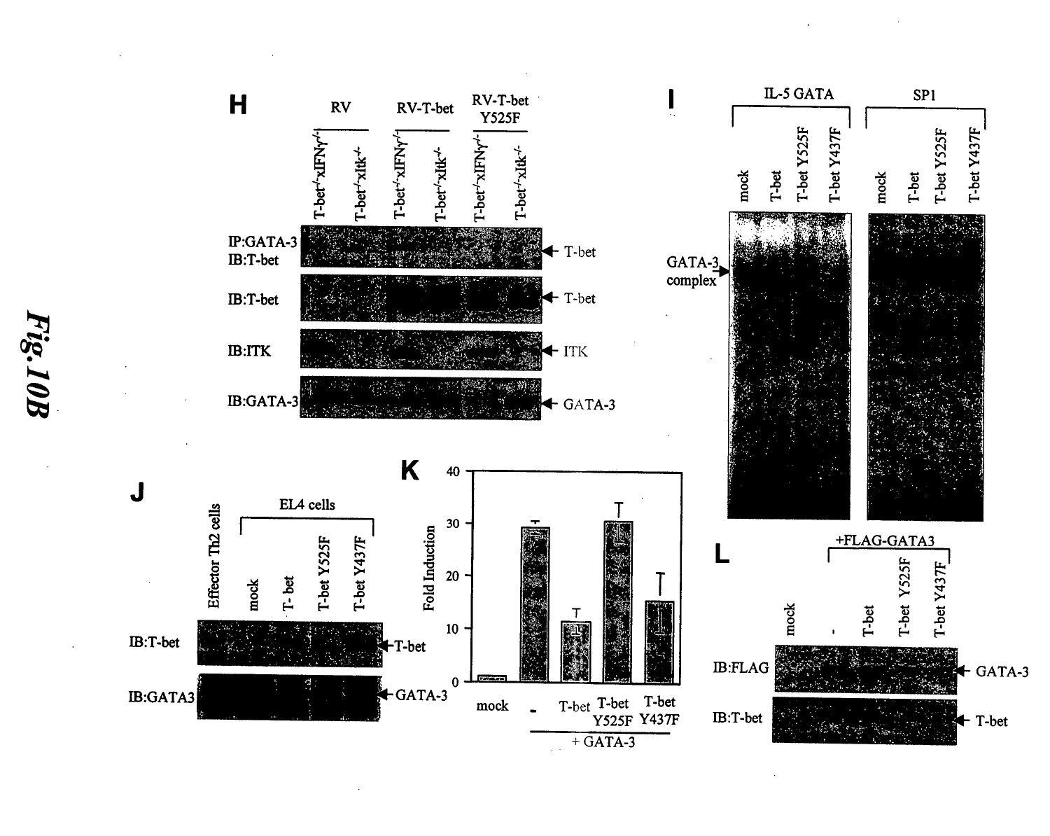

Without wishing to be bound by theory, one explanation for the above results was that T-bet directly or indirectly inhibits, in a manner dependent upon tyrosine 525, the expression of one or more of the transcription factors known to direct Th2 lineage commitment from the Thp. The more profound effect of T-bet Y525 on Th2 IL-5 and IL-13 as compared to IL-4 cytokine expression was reminiscent of the function of the Th2-specific transcription factor, GATA-3 (Zheng, W.-P. and R. A. Flavell (1997) Cell 89, 587-596; Das, J., et al. (2001) Nat. Immunol. 2, 45-50). However, no difference in mRNA expression levels of GATA-3, or of other Th2 relevant transcription factors, such as, c-Maf, JunB, Stat6, or NFATs were observed in Thp cells transduced with wt T-bet or the Y525F mutant, and T-bet did not repress the GATA-3 promoter in transient reporter assays. Another potential mechanism was that T-bet physically associated with a Th2 transcription factor, likely GATA-3, to control the latter's access to its target sites in the Th2 cytokine locus, and that this association was regulated by residue 525. A recent report describes the interaction of another GATA family member, GATA-4, with TBX5, a T-box protein responsible for a subset of syndromic cardiac septal defects (Garg, V., et al. (2003) Nature 424, 443-7). Initial experiments coexpressing FLAG-tagged GATA-3 and T-bet in 293T cells, followed by IP with anti-FLAG agarose and Western blot with anti-T-bet mAb, 4B10, of total cell lysates, revealed physical interaction of the two proteins but no detectable interaction of T-bet with c-Maf or NFATc2 (FIG. 10A). Interestingly, Y525F T-bet interacted with GATA-3 with lesser binding affinity compared with wt or Y437F T-bet did (FIG. 10A). Coexpression of T-bet and GATA-3 truncation mutants revealed that the N-terminal (257aa) domain of GATA-3 specifically interacted with T-bet (FIG. 10B). This was demonstrated by cotransfecting MYC-tagged GATA-3 truncations with T-bet and precipitating with MYC-AG conjugate (Santa Cruz Biotech, Inc., Santa Cruz). Protein blots were probed with anti-T-bet Ab. GATA-3 truncations were detected with anti-MYC mAb (9E10).

To directly test for endogenous T-bet/GATA-3 association, thymocytes, which express both T-bet and GATA-3 were examined. Nuclear extracts isolated from thymi of B6 wt and T-bet^{-/-} were incubated with anti-GATA-3 mAb, HG3-31, and subsequently with protein A/G agarose. Immune complexes were resolved, and probed with anti-T-bet Ab. GATA-3 expression was detected with anti-GATA-3 mAb. Immunoprecipitation of thymocyte lysates with anti-GATA-3 Ab followed by Western blot with anti-T-bet mAb revealed that the two proteins do associate in vivo in the wt, but not in T-bet^{-/-} thymus, a site where this interaction may also be physiologically meaningful (FIG. 10C). Notably, this association required the presence of ITK since it was not detected in Itk^{-/-} thymus (FIG. 10D, lane 3), (although T-bet and GATA-3 could interact in the absence of ITK in overexpression studies) showing that the association of T-bet and GATA-3 is facilitated by ITK.

The endogenous association of T-bet and GATA-3 was also examined. Naïve Thp cells were stimulated with anti-CD3 and anti-CD28 for 24 h and nuclear extracts were prepared for immunoprecipitation. LexA Ab was used as the isotype control for the GATA-3 Ab. Naïve Thp from BALB/C wt, T-bet^{-/-} and Itk^{-/-} mice were cultured for 24 h with anti-CD3 plus anti-CD28 and IL-2 in the presence of rIL-4 and rIFNγ and nuclear extracts prepared as above, and immunoprecipitation and immunoblot analyses was also performed as above. The results show that there is an endogenous association of T-bet and GATA3 in Thp cells treated in culture for 24 hours with anti-CD3/CD28 and rIL-2 alone (FIG. 10E), and in Thp treated with the above in the presence of IL-4 and IFNγ for 24 h to induce higher expression of T-bet and GATA-3 (FIG. 10F). Further, endogenous T-bet/GATA-3 association was detected in the human natural killer cell line YT which is known to express both proteins (FIG. 10G).

To further examine this Itk-mediated T-bet/GATA-3 interaction in Thp-derived cells, the reconstituted T-bet^{-/-} were introduced into Thp cells with wt or Y525F T-bet. In order to rule out the effect of IFNγ on GATA-3 expression and to examine whether the requirement for ITK is critical for the interaction, transduced wt and Y525F mutant T-bet into CD4+ Thp cells from T-bet^{-/-}×IFNγ^{-/-} and T-bet^{-/-}×Itk^{-/-} mice, respectively were isolated also. Transduced cells were stimulated with anti-CD3 and anti-CD28 under Th2-skewing conditions and lysates immunoprecipitated with GATA-3 ab followed by Western blotting with T-bet mAb. Comparable expression of GATA-3 in Th cells transduced with control, wt or Y525F T-bet retroviruses were observed. As we had observed in thymocytes, wt T-bet but not the Y525F mutant associated with GATA-3 and this interaction required ITK presence in Th cells (FIG. 10H).

If T-bet controls Th2 lineage commitment through its interaction with the Th2 factor GATA-3, then it likely does so by sequestering GATA-3 away from its binding sites in the Th2 cytokine locus. EL4 cells were transfected with wt, Y525F, or Y437F T-bet and nuclear extracts were incubated with radiolabeled GATA-3 binding sites from the IL-5 promoter, or with radiolabeled SP1 binding sites, resolved in native 6% polyacrylamide gel, and subjected to autoradiography. Indeed, these EMSA analyses revealed diminished binding of GATA-3 to a canonical GATA-3 target sequence and to the GATA-3 target sequence in the IL-5 promoter (FIG. 101). In contrast, expression of the T-bet Y525F mutant did not affect GATA-3/DNA complex formation (FIG. 101, left panel). Binding of these same extracts to a control SP1 probe was equivalent (FIG. 10I, right panel). The expression levels of wt, Y525F and Y437F T-bet were comparable and endogenous GATA-3 expression was not substantially affected by expressing wt, Y525F, or Y437F T-bet (FIG. 10J), demonstrating that the decreased amounts of GATA-3/DNA complexes were not due to decreased GATA-3 protein. Nuclear extracts from effector Th2 cells were used as a positive control for GATA-3 protein. Transient reporter gene assays, controlled for levels of GATA-3 and T-bet proteins (FIG. 10L) were performed by cotransfecting EL4 cells with an IL-5 promoter reporter gene with GATA-3 and T-bet cDNAs as well as a β-gal reporter gene and assaying relative luciferase activity standardized with β-galactosidase activity, shown as fold induction, demonstrated that T-bet, but not the Y525F T-bet repressed GATA-3 dependent IL-5 promoter activity, support this hypothesis (FIG. 10K) and are consistent with the failure of the T-bet Y525F mutant to repress Th2 cytokine production in primary Th cells.

The relationship of these data to previous reports describing the phenotype of mice lacking ITK is complex. ITK regulates TCR-induced intracellular Ca+ mobilization via its phosphorylation of phospholipase Cγ1 (Schaeffer, E. M., et al. (2000) J Exp Med 192, 987-1000; Schaeffer, E. M., et al. (1999) Science 284, 638-641). Mice lacking ITK have impaired T cell activation with reduced Ca++mobilization, PLC-γ and MAP kinase activation leading to impaired activation of NFAT and AP-1 transcription factors. Considerable work has implicated ITK and RLK in directing CD4+ T helper cell differentiation. However, integrating the various studies and model systems into a single unified model has been complex and controversial (Wen, Z., et al. (1995) Cell 82, 241-250; Schaeffer, E. M., et al. (1999) Science 284, 638-641; Fowell, D. J., et al. (1999) Immunity 11, 399-409). ITK deficient CD4+ T cells have been reported to have impaired Th2 differentiation capacity in vitro and in vivo as observed in their immune responses to L. Major, N. Strongyloides and in a model of asthma (Schaeffer, E. M., et al. (2001) Nat. Immunol. 2, 1183-1188; Fowell, D. J., et al. (1999) Immunity 11, 399-409; Mueller, C. and A. August (2003) J Immunol 170, 5056-63). Itk^{-/-} mice also fail to develop granulomas following S. mansoni infection (Schaeffer, E. M., et al. (2001) Nat. Immunol. 2, 1183-1188). Obviously these findings are inconsistent with a role for ITK in promoting T-bet mediated inhibition of a Th2 response. However, Itk^{-/-} mice do exhibit resting eosinophilia and elevated levels of IgE, suggesting enhanced Th2 development prior to a defined antigenic stimulus (Schaeffer, E. M., et al. (2001) Nat. Immunol. 2, 1183-1188) and Itk^{-/-} memory cells actually produce increased levels of Th2 cytokines. Furthermore, mice doubly deficient in both ITK and RLK form Th2 mediated granulomas comparable to wt and Rlk^{-/-} counterparts (Schaeffer, E. M., et al. (2001) Nat. Immunol. 2, 1183-1188). These latter observations could be explained by an absence of T-bet phosphorylation. Finally, in our own unpublished experiments using naïve Thp from Itk^{-/-} Balb/c mice stimulated with anti-CD3/CD28 in the presence of human IL-2, only modestly reduced levels of IL-4 have been observed and, in contrast to previous reports, increased rather than decreased levels of IL-5 and IL-13 compared to control wt Thp. It may be that the production of Th2 cytokines from non-T cells rather than from T cells contributes to the in vivo phenotype of Itk^{-/-} mice.

Without wishing to be bound by theory, these data may offer one mechanism by which strength of signal modulates T helper cell development, which has been suggested as a possible explanation for conflicting results from the analysis of mice deficient in Tec kinases (August, A. et al. (2002) Int J Biochem Cell Biol. 34, 1184-1189). Though predominantly cytosolic, ITK is found in the nucleus of resting T cells. This nuclear resident population may serve to keep basal Th2 activity in check, presumably through phosphorylation of T-bet. Once potent and sustained antigenic stimulation conditions arise, a multitude of factors, including those dependent on ITK, like PLCγ induced Ca²⁺ flux and NFAT activation, override T-bet repression and facilitate Th2 development.

Equivalents

Those skilled in the art will recognize, or be able to ascertain using no more than routine experimentation, many equivalents to the specific embodiments of the invention described herein. Such equivalents are intended to be encompassed by the following claims.

What is claimed is:

1. A method for identifying a compound which directly increases Th2 lineage commitment during T cell differentiation, comprising contacting in the presence of the compound, T-bet and a Tec kinase molecule under conditions which allow interaction of the kinase molecule with T-bet; and detecting the interaction of T-bet and the kinase molecule, wherein the ability of the compound to directly increase Th2 lineage commitment during T cell differentiation is indicated by a decrease in the interaction as compared to the amount of interaction in the absence of the compound.

2. The method of claim 1, wherein the interaction of T-bet and the kinase molecule is determined by measuring the formation of a complex between T-bet and the kinase.

3. The method of claim 1, wherein the interaction of T-bet and the kinase molecule is determined by measuring the phosphorylation of T-bet.

4. The method of claim 3, wherein the phosphorylation of T-bet is determined by measuring the phosphorylation of the tyrosine residue at amino acid position 525 (Y525) of T-bet.

5. The method of claim 1, wherein the kinase molecule is ITK.

6. A method of identifying compounds useful in directly increasing Th2 lineage commitment during T cell differentiation comprising,
a) providing an indicator composition comprising ITK, T-bet and GATA3;
b) contacting the indicator composition with each member of a library of test compounds;
c) selecting from the library of test compounds a compound of interest that decreases the ITK-mediated interaction of T-bet and GATA3 to thereby identify a compound that directly increases Th2 lineage commitment.

7. The method of claim 6, wherein the interaction is determined by measuring Th2 cytokine production by a T cell.

8. The method of claim 7, wherein the cytokine is selected from the group consisting of IL-4, IL-5, and IL-10.

9. The method of claim 6, wherein the ITK-mediated interaction of T-bet and GATA3 is determined by measuring the formation of a complex between T-bet and GATA3.

10. The method of claim 6, wherein the ITK-mediated interaction of T-bet and GATA3 is determined by measuring a decrease in GATA3 binding to DNA.

11. The method of claim 6, wherein the indicator composition is a cell that expresses a T-bet polypeptide.

12. The method of claim 11, wherein the cell is committed to a T cell lineage.

13. The method of claim 11, wherein the cell is not yet committed to a T cell lineage.

14. A method for identifying a compound which modulates the interaction of T-bet and GATA3 in a T cell, comprising contacting in the presence of the compound and ITK, T-bet and GATA3 under conditions which allow ITK-mediated binding of T-bet to GATA3 to form a complex; and detecting the formation of a complex of T-bet and GATA3 in which the ability of the compound to inhibit interaction between T-bet and GATA3 in the presence of ITK and the compound is indicated by a decrease in complex formation as compared to the amount of complex formed in the absence of ITK and the compound.

15. The method of claim 14, wherein the compound increases the formation or stability of the complex.

16. The method of claim 14, wherein the compound decreases the formation or stability of the complex.

17. A method of identifying compounds useful in directly increasing the production of at least one Th2 cytokine by a T cell, comprising,
a) providing an indicator composition comprising ITK, T-bet and GATA3;
b) contacting the indicator composition with each member of a library of test compounds;
c) selecting from the library of test compounds a compound of interest that decreases the ITK-mediated interaction of T-bet and GATA3 to thereby identify a compound that directly increases the production of at least one cytokine.

18. The method of claim 17, wherein the interaction of T-bet and GATA3 is determined by measuring the production of at least one cytokine.

19. The method of claim 17, wherein the interaction of T-bet and GATA3 is determined by measuring the production of more than one cytokine.

20. The method of claim 17, wherein the cell is selected from the group consisting of: a T cell, a B cell, and an NK cell.

21. A method of treating or preventing a disorder that would benefit from treatment with an agent that directly increases Th2 cytokine production by T cells, comprising administering to a subject with said disorder an agent that decreases the ITK-mediated binding of T-bet and GATA3 in T cells, such that the disorder is treated or prevented.

22. The method of claim 21, wherein the agent inhibits tyrosine phosphorylation of T-bet.

23. The method of claim 21, wherein the T cells are Thp cells.

24. A method of directly increasing Th2 cytokine production by a T cell, comprising contacting the cell with an agent that decreases the ITK-mediated binding of T-bet and GATA3 in the T cell, such that Th2 cytokine production by the T cell is directly increased.

25. The method of claim 24, wherein the agent inhibits tyrosine phosphorylation of T-bet.

26. The method of claim 24, wherein the T cells are Thp cells.

27. A method of directly increasing Th2 lineage commitment during T cell differentiation, comprising contacting the cell with an agent that decreases the ITK-mediated binding of T-bet and GATA3 in the T cell, such that Th2 lineage commitment during T cell differentiation is directly increased.

28. The method of claim 27, wherein the agent inhibits tyrosine phosphorylation of T-bet.

29. The method of claim 28, wherein the T cells are Thp cells.


SEQUENCE LISTING (21 sequences)

SEQ ID NO: 1 - DNA, 1608 bp, Homo sapiens
  CDS (1)..(1605)
atgggcatcgtggagccgggttgcggagacatgctgacgggcaccgagccgatgccggggagcgacgagggccgggcgcctggcgccgacccgcagcaccgctacttctacccggagccgggcgcgcaggacgcggacgagcgtcgcgggggcggcagcctggggtctccctacccggggggcgccttggtgcccgccccgccgagccgcttccttggagcctacgcctacccgccgcgaccccaggcggccggcttccccggcgcgggcgagtccttcccgccgcccgcggacgccgagggctaccagccgggcgagggctacgccgccccggacccgcgcgccgggctctacccggggccgcgtgaggactacgcgctacccgcgggactggaggtgtcggggaaactgagggtcgcgctcaacaaccacctgttgtggtccaagtttaatcagcaccagacagagatgatcatcaccaagcagggacggcggatgttcccattcctgtcatttactgtggccgggctggagcccaccagccactacaggatgtttgtggacgtggtcttggtggaccagcaccactggcggtaccagagcggcaagtgggtgcagtgtggaaaggccgagggcagcatgccaggaaaccgcctgtacgtccacccggactcccccaacacaggagcgcactggatgcgccaggaagtttcatttgggaaactaaagctcacaaacaacaagggggcgtccaacaatgtgacccagatgattgtgctccagtccctccataagtaccagccccggctgcatatcgttgaggtgaacgacggagagccagaggcagcctgcaacgcttccaacacgcatatctttactttccaagaaacccagttcattgccgtgactgcctaccagaatgccgagattactcagctgaaaattgataataacccctttgccaaaggattccgggagaactttgagtccatgtacacatctgttgacaccagcatcccctccccgcctggacccaactgtcaattccttgggggagatcactactctcctctcctacccaaccagtatcctgttcccagccgcttctaccccgaccttcctggccaggcgaaggatgtggttccccaggcttactggctgggggccccccgggaccacagctatgaggctgagtttcgagcagtcagcatgaagcctgcattcttgccctctgcccctgggcccaccatgtcctactaccgaggccaggaggtcctggcacctggagctggctggcctgtggcaccccagtaccctcccaagatgggcccggccagctggttccgccctatgcggactctgcccatggaacccggccctggaggctcagagggacggggaccagaggaccagggtccccccttggtgtggactgagattgcccccatccggccggaatccagtgattcaggactgggcgaaggagactctaagaggaggcgcgtgtccccctatccttccagtggtgacagctcctcccctgctggggccccttctccttttgataaggaagctgaaggacagttttataactattttcccaactga

SEQ ID NO: 2 - protein, 535 aa, Homo sapiens
MGIVEPGCGDMLTGTEPMPGSDEGRAPGADPQHRYFYPEPGAQDADERRGGGSLGSPYPGGALVPAPPSRFLGAYAYPPRPQAAGFPGAGESFPPPADAEGYQPGEGYAAPDPRAGLYPGPREDYALPAGLEVSGKLRVALNNHLLWSKFNQHQTEMIITKQGRRMFPFLSFTVAGLEPTSHYRMFVDVVLVDQHHWRYQSGKWVQCGKAEGSMPGNRLYVHPDSPNTGAHWMRQEVSFGKLKLTNNKGASNNVTQMIVLQSLHKYQPRLHIVEVNDGEPEAACNASNTHIFTFQETQFIAVTAYQNAEITQLKIDNNPFAKGFRENFESMYTSVDTSIPSPPGPNCQFLGGDHYSPLLPNQYPVPSRFYPDLPGQAKDVVPQAYWLGAPRDHSYEAEFRAVSMKPAFLPSAPGPTMSYYRGQEVLAPGAGWPVAPQYPPKMGPASWFRPMRTLPMEPGPGGSEGRGPEDQGPPLVWTEIAPIRPESSDSGLGEGDSKRRRVSPYPSSGDSSSPAGAPSPFDKEAEGQFYNYFPN

SEQ ID NO: 3 - DNA, 1593 bp, Mus musculus
  CDS (1)..(1590)
atgggcatcgtggagccgggctgcggagacatgctgaccggcaccgagccgatgccgagtgacgagggccgggggcccggagcggaccaacagcatcgtttcttctatcccgagccgggcgcacaggacccgaccgatcgccgcgcaggtagcagcctggggacgccctactctgggggcgccctggtgcctgccgcgccgggtcgcttccttggatccttcgcctacccgccccgggctcaggtggctggctttcccgggcctggcgagttcttcccgccgcccgcgggtgcggagggctacccgcccgtggatggctaccctgcccctgacccgcgcgcggggctctacccagggccgcgcgaggactacgcattgcccgcggggttggaggtgtctgggaagctgagagtcgcgctcagcaaccacctgttgtggtccaagttcaaccagcaccagacagagatgatcatcactaagcaaggacggcgaatgttcccattcctgtccttcaccgtggccgggctggagcccacaagccattacaggatgtttgtggatgtggtcttggtggaccagcaccactggcggtaccagagcggcaagtgggtgcagtgtggaaaggcagaaggcagcatgccagggaaccgcttatatgtccacccagactcccccaacaccggagcccactggatgcgccaggaagtttcatttgggaagctaaagctcaccaacaacaagggggcttccaacaatgtgacccagatgatcgtcctgcagtctctccacaagtaccagccccggctgcacatcgtggaggtgaatgatggagagccagaggctgcctgcagtgcttctaacacacacgtctttactttccaagagacccagttcattgcagtgactgcctaccagaacgcagagatcactcagctgaaaatcgacaacaacccctttgccaaaggattccgggagaactttgagtccatgtacgcatctgttgatacgagtgtcccctcgccacctggacccaactgtcaactgcttgggggagaccccttctcacctcttctatccaaccagtatcctgttcccagccgtttctaccccgaccttccaggccagcccaaggatatgatctcacagccttactggctggggacacctcgggaacacagttatgaagcggagttccgagctgtgagcatgaagcccacactcctaccctctgccccggggcccactgtgccctactaccggggccaagacgtcctggcgcctggagctggttggcccgtggcccctcaatacccgcccaagatgagcccagctggctggttccggcccatgcgaactctgcccatggacccgggcctgggatcctcagaggaacagggctcctccccctcgctgtggcctgaggtcacctccctccagccggagcccagcgactcaggactaggcgaaggagacactaagaggaggaggatatccccctatccttccagtggcgacagctcctctcccgctggggccccttctccttttgataaggaaaccgaaggccagttttataattattttcccaactga

SEQ ID NO: 4 - protein, 530 aa, Mus musculus
MGIVEPGCGDMLTGTEPMPSDEGRGPGADQQHRFFYPEPGAQDPTDRRAGSSLGTPYSGGALVPAAPGRFLGSFAYPPRAQVAGFPGPGEFFPPPAGAEGYPPVDGYPAPDPRAGLYPGPREDYALPAGLEVSGKLRVALSNHLLWSKFNQHQTEMIITKQGRRMFPFLSFTVAGLEPTSHYRMFVDVVLVDQHHWRYQSGKWVQCGKAEGSMPGNRLYVHPDSPNTGAHWMRQEVSFGKLKLTNNKGASNNVTQMIVLQSLHKYQPRLHIVEVNDGEPEAACSASNTHVFTFQETQFIAVTAYQNAEITQLKIDNNPFAKGFRENFESMYASVDTSVPSPPGPNCQLLGGDPFSPLLSNQYPVPSRFYPDLPGQPKDMISQPYWLGTPREHSYEAEFRAVSMKPTLLPSAPGPTVPYYRGQDVLAPGAGWPVAPQYPPKMSPAGWFRPMRTLPMDPGLGSSEEQGSSPSLWPEVTSLQPEPSDSGLGEGDTKRRRISPYPSSGDSSSPAGAPSPFDKETEGQFYNYFPN

SEQ ID NO: 5 - DNA, 3650 bp, Homo sapiens
cggcggccgcggatcccggcggcgatccgacctcgcagtctccccaggtccgccagcagccggttcagccagaatactgggatcttcagtggcaggaggagtaatcagaagacggagatgaattttaacactattttggaggagattcttattaagaggtcacagcagaaaaagaagacatcgcccttaaactacaaagagagactttttgtacttacaaagtccatgctaacctactatgagggtcgagcagagaagaaatacagaaaggggtttattgatgtttcaaaaatcaagtgtgtggaaatagtgaagaatgatgatggtgtcattccctgtcaaaataagtatccatttcaggttgttcatgatgctaacacactttacatttttgcacctagtccacaaagcagggacctgtgggtgaagaagttaaaagaagaaataaagaacaacaataatattatgattaaatatcatcctaaattctggacagatggaagttatcagtgttgtagacaaactgaaaaattagcacccggatgtgaaaaatacaatctttttgagagcagtataagaaaagcactacctccagcaccagaaacaaagaagcgaaggcctcccccaccaattccactagaagaagaagataatagtgaagaaatcgttgtagccatgtatgatttccaagcagcagaaggacatgatctcagattagagagaggccaagagtatctcattttagaaaagaatgatgtgcattggtggagagcaagagataaatatgggaatgaaggatatatcccaagtaattacgtaacgggaaagaaatcaaacaacttagatcaatatgaatggtattgcagaaatatgaatagaagcaaggcagagcaactcctccgcagtgaagataaagaaggtggttttatggtaagggattccagtcaaccaggcttgtacacagtctccctttataccaagtttggaggagaaggttcatcgggttttaggcattatcatataaaggaaacaacaacatctccaaagaagtattacctagctgaaaaacatgcttttggctccattcctgagattattgaatatcataagcacaatgcagcaggacttgtcaccaggcttcggtacccagttagtgtgaaagggaagaatgcacccaccactgcaggattcagctatgagaaatgggagattaacccttcagaactgacctttatgagggaattgggaagtggactgtttggagtggtgaggcttggcaaatggcgagcccagtacaaagtcgcaatcaaagctattcgggaaggtgcaatgtgcgaggaggactttatagaagaagctaaagtgatgatgaagctgacacacccgaagttagtgcagctttatggtgtgtgcacccagcagaaaccaatatacattgttactgagttcatggaaaggggctgccttctgaatttcctccgacagagacaaggtcatttcagtagagacgtactgctgagcatgtgtcaggatgtgtgtgaagggatggagtatctggagagaaacagcttcatccacagagatctggctgccagaaattgtctagtaagtgaggcgggagttgtaaaagtatctgattttggaatggccaggtattttctggatgatcagtacacaagttcttctggtgctaagtttcctgtgaagtggtgtccacctgaagtgtttaattacagccgcttcagcagcaaatcagatgtctggtcatttggtgttttaatgtgggaagtattcacggaaggcagaatgccttttgaaaaatacaccaattatgaagtggtaaccatggttactcgaggccaccgactctaccagccgaagttggcgtccaactatgtgtatgaggtgatgctgagatgttggcaggagaaaccagagggaaggccttctttcgaagatctgctgcgcacaatagatgaactagttgaatgtgaagaaacttttggaagataagtgatgtgtgaccagtggctcccagattcccaagcacaaggaaggatgggcattttgtggcttttaatttattgagcacttggacatgtagatcattttacttatacagtggaaacacataaataatttgcttctagaccagcctctgtctagacttgcttctagacagaatctcccagagtgtggaaatgttgccttagaaatggtgattaaaatcactcatttctattcattcctcaggcacttgagtgacagttgtttaccaggcactgtgtgtagccccagggtttggccattcaggggtgcacacatgggaccatgttagctgatgccagttgaaggccagggtatttgggaaggggaagggtattagagtcatgaccaagcaacccttctttttccctttgacttctacagaaatctgggcctgagacattgtctacaattgggttctagatacatcaggaacccatcttggataaataaatacctatcttttgttttgaaaacatctcagttttcaagactgctcttagtattacatgaacaatatttgtatgctgtatatattgtaaatatatataatatataaagttatatatttatgagaaacacgaattgtcttttaattgaaacttttaatcctgtagtataggagttcaccttcttaggactagagactgtgccttatagctgttaattcatttccccctgaacatcaaatatgcctgaagagaagaaagtctagattcttctatgagtaacgccccctcctcactcaggtaaatgtgtctggggatgcctgtccagcttaaccacgtgcatttggcctatgtaatcctgcccatggtggccgcagctaatcagaatcagatggaaaattaaaccgggtaatctacttctaagccttaagaatattccctgggacacagacactataattggaagtgctgagctctggggcagaaggatcaggtgaccttcgcaacaaagtttgcccccacctcacataggacccggaagcagcctgagctgtggcggaggatccaggaagctacggagagaagcagccagcatggtgttccgtgcctcccggacgtttttcaggaggcctggttggacttgggttcctggatggtgggattgttgtacagcctctcaggagaccctgctgtcaagactgtgtgtgtggatttcccacccttagaagctctactaagacatcaacggaattagggccttcctttttgccttgtgagcgccaaggaaaagaaactatctcggtcacgtgagcgccacgaaagaaactgtatcagtcatccagagaccgtttattgcccaacacgttattcttgctgttggtggggtaactagccgaggaagacacagcgccttcccttcaggagttgcgtctcctctgcaggccacgatggtctgctctggagcattgggtgaacacacaggctggctgctctgggcagcgccttcactctgaccctggagaaccatttcatttcatcctggtcagtctagagtctgtgcaccaggcagtccatccactgaaggctgtgtttattcttttcctgtgcccctcataatggaagaaagtaaactgcttatcccgagccttaaaaaaa

SEQ ID NO: 6 - protein, 631 aa, Homo sapiens
MNFNTILEEILIKRSQQKKKTSPLNYKERLFVLTKSMLTYYEGRAEKKYRKGFIDVSKIKCVEIVKNDDGVIPCQNKYPFQVVHDANTLYIFAPSPQSRDLWVKKLKEEIKNNNNIMIKYHPKFWTDGSYQCCRQTEKLAPGCEKYNLFESSIRKALPPAPETKKRRPPPPIPLEEEDNSEEIVVAMYDFQAAEGHDLRLERGQEYLILEKNDVHWWRARDKYGNEGYIPSNYVTGKKSNNLDQYEWYCRNMNRSKAEQLLRSEDKEGGFMVRDSSQPGLYTVSLYTKFGGEGSSGFRHYHIKETTTSPKKYYLAEKHAFGSIPEIIEYHKHNAAGLVTRLRYPVSVKGKNAPTTAGFSYEKWEINPSELTFMRELGSGLFGVVRLGKWRAQYKVAIKAIREGAMCEEDFIEEAKVMMKLTHPKLVQLYGVCTQQKPIYIVTEFMERGCLLNFLRQRQGHFSRDVLLSMCQDVCEGMEYLERNSFIHRDLAARNCLVSEAGVVKVSDFGMARYFLDDQYTSSSGAKFPVKWCPPEVFNYSRFSSKSDVWSFGVLMWEVFTEGRMPFEKYTNYEVVTMVTRGHRLYQPKLASNYVYEVMLRCWQEKPEGRPSFEDLLRTIDELVECEETFGR

SEQ ID NO: 7 - DNA, 2578 bp, Mus musculus
cgatgggtttggtcagcgcttgccgagctccggcctccgcagtttggacgtcgctctgtcttggcttgtctcggcacgcgctccgtcaaggtgtcggacgacactgaggacacagaggatgtccgaagaatgaaatgagcagatggaactttgaaggctgagtcaacgggcagaggtaatccggagatcgtcaatggcaggagaaagagcaaccagaagaccgagatgaatttcaacactatcctagaagagattcttattaaaaggtcccagcagaaaaagaagacatcacccttaaactacaaagagagactttttgtacttacaaaatccgtgttgagctactatgagggtcgagcggagaagaaatacagaaagggcgtcattgatatttccaaaatcaagtgtgtggagatagtgaagaacgatgatggtgtcattccctgtcaaaataaatttccattccagtccacaaagcagggaccgatgggtgaagaagttaaaagaagaaataaagaacaacaataatatcatgattaaataccatcctaaattctgggcagatgggagttaccagtgttgtagacaaacagaaaaactagcacccggatgtgagaagtacaatctttttgagagtagtataagaaagaccctgcctcccgcgccagaaataaagaagagaaggcctcctccaccaattcccccagaggaagaaaatactgaagaaatcgttgtagcgatgtatgacttccaagcgacggaagcacatgacctcaggttagagagaggccaagagtatatcatcctggaaaagaatgacctccattggtggagagcgagagataagtatgggtggtactgcagaaataccaacagaagcaaagcagaacagctcctcagaacggaagataaagaaggtggttttatggtgagagactccagtcaaccaggcttgtacactgtctccctttacacaaagtttggcggagaaggctcatcaggtttcaggcattatcacataaaggaaacagcaacatccccaaagaagtattacctggcagagaagcatgctttcgggtccattcctgagatcattgaatatcacaagcacaatgcggcagggcttgtcaccaggctgcggtacccggtcagtacaaaggggaagaacgctcccactactgccggcttcagctatgataagtgggagattaacccatcagagctgacctttatgagagagttggggagcggactgtttggagtggtgaggcttggcaagtggcgggcccagtacaaagtggccatcaaagctatccgggaaggcgccatgtgtgaagaggatttcatagaggaagctaaagtcatgatgaagctgacacaccccaagctggtacagctctatggtgtatgcacccagcagaagcccatctacatcgttaccgagttcatggaacggggctgccttctgaatttcctccggcagagacaaggccatttcagcagagacatgctgctaagcatgtgtcaagatgtctgtgaagggatggagtacctggagagaaacagcttcatccacagagacctggctgccagaaattgtctagtgaatgaagcaggagttgtcaaagtatctgattttggaatggccaggtacgttctggatgatcagtacacaagttcttctggcgccaagttccctgtgaagtggtgtcccccagaagtgtttaattacagccgctttagcagcaagtcagacgtctggtcgtttggtgtgctaatgtgggaaatattcacagaaggcaggatgccctttgagaagaacaccaattacgaagtggtaaccatggtgactcgtggccaccgcctccaccggccaaagctggctaccaaatatttgtatgaggtgatgctgagatgctggcaagagagaccagagggaaggccttcctttgaagacttgctgcgtacgatagatgaactagttgaatgtgaagaaacttttggaagatgaatggtggccccagtttccaaggcaagaggaagaaatggtgtgccatcggaacgcggttctcttggcacctgggagtatagactgctctgcttacaacacgggagccccagcgcatctgctgctgatccagcctgagctcagtggctgctttgccggctgcacagatggtctctcagagctggtgacttgaagcactcattttgctcatttcttcaagggtttgagtgccagccatgtataccaggctctgtgcccaggcctcaggagatgaacatgggactatgctagctgatgctagcagaaagccagggtggttgtgatggggacgagtcatgtcccagcgtctcttccatgccctttggcttttacataaacctgggcctggagtgttgtctaccactgagttctaggaaaagcaggaacccacctggatacgtagtaatcctctgttttggaaacatctctttccaaacttgttcttagtagtatgcttaaaaatttgtatattgtatatattgtaaatacatataatatataaagttatatatttataagtaaaaaaaaaaa

SEQ ID NO: 8 - protein, 527 aa, Mus musculus
MMVSFPVKINFHSSPQSRDRWVKKLKEEIKNNNNIMIKYHPKFWADGSYQCCRQTEKLAPGCEKYNLFESSIRKTLPPAPEIKKRRPPPPIPPEEENTEEIVVAMYDFQATEAHDLRLERGQEYIILEKNDLHWWRARDKYGWYCRNTNRSKAEQLLRTEDKEGGFMVRDSSQPGLYTVSLYTKFGGEGSSGFRHYHIKETATSPKKYYLAEKHAFGSIPEIIEYHKHNAAGLVTRLRYPVSTKGKNAPTTAGFSYDKWEINPSELTFMRELGSGLFGVVRLGKWRAQYKVAIKAIREGAMCEEDFIEEAKVMMKLTHPKLVQLYGVCTQQKPIYIVTEFMERGCLLNFLRQRQGHFSRDMLLSMCQDVCEGMEYLERNSFIHRDLAARNCLVNEAGVVKVSDFGMARYVLDDQYTSSSGAKFPVKWCPPEVFNYSRFSSKSDVWSFGVLMWEIFTEGRMPFEKNTNYEVVTMVTRGHRLHRPKLATKYLYEVMLRCWQERPEGRPSFEDLLRTIDELVECEETFGR

SEQ ID NO: 9 - DNA, 2365 bp, Homo sapiens
tcccagccttcccatccccccaccgaaagcaaatcattcaacgacccccgaccctccgacggcaggagccccccgacctcccaggcggaccgcccttccctccccgcgcgggttccgggcccggcgagagggcgcgacgacagccgaggccatggaggtgacggcggaccagccgcgctgggtgagccaccaccaccccgccgtgctcaacgggcagcacccggacacgcaccacccgggcctcagccactcctacatggacgcggcgcagtacccgctgccggaggaggtggatgtgctttttaacatcgacggtcaaggcaaccacgtcccgccctactacggaaactcggtcagggccacggtgcagaggtaccctccgacccaccacgggagccaggtgtgccgcccgcctctgcttcatggatccctaccctggctggacggcggcaaagccctgggcagccaccacaccgcctccccctggaatctcagccccttctccaagacgtccatccaccacggctccccggggcccctctccgtctaccccccggcctcgtcctcctccttgtcggggggccacgccagcccgcacctcttcaccttcccgcccaccccgccgaaggacgtctccccggacccatcgctgtccaccccaggctcggccggctcggcccggcaggacgagaaagagtgcctcaagtaccaggtgcccctgcccgacagcatgaagctggagtcgtcccactcccgtggcagcatgaccgccctgggtggagcctcctcgtcgacccaccaccccatcaccacctacccgccctacgtgcccgagtacagctccggactcttcccccccagcagcctgctgggcggctcccccaccggcttcggatgcaagtccaggcccaaggcccggtccagcacaggcagggagtgtgtgaactgtggggcaacctcgaccccactgtggcggcgagatggcacgggacactacctgtgcaacgcctgcgggctctatcacaaaatgaacggacagaaccggcccctcattaagcccaagcgaaggctgtctgcagccaggagagcagggacgtcctgtgcgaactgtcagaccaccacaaccacactctggaggaggaatgccaatggggaccctgtctgcaatgcctgtgggctctactacaagcttcacaatattaacagacccctgactatgaagaaggaaggcatccagaccagaaaccgaaaaatgtctagcaaatccaaaaagtgcaaaaaagtgcatgactcactggaggacttccccaagaacagctcgtttaacccggccgccctctccagacacatgtcctccctgagccacatctcgcccttcagccactccagccacatgctgaccacgcccacgccgatgcacccgccatccagcctgtcctttggaccacaccacccctccagcatggtcaccgccatgggttagagccctgctcgatgctcacagggcccccagcgagagtccctgcagtccctttcgacttgcatttttgcaggagcagtatcatgaagcctaaacgcgatggatatatgtttttgaaggcagaaagcaaaattatgtttgccactttgcaaaggagctcactgtggtgtctgtgttccaaccactgaatctggaccccatctgtgaataagccattctgactcatatcccctatttaacagggtctctagtgctgtgaaaaaaaaaaatcctgaacattgcatataacttatattgtaagaaatactgtacaatgactttattgcatctgggtagctgtaaggcatgaaggatgccaagaagtttaaggaatatgggagaaatagtgtggaaattaagaagaaactaggtctgatattcaaatggacaaactgccagttttgtttcctttcactggccacagttgtttgatgcattaaaagaaaataaaaaaaagaaaaaagagaaaagaaaaaaaaagaaaaaagttgtaggcgaatcatttgttcaaagctgttggccctctgcaaaggaaataccagttctgggcaatcagtgttaccgttcaccagttgccattgagggtttcagagagcctttttctaggcctacatgctttgtgaacaagtccctgtaattgttgtttgtatgtataattcaaagcaccaaaataagaaaagatgtagatttatttcatcatattatacagaccgaactgttgtataaatttatttactgctagtcttaagaactgctttctttcgtttgtttgtttcaatattttccttctctctcaattttcggttgaataaactagattacattcagttggcaaaaaaaaaaaaa

SEQ ID NO: 10 - DNA, 3067 bp, Homo sapiens
ggcgccgtcttgatactttcagaaagaatgcattccctgtaaaaaaaaaaaaaaaatactgagagagggagagagagagagaagaagagagagagacggagggagagcgagacagagcgagcaacgcaatctgaccgagcaggtcgtacgccgccgcctcctcctcctctctgctcttcgctacccaggtgacccgaggagggactccgcctccgagcggctgaggaccccggtgcagaggagcctggctcgcagaattgcagagtcgtcgcccctttttacaacctggtcccgttttattctgccgtacccagtttttggatttttgtcttccccttcttctctttgctaaacgacccctccaagataatttttaaaaaaccttctcctttgctcacctttgcttcccagccttcccatccccccaccgaaagcaaatcattcaacgacccccgaccctccgacggcaggagccccccgacctcccaggcggaccgccctccctccccgcgcgcgggttccgggcccggcgagagggcgcgagcacagccgaggccatggaggtgacggcggaccagccgcgctgggtgagccaccaccaccccgccgtgctcaacgggcagcacccggacacgcaccacccgggcctcagccactcctacatggacgcggcgcagtacccgctgccggaggaggtggatgtgctttttaacatcgacggtcaaggcaaccacgtcccgccctactacggaaactcggtcagggccacggtgcagaggtaccctccgacccaccacgggagccaggtgtgccgcccgcctctgcttcatggatccctaccctggctggacggcggcaaagccctgggcagccaccacaccgcctccccctggaatctcagccccttctccaagacgtccatccaccacggctccccggggcccctctccgtctaccccccggcctcgtcctcctccttgtcggggggccacgccagcccgcacctcttcaccttcccgcccaccccgccgaaggacgtctccccggacccatcgctgtccaccccaggctcggccggctcggcccggcaggacgagaaagagtgcctcaagtaccaggtgcccctgcccgacagcatgaagctggagtcgtcccactcccgtggcagcatgaccgccctgggtggagcctcctcgtcgacccaccaccccatcaccacctacccgccctacgtgcccgagtacagctccggactcttcccccccagcagcctgctgggcggctcccccaccggcttcggatgcaagtccaggcccaaggcccggtccagcacaggcagggagtgtgtgaactgtggggcaacctcgaccccactgtggcggcgagatggcacgggacactacctgtgcaacgcctgcgggctctatcacaaaatgaacggacagaaccggcccctcattaagcccaagcgaaggctgtctgcagccaggagagcagggacgtcctgtgcgaactgtcagaccaccacaaccacactctggaggaggaatgccaatggggaccctgtctgcaatgcctgtgggctctactacaagcttcacaatattaacagacccctgactatgaagaaggaaggcatccagaccagaaaccgaaaaatgtctagcaaatccaaaaagtgcaaaaaagtgcatgactcactggaggacttccccaagaacagctcgtttaacccggccgccctctccagacacatgtcctccctgagccacatctcgcccttcagccactccagccacatgctgaccacgcccacgccgatgcacccgccatccagcctgtcctttggaccacaccacccctccagcatggtcaccgccatgggttagagccctgctcgatgctcacagggcccccagcgagagtccctgcagtccctttcgacttgcatttttgcaggagcagtatcatgaagcctaaacgcgatggatatatgtttttgaaggcagaaagcaaaattatgtttgccactttgcaaaggagctcactgtggtgtctgtgttccaaccactgaatctggaccccatctgtgaataagccattctgactcatatcccctatttaacagggtctctagtgctgtgaaaaaaaaaatgctgaacattgcatataacttatattgtaagaaatactgtacaatgactttattgcatctgggtagctgtaaggcatgaaggatgccaagaagtttaaggaatatgggagaaatagtgtggaaattaagaagaaactaggtctgatattcaaatggacaaactgccagttttgtttcctttcactggccacagttgtttgatgcattaaaagaaaataaaaaaaagaaaaaagagaaaagaaaaaaaaagaaaaaagttgtaggcgaatcatttgttcaaagctgttggcctctgcaaaggaaataccagttctgggcaatcagtgttaccgttcaccagttgccgttgagggtttcagagagcctttttctaggcctacatgctttgtgaacaagtccctgtaattgttgtttgtatgtataattcaaagcaccaaaataagaaaagatgtagatttatttcatcatattatacagaccgaactgttgtataaatttatttactgctagtcttaagaactgctttctttcgtttgtttgtttcaatattttccttctctctcaatttttggttgaataaactagattacattcagttggcctaaggtggttgtgctcggagggtttcttgtttcttttccattttgtttttggatgatatttattaaatagcttctaagagtccggcggcatctgtcttgtccctattcctgcagcctgtgctgagggtagcagtgtatgagctaccagcgtgcatgtcagcgaccctggcccgacaggccacgtcctgcaatcggcccggctgcctcttcgccctgtcgtgttctgtgttagtgatcactgcctttaatacagtctgttggaataatattataagcataataataaagtgaaaatattttaaaactacaa

SEQ ID NO: 11 - DNA, 2853 bp, Mus musculus
ttttctttcctccctaaaccctcctttttgctctccttttctatacccttaactgcaaacaaaccattaaacgacccctctcctgggcctccgacggcaggagtccgcggacctcccaggccgacagccctccctctacccgcgagggttccgggccgggcgagagggcgcgagcacagccgaggacatggaggtgactgcggaccagccgcgctgggtgagccaccatcaccccgcggtcctcaacggtcagcacccagacacgcaccacccgggcctcggccattcgtacatggaagctcagtatccgctgacggaagaggtggacgtactttttaacatcgatggtcaaggcaaccacgtcccgtcctactacggaaactccgtcagggctacggtgcagaggtatcctccgacccaccacgggagccaggtatgccgcccgcctctgctgcacggatctctgccctggctggatggcggcaaagccctgagcagccaccacaccgcctcgccctggaacctcagccccttctccaagacgtccatccaccacggctctccggggcctctgtccgtttaccctccggcttcatcctcttctctggcggccggccactccagtcctcatctcttcaccttcccgcccaccccgccgaaagacgtctccccagacccgtcgctgtccaccccgggatccgccgggtcggccaggcaagatgagaaagagtgcctcaagtatcaggtgcagctgccagatagcatgaagctggagacgtctcactctcgaggcagcatgaccaccctgggtggggcctcatcctcagcccaccaccccattaccacctatccgccctatgtgcccgagtacagctctggactcttcccacccagcagcctgctgggaggatcccctaccgggttcggatgtaagtcgaggcccaaggcacgatccagcacagaaggcagggagtgtgtgaactgcggggcaacctctaccccactgtggcggcgagatggtaccgggcactacctttgcaatgcctgcggactctaccataaaatgaatgggcagaaccggccccttatcaagcccaagcgaaggctgtcggcagcaaggagagcagggacatcctgcgcgaactgtcagaccaccaccaccaccctctggaggaggaacgctaatggggacccggtctgcaatgcctgtgggctgtactacaagcttcataatattaacagacccctgactatgaagaaagaaggcatccagacccgaaaccggaagatgtctagcaaatcgaaaaagtgcaaaaaggtgcatgacgcgctggaggacttccccaagagcagctccttcaacccggccgctctctccagacacatgtcatccctgagccacatctctcccttcagccactccagccacatgctgaccacaccgacgcccatgcatccgccctccggcctctccttcggacctcaccacccttccagcatggtcaccgccatgggttagagaggcagagccctgctccacatgcgtgaggagtctccaagtgtgcgaagagttcctccgaccccttctacttgcgtttttcgcaggagcagtatcatgaagcccgaaagcgacagatctgtgtttttgaaggcagaaagcaaaatgtttgcttcttttttcaaaggagctcgaggtggtgtctgcattccaaccactgaatccggatcccatttgtgaataagccattcagactcatattccctatttaacagggtctctagtgctgtgaaaaaaatattgctgaacattgcatataacttatattgtaagaaatactgtacatttgaggaagactttattgtacctggatagctgtaagaaaggcatgaaggacgccaagagttttaaggaatatagggggattaaagtatggagatacagaagaaaccactaagtctgatgtccaaatgggcacactgtcagttttgtttcccttcagttgtttgatgcatttaaaaaaaaaaaaaagaaagaaaaagaaaaaaaggggggggggggagaaaaaaataaattaaaaaaaaaaaaaaaaaaaagaaaagaaagaaaaatctaagaaaaaaaaaaaaaaggttgtaggcaaatcatttgttccaggctgtgagcctgtgcaaaagagatttcagatctgggcaatgggtgtgtgatctcacccactgaagatctgagaatgtcatggctaggcctacatgctctgtgaatcagtccctgtaattgttgtttgtatgtataattcagaagcaccaaaataagaaaagatgtagatttatttcatcatattatacagactgaattgttgtataaatttatttactgctagtgttaggaactgctttttttttttttttggttttaatgttttttttttttttgttttttgtttttttttttctttctctctggatttttggttgaataaactagattgctttcagttgacttaaggtggatgtactctggagggtttatttttccttttattattatttttgatggtatttattaaatagcttctatgggcccggcggtacctgtctttttcgtcacttttcttgcagcctaaactatgaaggtagcagcgtaccagctaccaacatgcatgtcagagacccggccactcacaggcctggtcctgagagccacctggctgactgttagcccctgtgtgttctgtattagtgatcactgcctttaaacagtctgttggaataatactataaaaataataataaagttaaaatattttaaaacaaaaaaaaaaaaaaaaaaaaaaaaaaaaaaaaaaaaaaaaaaaa

SEQ ID NO: 12 - protein, 443 aa, Mus musculus
MEVTADQPRWVSHHHPAVLNGQHPDTHHPGLGHSYMEAQYPLTEEVDVLFNIDGQGNHVPSYYGNSVRATVQRYPPTHHGSQVCRPPLLHGSLPWLDGGKALSSHHTASPWNLSPFSKTSIHHGSPGPLSVYPPASSSSLAAGHSSPHLFTFPPTPPKDVSPDPSLSTPGSAGSARQDEKECLKYQVQLPDSMKLETSHSRGSMTTLGGASSSAHHPITTYPPYVPEYSSGLFPPSSLLGGSPTGFGCKSRPKARSSTEGRECVNCGATSTPLWRRDGTGHYLCNACGLYHKMNGQNRPLIKPKRRLSAARRAGTSCANCQTTTTTLWRRNANGDPVCNACGLYYKLHNINRPLTMKKEGIQTRNRKMSSKSKKCKKVHDALEDFPKSSSFNPAALSRHMSSLSHISPFSHSSHMLTTPTPMHPPSGLSFGPHHPSSMVTAMG

SEQ ID NO: 13 - DNA, 4366 bp, Homo sapiens
tgcattctttgccccaaaactctttcctttggttgtgctaagaggtgatgcccaaggtgcaccacctttcaagaactggatcatgaacaactttatcctcctggaagaacagctcatcaagaaatcccaacaaaagagaagaacttctccctcgaactttaaagtccgcttctttgtgttaaccaaagccagcctggcatactttgaagatcgtcatgggaagaagcgcacgctgaaggggtccattgagctctcccgaatcaaatgtgttgagattgtgaaaagtgacatcagcatcccatgccactataaatacccgtttcaggtggtgcatgacaactacctcctatatgtgtttgctccagatcgtgagagccggcagcgctgggtgctggcccttaaagaagaaacgaggaataataacagtttggtgcctaaatatcatcctaatttctggatggatgggaagtggaggtgctgttctcagctggagaagcttgcaacaggctgtgcccaatatgatccaaccaagaatgcttcaaagaagcctcttcctcctactcctgaagacaacaggcgaccactttgggaacctgaagaaactgtggtcattgccttatatgactaccaaaccaatgatcctcaggaactcgcactgcggcgcaacgaagagtactgcctgctggacagttctgagattcactggtggagagtccaggacaggaatgggcatgaaggatatgtaccaagcagttatctggtggaaaaatctccaaataatctggaaacctatgagtggtacaataagagtatcagccgagacaaagctgaaaaacttcttttggacacaggcaaagaaggagccttcatggtaagggattccaggactgcaggaacatacaccgtgtctgttttcaccaaggctgttgtaagtgagaacaatccctgtataaagcattatcacatcaaggaaacaaatgacaatcctaagcgatactatgtggctgaaaagtatgtgttcgattccatccctcttctcatcaactatcaccaacataatggaggaggcctggtgactcgactccggtatccagtttgttttgggaggcagaaagccccagttacagcagggctgagatacgggaaatgggtgatcgacccctcagagctcacttttgtgcaagagattggcagtgggcaatttgggttggtgcatctgggctactggctcaacaaggacaaggtggctatcaaaaccattcgggaaggggctatgtcagaagaggacttcatagaggaggctgaagtaatgatgaaactctctcatcccaaactggtgcagctgtatggggtgtgcctggagcaggcccccatctgcctggtgtttgagttcatggagcacggctgcctgtcagattatctacgcacccagcggggactttttgctgcagagaccctgctgggcatgtgtctggatgtgtgtgagggcatggcctacctggaagaggcatgtgtcatccacagagacttggctgccagaaattgtttggtgggagaaaaccaagtcatcaaggtgtctgactttgggatgacaaggttcgttctggatgatcagtacaccagttccacaggcaccaaattcccggtgaagtgggcatccccagaggttttctctttcagtcgctatagcagcaagtccgatgtgtggtcatttggtgtgctgatgtgggaagttttcagtgaaggcaaaatcccgtatgaaaaccgaagcaactcagaggtggtggaagacatcagtaccggatttcggttgtacaagccccggctggcctccacacacgtctaccagattatgaatcactgctggaaagagagaccagaagatcggccagccttctccagactgctgcgtcaactggctgaaattgcagaatcaggactttagtagagactgagtaccaggccacgggctgcagatcctgaatggaggaaggatatgtcctcattccatagagcattagaagctgccaccagcccaggaccctccagaggcagcctggcctgtggcatcagtccctgagtcaccatggaagcagcatcctgaccacagctggcagtcaagccacagctggagggtcagccaccaagctgggagctgagccagaacaggagtgatgtctctgcccttcctctagcctcttgtcacatgtggtgcacaaacctcaacctgacagctttcagacagcattcttgcacttcttagcaacagagagagacatgagtaagacccagattgctatttttattgttatttttaacatgaatctaaagtttatggttccagggactttttatttgacccaacaacacagtatcccaggatatggaggcaaggggaacaaagagcatgagtctttttccaagaaaactggtgagttaagtaagattagagtgagtgtgctctgttgctgtgatgctgtcagccacagcttcctgccgtagagaatgatagagcagctgctcacacaggaggccggatattctgagaagcagctttatgaggttttacagagtatgctgctacctctctccttgaagggagcatggcgagacccattggatggattggggtgaacagttcaggtcccatgcttggagcattgggtatctgatgtctgcaccagaacaagagaacctctgacggtggagaaccatgtggtgcaagaagagatcttaggtctcttcttttataccaagctcatcttttataccaagctgtgcaggtgactatgcctcctcttctgcacagaatgcttccaccagcatcctgagaagaaatgattacttctgaaaaacatccttttttccagcctctgggaatcagccccccctctctgcactatccgatcctcatcaacagagggcagcattgtgttggtcaatgttcccttggcgagcaattgaaacttgtttaggccctagggttgagcaattttaaggttgagactccaagtctcctaaaattctaggagagaaataaagagtctgtttttgctcaaaccatcaggatggaaacagtcaggcactgactggggtgcttccaagaggcatgagagtgcctactctggcttgagcacttctatatgcaaggtgaatatgtactgagctaggagacttccctgcaaaatctctgttcaccctgggttcacatccccatgaggtaatattattattcccattttacaaataatgtaactgaggctttaaaaagccaagacatctgcccaaagtgatggaactagaaagtctagagctggtattctagcccaaatctgtctgaccgcaatacacagattctttattcctattcgacactggcttctactgaaaatgaaacggattgcagagggaataaatacaaagatggaaagccagtaaagaagtcagtatagaaccactagcgaatagtgttgctctggcacagaccactgtggttgatggcatggccctccaacttggaataggattttccttttcctattctgtatccttaccttggtcatgttaatgactttggagttattcagttaatgaccctttaattctcacaaccaaccagtcatgttgcttgaagccatttatagacgagcttcaaagcaactttaaaagattcttctgtagaagtatgagttcttcctttaattatcattccaactttcagctgtagtcttcttgaacacttcatgaggagggacattccctgatataagagaggatggtgttgcaattggctctttctaaatcatgtgacgttttgactggcttgagattcagatgcataatttttaattataattattgtgaagtggagagcctcaagataaaactctgtcattcagaagatgattttactcagcttatccaaaattatctctgtttactttttagaattttgtacattatcttttgggatccttaattagagatgatttctggaacattcagtctagaaagaaaacattggaattgactgatctctgtggtttggtttagaaaattcccctgtgcatggtattacctttttcaagctcagattcatctaatcctcaactgtacatgtgtacattcttcacctcctggtgccctatcccgcaaaatgggcttcctgcctggtttttctcttctcacattttttaaatggtcccctgtgtttgtagagaactcccttatacagagttttggttctagttttatttcgtagattttgcattttgtaccttttgagactatgtatttatatttggatcagatgcatatttattaatgtacagtcactgctagtgttcaaaataaaaatgttacaaat

SEQ ID NO: 14 - protein, 620 aa, Homo sapiens
MNNFILLEEQLIKKSQQKRRTSPSNFKVRFFVLTKASLAYFEDRHGKKRTLKGSIELSRIKCVEIVKSDISIPCHYKYPFQVVHDNYLLYVFAPDRESRQRWVLALKEETRNNNSLVPKYHPNFWMDGKWRCCSQLEKLATGCAQYDPTKNASKKPLPPTPEDNRRPLWEPEETVVIALYDYQTNDPQELALRRNEEYCLLDSSEIHWWRVQDRNGHEGYVPSSYLVEKSPNNLETYEWYNKSISRDKAEKLLLDTGKEGAFMVRDSRTAGTYTVSVFTKAVVSENNPCIKHYHIKETNDNPKRYYVAEKYVFDSIPLLINYHQHNGGGLVTRLRYPVCFGRQKAPVTAGLRYGKWVIDPSELTFVQEIGSGQFGLVHLGYWLNKDKVAIKTIREGAMSEEDFIEEAEVMMKLSHPKLVQLYGVCLEQAPICLVFEFMEHGCLSDYLRTQRGLFAAETLLGMCLDVCEGMAYLEEACVIHRDLAARNCLVGENQVIKVSDFGMTRFVLDDQYTSSTGTKFPVKWASPEVFSFSRYSSKSDVWSFGVLMWEVFSEGKIPYENRSNSEVVEDISTGFRLYKPRLASTHVYQIMNHCWKERPEDRPAFSRLLRQLAEIAESGL

SEQ ID NO: 15 - DNA, 4294 bp, Mus musculus
gaattccgttcctgtctcagtctccgctgctcctctccttcagtcgcactgcggggtgatgcccaaggcgcatcacttttcagaactggaccatgaacaacttcatcctcctggaagaacagctgatcaagaagtcccaacagaagagaaggacttctccctcgaattttaaagttcgtttctttgtcttaacgaaagccagcctggcctactttgaggaccgccacgggaagaagcgcacgttgaagggctccattgaactctccagaatcaagtgtgtggagattgtcaagagtgacattagcatcccgtgccactataaatacccttttcagactcttgtgtacttacaggtcgtgcatgacaactatctcctgtatgtgtttgctccagactgtgagagtcggcagcgctgggtgctgacccttaaagaagaaacgaggaataacaacagcctggtatccaagtatcaccctaatttctggatggatgggcggtggaggtgctgctcccagctggagaagcctgctgtaggctgtgctccctacgacccatccaagaatgcttcaaagaagcctcttcctcctactcctgaagacaacaggcggtcatttcaggaacctgaagaaaccctggtcattgccttgtacgactaccaaaccaacgaccctcaggagctcgcgctgcggtgtgatgaagagtactacctgctggacagctccgagatccactggtggagggttcaagacaaaaatgggcatgaaggatatgcaccaagcagttacctggtagaaaaatctccaaataaccttgaaacctatgagtggtacaataaaagcatcagccgcgacaaagctgaaaaacttcttttggacacaggtaaagaaggagctttcatggtccgagattccaggacgcccgggacatacacagtctctgttttcaccaaggccatcataagtgagaacccctgtataaaacattatcacatcaaagaaacaaatgacagccccaagcgctactacgtggctgagaagtatgtgtttgactccatccctctcctcatccagtatcaccagtacaatggaggaggtttggtcactcgactccgctatccagtttgctcctggagacaaaaagcccctgtcacagcagggctaagatatgggaagtgggtgatccaaccctcagagctaacgttcgtgcaggagattggcagcgggcagtttgggctggtgcatctcggctactggctcaacaaggacaaggtggccatcaagaccattcaggaaggggcgatgtcagaagaagactttatcgaggaggcggaagtcatgatgaaactctctcaccccaaactggtgcagctctatggggtgtgcctggagcaagcccccatctgcctggtgtttgagttcatggagcacggctgcctgtcggattaccttcgaagtcagcggggtctctttgctgcggagaccctgctgggcatgtgcctggatgtgtgtgagggcatggcctacctggaaaaagcttgtgtcatccacagagacctggcagccagaaactgtttggtgggagaaaaccaggtcatcaaggtgtccgactttgggatgacaagatttgtccttgatgatcaatataccagctccacgggcaccaaattcccagtgaagtgggcatccccagaggtgttctcctttagtcgctatagcagcaagtcagatgtgtggtcgtttggtgtactgatgtgggaagtcttcagtgaaggcaaaatcccatacgaaaaccgaagcaattccgaggtcgtggaagatatcagcactggctttcggttatacaagccccgcctggcctcctgtcatgtctaccagatcatgaatcattgctggaaagagaaaccagaagaccggccacccttctcccagctgttaagccagctggctgaaatcgcagaagctgggctttagcagggactcattgaccagacacagccataaatcctgagtgaaggaacaatgtcctttttccagagcattaaaagctgccaccagtccagaaacccccacaggtgcctggaccatggtgccagcacctatgcagccacaactgcagcatcatagaaaagggtggagggccagccactgagccaacagctgaaccacaactggagcagtatctgcgtgtcaccccatcccagcctcttgtcgtatgctgtactcaaagctccattgcccactctgggagcatcccctccccctcttagcaatccatggagaggcagacgtaggccacactcttctttattattactttaagaataattcaagtaacctttaatttggcccaacgagacaatgtgcccattttatggatggaagagcgggaaagcatcattctttttctaagaaatgcaagaggtgattaaaccagggtgttctactacttcaaggctgtcagccacagcttcctgcctcacatgaggcggagcggatgcttgtgccagaggccggatgccataaggtttcagagcacactgccacctctctttgatggggcacagagagctccaccgggtggatagggcagggtgacacattcagaccccacggcaggaccacaggatgtctgaggtcggtcaggaatgagagggcctctgatggtggaagtaaagagctgcaaaagaagcctttgggttgtccctgacccagcggccctgtttcacggtgagtcatgtgtgtgactggatctcctgttctgtgcaggatgctgaagcagtgactacagaacggtcatcattccagcctctcaggagcggcatccactcagcactgtcatgatccttgtgactttgagactttgggttctttcaagcctttacgggttcagcagtcttaaggttgccatgtaagctctcaagagcccagcaaaggaagaaggcgtttgctcttgcccaaactatcaggaaggaaagaggcaagcactgggcggtgcttccaaaatgcacagatgtctcctactgattggcactcgcacaggtgacatgtgtatatcctgcacacaggtcatcctggcgaatcacagttcataccaacccaaccacgaggtattattcatgtcttacagaaagtggacttggtcttttaaaagctggatagctgccccagtgacagaactgggaaggacggagattgagatgacacccgaatataactccagtgtagcctcttagctcttctcaatgctgcctcctactgggttgggccgctgagcgcataacacaggaaagtctgggttaatgggcaccccaccccacagccaagttgctcctactcagagcactggggggcccagtgggaccctccaaattgaaataggctgttctctttcttcaccctcacctggatctgagttcacaaccctggagccactcaaaattaaccctttcattctcccaacctaccagagtcacattgcctgaggccatttatactagagcttcaaaggtgctttcaactagtctcctgcagactgtttcctgtaattatcccttcaacctagagctggctctcttgtgagaaggaggattccctggtgccaggcacactggattttctgcggtgttcagacaaagcccctagaaaaatgatcagagtcacagatccctcttcctaagtcacgtggcatttaggctggcttgaggctcaaatgcatcacttccaactgtaatcactgtgtccagataaaactctgtcattcagaaaatgaacttcctcaactggtccacaatcatctctgtttattctcttttgggaaaccttaattaagagacgatttctgggacatccaatctggaagataaacactggaaccgagagaagtctgtggtgtggtttaggagactggcccccatacggtggtattggctctcttaacctcacatgcacgaaggctttgatggacgcgtgtgcactgcttactccagtgtcctgcttgggaagatgggattctcttctgctggtttctgtcttacatttttttgtaaatggtgccctgtgttcacagaaaggttttggtttgaaatgtattttgtaggccttgcaattcataatgtttggaactatgtatttatgcctagatcaggagagtatttattgcttgtcttcatgataaaaaatactgcaggtatgtcttaccctctgtgggggccacaagtcaatcattgcttatggaaaaaaatatatatataaagctacatgttttacaaaaaaaaaaaaaaaaaaaaaaggaattc

SEQ ID NO: 16 - protein, 625 aa, Mus musculus
MNNFILLEEQLIKKSQQKRRTSPSNFKVRFFVLTKASLAYFEDRHGKKRTLKGSIELSRIKCVEIVKSDISIPCHYKYPFQTLVYLQVVHDNYLLYVFAPDCESRQRWVLTLKEETRNNNSLVSKYHPNFWMDGRWRCCSQLEKPAVGCAPYDPSKNASKKPLPPTPEDNRRSFQEPEETLVIALYDYQTNDPQELALRCDEEYYLLDSSEIHWWRVQDKNGHEGYAPSSYLVEKSPNNLETYEWYNKSISRDKAEKLLLDTGKEGAFMVRDSRTPGTYTVSVFTKAIISENPCIKHYHIKETNDSPKRYYVAEKYVFDSIPLLIQYHQYNGGGLVTRLRYPVCSWRQKAPVTAGLRYGKWVIQPSELTFVQEIGSGQFGLVHLGYWLNKDKVAIKTIQEGAMSEEDFIEEAEVMMKLSHPKLVQLYGVCLEQAPICLVFEFMEHGCLSDYLRSQRGLFAAETLLGMCLDVCEGMAYLEKACVIHRDLAARNCLVGENQVIKVSDFGMTRFVLDDQYTSSTGTKFPVKWASPEVFSFSRYSSKSDVWSFGVLMWEVFSEGKIPYENRSNSEVVEDISTGFRLYKPRLASCHVYQIMNHCWKEKPEDRPPFSQLLSQLAEIAEAGL

SEQ ID NO: 17 - protein, 443 aa, Homo sapiens
MEVTADQPRWVSHHHPAVLNGQHPDTHHPGLSHSYMDAAQYPLPEEVDVLFNIDGQGNHVPPYYGNSVRATVQRYPPTHHGSQVCRPPLLHGSLPWLDGGKALGSHHTASPWNLSPFSKTSIHHGSPGPLSVYPPASSSSLSGGHASPHLFTFPPTPPKDVSPDPSLSTPGSAGSARQDEKECLKYQVPLPDSMKLESSHSRGSMTALGGASSSTHHPITTYPPYVPEYSSGLFPPSSLLGGSPTGFGCKSRPKARSSTGRECVNCGATSTPLWRRDGTGHYLCNACGLYHKMNGQNRPLIKPKRRLSAARRAGTSCANCQTTTTTLWRRNANGDPVCNACGLYYKLHNINRPLTMKKEGIQTRNRKMSSKSKKCKKVHDSLEDFPKNSSFNPAALSRHMSSLSHISPFSHSSHMLTTPTPMHPPSSLSFGPHHPSSMVTAMG

SEQ ID NO: 18 - DNA, 2564 bp, Homo sapiens
gatttcagttgaaagatgtgtttttgtgagtagagcaccgcagaagaactgaagactgttgtgtgctccccgcagaaggggctaccatgatcctttcctcctataacaccatccagtcggttttctgttgctgctgttgctgttcagtgcagaagcgacaaatgagaacacagataagcctgagcacagatgaagagcttccagaaaaatacacccagcatcgcaggccgtggctcagccaattgtcaaataagaagcaatccaacacgggccgtgtgcagccgtcaaaacgaaagccactgcctcccctcccaccctctgaggttgctgaagagaagatccaagtcaaggcactttatgattttctgcccagagaaccctgtaatttagccttaaggagagcagaagaatacctgatactggagaaatacaatcctcactggtggaaggcaagagaccgtttggggaatgaaggcttaatcccaagcaactatgtgactgaaaacaaaataactaatttagaaatatatgagtggtaccatagaaacattaccagaaatcaggcagaacatctattgagacaagagtctaaagaaggtgcatttattgtcagagattcaagacatttaggatcctacacaatttccgtatttatgggagctagaagaagtacggaggctgccataaaacattatcagataaaaaagaatgactcaggacagtggtatgtggctgaaagacacgcctttcaatcaatccctgagttaatctggtatcaccagcacaatgcagccggtctcatgactcgtctccgatatccagttgggctgatgggcagttgtttaccagccacagctgggtttagctacgaaaagtgggagatagatccatctgagttggcttttataaaggagattggaagcggtcagtttggagtggtccatttaggtgaatggcggtcacatatccaggtagctatcaaggccatcaatgaaggctccatgtctgaagaggatttcattgaagaggccaaagtgatgatgaaattatctcattcaaagctagtgcaactttatggagtctgtatacagcggaagcccctttacattgtgacagagttcatggaaaatggctgcctgcttaactatctcagggagaataaaggaaagcttaggaaggaaatgctactgagtgtatgccaggatatatgtgaaggaatggaatatctggagaggaatggctatattcatagggatttggcggcaaggaattgtttggtcagttcaacatgcatagtaaaaatttcagactttggaatgacaaggtacgttttggatgatgagtatgtcagttcttttggagccaagttcccaatcaagtggtcccctcctgaagtttttcttttcaataagtacagcagtaaatctgatgtctggtcatttggagttttaatgtgggaagtttttacagaaggaaaaatgccttttgaaaataagtcaaatttgcaagtcgtggaagctatttctgaaggcttcaggctatatcgccctcacctggcaccaatgtccatatatgaagtcatgtacagctgctggcatgagaaacctgaaggccgccctacatttgcggagctgctgcgggctgtcacagagattgcggaaacctggtgaccggaaacagaatgccaacccaaagagtcatcttgcaaaactgtcatttattgtgaatatcttcaccatatggggtcacttatggtgaatatctttcttcagagttgctgactcttgaaaacagtgcaaagatcacagtttttaaaagttttaaaaatttaagaatattcacacaatcgtttttctatgtgtgagagggatttgcacactcttatttttctgtaaaatatttcacatcccaaatgtgaagaagtgaaaaagacttcgcagcagtcttcattgtggtgctcttcatgatcatagccccaggaacccttgaggttcttcttcacaaggctgagagtgcttccttcttgaagacgagtgtcattcatcacttcagtgatccatgcatagaatatgaaaataaattcttccaactcatgggataaaggggactcccttgaagaatttcatgtttttgggctgtatagctctttacagaaaatgcacctttataaatcacatgaatgttagtattctggaaatgtcttttgttaatataatcttcccatgttatttaacaaattgtttttgcacatatctgattatattgaaagcagtttttttgcattcgagttttaaacactgttataaaatgtagccaaagctcacctttgaacagatcccggtgacattctatttccaggaaaatccggaacctgattttagttctgtgattttacactttttacatgtgagattggacagtttcagaggccttattttgtcatactaagtgtctcctgtaattttcaggaagatgatttgttctttccagaagaggagacaaaagcaagatagccaaatgtgacatcaagctccattgtttcggaaatccaggattttgaattc

SEQ ID NO: 19 - protein, 527 aa, Homo sapiens
MILSSYNTIQSVFCCCCCCSVQKRQMRTQISLSTDEELPEKYTQHRRPWLSQLSNKKQSNTGRVQPSKRKPLPPLPPSEVAEEKIQVKALYDFLPREPCNLALRRAEEYLILEKYNPHWWKARDRLGNEGLIPSNYVTENKITNLEIYEWYHRNITRNQAEHLLRQESKEGAFIVRDSRHLGSYTISVFMGARRSTEAAIKHYQIKKNDSGQWYVAERHAFQSIPELIWYHQHNAAGLMTRLRYPVGLMGSCLPATAGFSYEKWEIDPSELAFIKEIGSGQFGVVHLGEWRSHIQVAIKAINEGSMSEEDFIEEAKVMMKLSHSKLVQLYGVCIQRKPLYIVTEFMENGCLLNYLRENKGKLRKEMLLSVCQDICEGMEYLERNGYIHRDLAARNCLVSSTCIVKISDFGMTRYVLDDEYVSSFGAKFPIKWSPPEVFLFNKYSSKSDVWSFGVLMWEVFTEGKMPFENKSNLQVVEAISEGFRLYRPHLAPMSIYEVMYSCWHEKPEGRPTFAELLRAVTEIAETW

SEQ ID NO: 20 - DNA, 2342 bp, Mus musculus
agaacttctttttgctgttttggtgacaagttttttttgtcttcttctcctgaagatggccgtgatgtccccatgcctctgatcagggactgttccccgttcttatcgggagcacagccagagtggtccacacagggtcatggactcccggcttcctaaccgtgacaatgatctccttttcagatagctccttccagtctgttctctgctgctgctgttgccgctgctcagtacagaagagacaggtgagaactcagataagcctgagcagagaggaagaactctcagaaaaacattcccagcgtcagaggccgtggttcgccaaactgatgggcaaaactcaatccaacagaggcggggtgcaaccctcgaagcgcaagccgctgcctcccctcccgcaggagcctccagatgagagaatccaggtcaaggctctttatgacttcctgcctcgggagcctggtaatttggcactgaagagagcggaggaatatctgatattggagaggtgtgatcctcactggtggaaggccagagaccgcttcgggaatgaaggcttaatcccaagcaactatgtgacagaaaacagactcgccaacttagaaatctatgaatggtaccacaagaacattacgagaaaccagaccgaacgcctattgaggcaagaggctaaagaaggtgcctttatcgtgagagattcgagacacttggggtcttacacaatctctgtgtttacaagagctcgaaggcatacacagtcttcaataaaacattatcagataaaaaagaatgactccggacagtggtacatcaccgaaagacatctcttcccctcagtccccgagttgatccagtatcaccagtacaatgcagctggtctcatatctcgtctccgctatcccattgggctcctgggcagctgtttaccagccacatctggttttagctatgaaaagtgggagatagatccgtcagagttgacttttgtcaaggagatcggaagtggtcagtttggggttgtccacttaggagaatggagagcacatatcccggtcgccatcaaggccatcaatgaaggttccatgtctgaagaagacttcattgaggaagccaaggtgatgatgaaactgtcacattcgaggttagttcaactttacggggtgtgtatacagcagaagcccctgtacatagtgacggagttcatggagaacggctgcctgcttgactatctcagggagaggaaaggccagcttcagaaggcgctgctcttgagcatgtgccaagacatatgtgaagggatggcgtacctggagaggagctgctatattcacagggatctggctgccaggaactgtttggtcagttctgcctgcgtagtaaagatctcagacttcggcatggcgaggtatgttttggacgatgaatatatcagttcttctggagctaagttcccagtcaagtggtgcccgcctgaagtctttcatttcaacaaatacagtagcaagtctgatgtctggtcgttcggagttttaatgtgggaagtttttacagaaggaaaaatgccttttgaaaataagtcaaatttgcaagtggtggaagccatttctcaaggtttccggctgtatcgtcctcacctggcccccatgaccatatacagtgtaatgtacagttgctggcatgagagccctaaaggccgtccgacatttgctgagctgcttcaggttctcacggagatcgcagaaacgtggtgaccttaaatgcagtgccagctcgcaggtgaccttaagtggaactccagcccacagggtcatcttgcaaaaaaacggtcgcaaggtgaaatcatgggcatctcggatagggagtatctccaccagggttgttgactcttggcgacgaagcaaaggtcacaggcttgtcacactgatttcaatgcaaaatagtctgacccgtagtcttgtacaagtgtgaggcagacttctgaactacacttctgagctccttccacatcctgtatgtgaaaagagtgtgctccacaccagccctccaaatggctgatgaccctcaggtcccttaagtgtacagagaccccttattcttcataaggctgaggcaacatcgttcttgagcgctgacatttctctttcgagtggtccatgcagagaggggaaaaaaattagattctgccaactcatgaaatgaagaaatcttttcaacagtttcatgtttggggctgtataaatgtttataggaaacatagctttggaaacctatgtgaacattctggaaatgtcttttataatcgtgccatatgttatttaataaactcttctgtttattgtggg

SEQ ID NO: 21 - protein, 527 aa, Mus musculus
MISFSDSSFQSVLCCCCCRCSVQKRQVRTQISLSREEELSEKHSQRQRPWFAKLMGKTQSNRGGVQPSKRKPLPPLPQEPPDERIQVKALYDFLPREPGNLALKRAEEYLILERCDPHWWKARDRFGNEGLIPSNYVTENRLANLEIYEWYHKNITRNQTERLLRQEAKEGAFIVRDSRHLGSYTISVFTRARRHTQSSIKHYQIKKNDSGQWYITERHLFPSVPELIQYHQYNAAGLISRLRYPIGLLGSCLPATSGFSYEKWEIDPSELTFVKEIGSGQFGVVHLGEWRAHIPVAIKAINEGSMSEEDFIEEAKVMMKLSHSRLVQLYGVCIQQKPLYIVTEFMENGCLLDYLRERKGQLQKALLLSMCQDICEGMAYLERSCYIHRDLAARNCLVSSACVVKISDFGMARYVLDDEYISSSGAKFPVKWCPPEVFHFNKYSSKSDVWSFGVLMWEVFTEGKMPFENKSNLQVVEAISQGFRLYRPHLAPMTIYSVMYSCWHESPKGRPTFAELLQVLTEIAETW